(19) United States
(12) Patent Application Publication
(10) Pub. No.: US 2005/0153262 A1
(43) Pub. Date: Jul. 14, 2005

(54) Firearm laser training system and method employing various targets to simulate training scenarios

(76) Inventor: O. Tansel Kendir, Eldersburg, MD (US)

Correspondence Address: EDELL, SHAPIRO, FINNAN & LYTLE, LLC, 1901 RESEARCH BOULEVARD, SUITE 400, ROCKVILLE, MD, 20850, US

(21) Appl. No.: 10/995,128

(22) Filed: Nov. 24, 2004

Related U.S. Application Data
(60) Provisional application No. 60/524,872, filed on Nov. 26, 2003.

(51) Int. Cl. F41G 3/26; G09B 19/00; F41A 33/00

(52) U.S. Cl. 434/21; 434/16

(57) ABSTRACT

A firearm laser training system according to the present invention includes a laser assembly, actuable target assemblies and a computer system. The laser assembly is attached to a user firearm to project a laser beam toward the target. The target assemblies raise and lower targets in accordance with control signals from the computer system. Targets are raised to indicate intended targets, and are lowered in response to the beam impacting the raised targets or upon expiration of an interval without a beam impact. A corresponding target assembly forwards information to the computer system for display via wired or wireless communications. In addition, the training system may employ stationary target assemblies and/or laser-detecting body gear worn by exercise participants. The target assemblies and body gear communicate impact information to the computer system via wireless communications and may be utilized to create various training scenarios for firearm training.

### CROSS-REFERENCE TO RELATED APPLICATIONS

This application claims priority from U.S. Provisional Patent Application Ser. No. 60/524,872, entitled “Firearm Laser Training System and Method Employing Wearable Laser Detecting Devices to Simulate Various Training Scenarios” and filed Nov. 26, 2003, the disclosure of which is incorporated herein by reference in its entirety.

### BACKGROUND OF THE INVENTION

1. Technical Field

The present invention pertains to a weapon training system employing laser-emitting weapons and laser-detecting devices, such as the types of systems disclosed in U.S. Pat. No. 5,344,320 (Inbar et al.), U.S. Pat. No. 6,322,365 (Shechter et al.), U.S. Pat. No. 6,572,375 (Shechter et al.) and U.S. Pat. No. 6,575,753 (Rosa et al.), the disclosures of which are incorporated herein by reference in their entireties. In particular, the present invention pertains to a firearm laser training system employing actuable target assemblies and/or laser-detecting body gear to simulate various training scenarios.

2. Discussion of the Related Art

Firearms are utilized for a variety of purposes, such as hunting, sporting competition, law enforcement and military operations. The inherent danger associated with firearms necessitates training and practice in order to minimize the risk of injury. However, special facilities are required to facilitate practice of handling and shooting the firearm. These special facilities tend to provide a sufficiently sized area for firearm training and/or confine projectiles propelled from the firearm within a prescribed space, thereby preventing harm to the surrounding environment. Accordingly, firearm trainees are required to travel to the special facilities in order to participate in a training session, while the training sessions themselves may become quite expensive since each session requires new ammunition for practicing handling and shooting of the firearm.

The related art has attempted to overcome the above-mentioned problems by utilizing laser or other light energy with firearms to simulate firearm operation and indicate simulated projectile impact locations on intended targets. For example, U.S. Pat. No. 2,934,634 (Hellberg) discloses an attachment for an ordinary firearm which temporarily converts that firearm to a game or practice device. The conversion is achieved by a special target in combination with attachments for the firearm trigger guard and barrel. The target is actuated by a photocell in response to detection of a light ray. The barrel includes an illumination source attached thereto, while the trigger guard has a time delay switch enabling the light source to remain illuminated for a period of time sufficient to assure actuation of the target.

U.S. Pat. No. 3,526,972 (Sumpf) discloses a marksman's practicing device for use as an attachment on a shotgun or the like having a casing adapted for attachment to a barrel. The casing includes a light source disposed therein having a trigger-actuated switch to energize the light source to produce a light beam within the casing and a beam directing mechanism for projecting the beam coaxially from the barrel. The device is employed in connection with a light sensitive target having a bull's eye formed by a selenium cell or the like. The cell may be installed in a stationary position or constructed for movement in a random or flight imitating path, and is connected to an audio visual signal device to indicate a hit upon the target.

U.S. Pat. No. 3,633,285 (Sesney) discloses a laser transmitting device for marksmanship training. The device is readily mountable to the barrel of a firearm and transmits a light beam upon actuation of the firearm firing mechanism. The laser device is triggered in response to an acoustical transducer detecting sound energy developed by the firing mechanism. The light beam is detected by a target having a plurality of light detectors, whereby an indication of aim accuracy may be obtained.

U.S. Pat. No. 3,995,376 (Kimble et al.) discloses a miniaturized laser assembly mounted on a weapon where the power source and circuitry for the laser assembly are contained within the weapon. The laser weapon is fired in a normal manner by squeezing the trigger while aiming at a target. The laser emits a harmless invisible signal pulse of coherent light, while a silicon photodiode may be mounted on a stationary, moving, pop-up or personally worn version of the target. In response to activation of the photodiode by a pulse of laser light, circuitry connected to the photodiode energizes a horn to indicate a successfully aimed and fired shot.

U.S. Pat. No. 4,048,489 (Gianetti) discloses a light operated target shooting system. An electro-optic light pulse generator is contained in a gun sight holder and serves as the light source in a light responsive target shooting system. The pulse generator is a laser or other light emitting unit, mounted with an optical system, electronic controls and a battery power source in the interior of the unit. When the user shoots the gun, light pulses are beamed in the direction that the gun and sight holder are pointed. In a disclosed system, the light pulses are directed toward a target structure including light sensors spaced over the target surface. The sensors provide electrical signals or a change in an electrically sensed circuit parameter that is used to actuate a scoring device.

U.S. Pat. No. 4,340,370 (Marshall et al.) discloses a linear motion and pop-up target training system for training a marksman to fire a simulated weapon. The system includes a model-board having a terrain surface with six pop-up targets and three bi-directional linear motion targets. Each target emits a pulsed beam of infrared light in response to activation by a first microprocessor computer. The weapon includes a sensor that senses the pulsed infrared beam emitted by the activated target. The sensor supplies an analog signal, proportional to the amount of received light, to a rifle electronics circuit that converts the analog signal to a digital logic signal. A second microprocessor computer receives and processes the digital logic signal in accordance with a predetermined computer program to determine whether the marksman has scored a hit, a miss or a near miss upon the activated target.

U.S. Pat. No. 4,662,845 (Gallagher et al.) discloses a target system for laser marksmanship training devices. The system includes one or more photodetectors mounted on a target and sensitive to one or more pulses of the wavelength of a laser beam simulating the projectile of a weapon. An amplifier increases the power output of the photodetectors, while the amplified signal operates a frequency selective transducer. The transducer is attached and acoustically coupled to the target and produces a vibration signature simulating the vibration characteristics of a weapon-fired projectile striking the target. A microphone sensitive to the vibration signature of the transducer is acoustically coupled to the target, while a drive mechanism lowers the target out of the field of view of the weapon when the microphone receives a vibration signature from the transducer indicating a hit.

The related art suffers from several disadvantages. In particular, the Hellberg, Sesney and Gianetti systems typically utilize a stationary target to provide firearm training, thereby limiting those systems with respect to the training scenarios and firearm exercises that may be conducted. The Kimble et al. and Sumpf systems may employ a moving or actuable target, respectively; however, these targets are employed to simulate a flight path of an actual intended target or to indicate a hit via target actuation. Thus, the targets provide specific aspects of firearm training or are employed merely to indicate a hit, and are similarly limited with respect to the training scenarios and firearm exercises that may be conducted. Further, the Gallagher et al. system typically employs a pop-up target utilized for live ammunition, thereby increasing system costs and requiring sufficient space to utilize the targets. The Marshall et al. system utilizes a sensor mounted on a firearm, and moving and pop-up targets disposed on a model board that emit light. Accordingly, this system tends to have less accuracy with respect to detecting proper firearm positioning and is limited to the particular scenario presented by the model board. In addition, the systems described above do not generally provide a manner to enable a user to customize and vary the particular training scenario, target types and/or target sequence or actuation for firearm training.

### OBJECTS AND SUMMARY OF THE INVENTION

Accordingly, it is an object of the present invention to simulate operation of a firearm and conduct firearm training exercises with various training scenarios.

It is another object of the present invention to simulate operation of a firearm and conduct firearm training exercises with various training scenarios by employing a series of actuable targets and/or laser-detecting body gear for exercise participants that each transfer impact information from the training exercise over a wireless communication system.

Yet another object of the present invention is to simulate operation of a firearm and conduct firearm training exercises by utilizing laser-detecting targets mounted on actuating devices and/or laser-detecting body gear on exercise participants to create various training scenarios.

Still another object of the present invention is to enable a user to customize and vary the firearm laser training scenario for firearm training.

A further object of the present invention is to simulate operation of a firearm by employing an eye-safe low power laser over long distances between a user and target (e.g., 600-700 meters) with enhanced accuracy for detection of target impact locations.

The aforesaid objects are achieved individually and/or in combination, and it is not intended that the present invention be construed as requiring two or more of the objects to be combined unless expressly required by the claims attached hereto.

According to the present invention, a firearm laser training system includes a laser transmitter assembly, one or more actuable target assemblies each having a target, and a computer system. The laser assembly is attached to an unloaded user firearm to adapt the firearm for compatibility with the training system. A user aims an unloaded firearm at a particular target and actuates the firearm trigger to project a laser beam from the laser transmitter assembly toward that target. The target assemblies raise and lower targets in accordance with control signals from the computer system. The targets are raised at prescribed times for a specific time interval to indicate intended targets for the user, and are lowered in response to the beam impacting the raised targets within that interval (e.g., indicating a hit) or upon expiration of the interval without a beam impact (e.g., indicating a miss). A corresponding target assembly control unit analyzes detection signals from an associated target to lower that raised target in response to beam impact and forwards information to the computer system to provide feedback information to the user via a display. Communication between the target assemblies and computer system may be accomplished via a wired (e.g., cables, etc.) or wireless communication system.

In addition, the firearm laser training system may employ stationary target assemblies and/or laser-detecting body gear worn by exercise participants to enable the participants to serve as targets. The target assemblies and body gear communicate impact information to the computer system via a wireless communication system. The target assemblies and/or body gear may be utilized to create various training scenarios for firearm training.

The present invention offers several advantages. In particular, the use of laser pulses to simulate firearm actuation or projectiles enables the system to conduct firearm training in a realistic and safe manner. For example, use of the present invention system with a blocked barrel type firearm (U.S. Pat. No. 6,322,365) employing blank ammunition provides realistic and safe training, where automatic type weapons (e.g., machine guns, etc.) may be cycled. The present invention system enables a user to train with their actual weapon, while the laser employed is eye-safe. Accordingly, the system employs low power lasers over long distances (e.g., 600-700 meters) with enhanced impact detection accuracy. Further, the laser detecting body gear assemblies of the present invention provide enhanced accuracy with respect to hit or beam impact detection and are typically utilized with a short laser pulse. This prevents firearm motion after the shot by a user from affecting detection of beam impacts. Moreover, the body gear assemblies and target assemblies are generally insensitive to ambient light conditions, thereby enabling employment for indoor or outdoor training scenarios. In addition, the present invention system monitors the status of, or beam impacts upon, the target assemblies and body gear worn by users during a training scenario to provide the progress of the training drill to a training instructor or other observers.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 is a diagram of an exemplary firearm laser training system employing actuable targets according to the present invention.

FIG. 2 is a schematic block diagram of the firearm laser training system of FIG. 1.

FIG. 3 is a view in perspective of an interface unit employed by the system of FIG. 1.

FIG. 4 is a view in perspective of a target object of the system of FIG. 1 according to the present invention.

FIG. 5 is a view in perspective of an alternative target object of the system of FIG. 1 according to the present invention.

FIG. 6A is a top view in plan of a platform of the target object of FIG. 4 including detection circuitry according to the present invention.

FIG. 6B is a top view in plan of a platform of the target object of FIG. 5 including detection circuitry according to the present invention.

FIG. 7 is a schematic block diagram of detection units employed by the target object detection circuitry of FIGS. 6A-6B to detect beam impacts.

FIG. 8 is an electrical schematic diagram of a gain adjustment circuit controlling the gain of the detection units of FIG. 7.

FIG. 9 is a schematic block diagram of a detection control unit of the target object detection circuitry of FIGS. 6A-6B.

FIG. 10 is an exploded view in perspective of an actuable target assembly of the system of FIG. 1 according to the present invention.

FIG. 11 is a schematic block diagram of the target assembly of FIG. 10.

FIG. 12 is a diagram of an alternative firearm laser training system employing actuable targets and detecting impact locations on those targets according to the present invention.

FIG. 13 is a schematic block diagram of the firearm laser training system of FIG. 12.

FIG. 14 is a schematic block diagram of a detection control unit of the target objects employed by the system of FIG. 12.

FIG. 15 is a view in perspective of an actuation interface unit of the system of FIG. 12.

FIG. 16 is a schematic block diagram of the actuation interface unit of FIG. 15.

FIG. 17 is a schematic block diagram of an alternative embodiment of the actuation interface unit of FIG. 15.

FIG. 18 is a diagram of an exemplary firearm laser training system employing target assemblies and/or wearable laser detecting body gear in communication with a control station via a wireless communication system according to the present invention.

FIG. 19 is an exploded view in perspective of a stand receiving a target object according to the present invention.

FIG. 20 is a view in perspective of an impact display unit to indicate beam impacts on a target object according to the present invention.

FIG. 21 is schematic block diagram of the impact display unit of FIG. 20.

FIG. 22 is a view in perspective of a communication interface unit to communicate target impacts to a control station via a wireless communication link according to the present invention.

FIG. 23 is a schematic block diagram of the communication interface unit of FIG. 22.

FIG. 24 is a schematic block diagram of an alternative embodiment of the communication interface unit of FIG. 22.

FIG. 25 is a block diagram of an RF unit employed by the communication interface units of the system of FIG. 18.

FIG. 26 is a view in perspective of a body gear unit or segment of FIG. 18 configured to cover a user torso and including multi-colored indicators to indicate beam impacts according to the present invention.

FIG. 27 is a view in perspective of a body gear unit or segment of FIG. 18 configured to cover a user limb and including multi-colored indicators to indicate beam impacts according to the present invention.

FIG. 28 is a schematic block diagram of a detection assembly for the body gear of FIGS. 26-27 to detect a beam impact and alternately enable the indicators according to the present invention.

FIG. 29 is a block diagram of an RF unit employed by the body gear of FIGS. 26-27.

FIG. 30 is a view in perspective of the body gear unit of FIG. 18 alternatively configured with a series of indicators, each associated with a corresponding detector, to indicate the location of a beam impact on the body gear according to the present invention.

FIG. 31 is a schematic block diagram of a detection assembly for the body gear units of FIG. 30 to detect and indicate the location of a beam impact on the body gear according to the present invention.

FIG. 32 is a block diagram of a reader unit employed by the training system of FIG. 18.

FIGS. 33-34 are procedural flow charts illustrating the manner in which the computer system controls system operation according to the present invention.

FIGS. 35-38 are schematic illustrations of exemplary graphical user screens displayed by the computer system for training activities.

FIG. 39 is a schematic illustration of an exemplary graphical user screen displayed by the systems of FIGS. 12 and 18 to indicate impact locations on body gear units and/or target assemblies according to the present invention.

FIG. 40 is a schematic illustration of an alternative graphical user screen displayed by the system of FIG. 18 indicating locations of targets and/or participants in a training area according to the present invention.

### DETAILED DESCRIPTION OF THE PREFERRED EMBODIMENTS

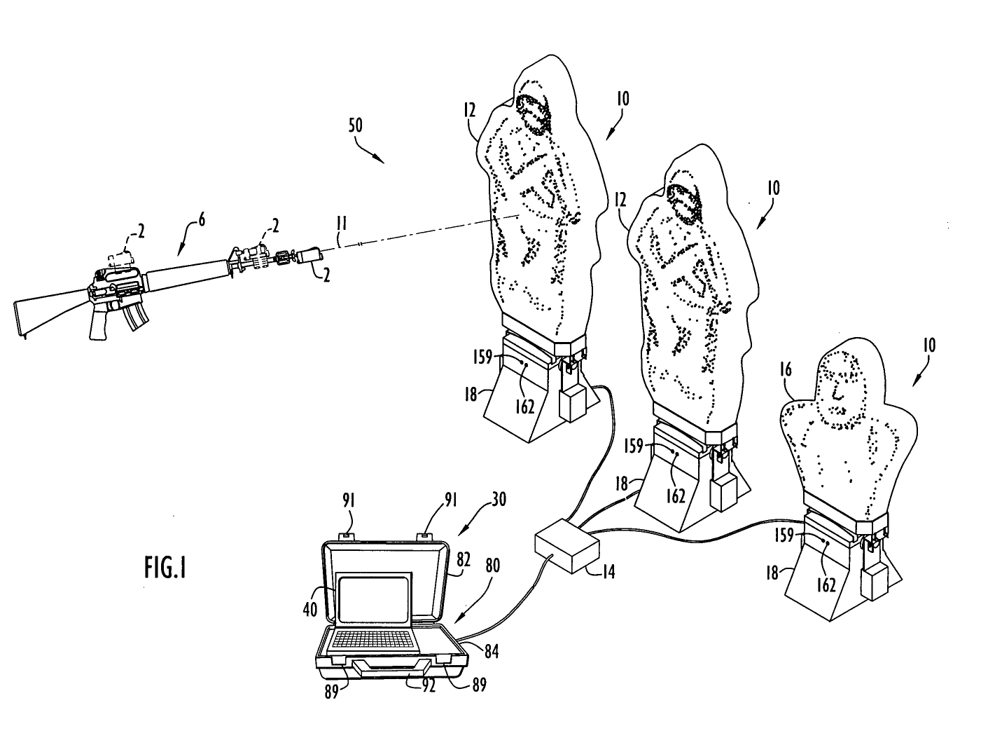

A firearm laser training system employing an actuable target assembly according to the present invention is illustrated in FIG. 1. Specifically, firearm laser training system 50 includes a laser transmitter assembly 2, actuable target assemblies 10, an interface unit 14 and a control station 30. The laser assembly is attached to an unloaded user firearm 6 to adapt the firearm for compatibility with the training system. By way of example only, firearm 6 may be implemented by a conventional M-16 type rifle equipped to emit laser pulses in response to user actuation, such as the type of firearm disclosed in aforementioned U.S. Pat. No. 6,572,375 (Shechter et al.). The laser transmitter may be fastened to the distal end of the firearm barrel or proximate the firearm sight or handle. In addition, the firearm may emit laser pulses in response to dryfire or in response to blank cartridges as disclosed in U.S. Pat. No. 6,572,375 (Shechter et al.). However, the firearm may be implemented by any conventional firearms (e.g., hand-gun, rifle, shotgun, etc.), while the laser and firearm combination may be implemented by any of the simulated firearms disclosed in the above-mentioned patents and patent application. Target assemblies 10 each include a target object 12 or 16 in the form of a silhouette of a person and an actuation unit 18 to raise or lower a corresponding target object. The target objects are substantially similar to each other, except that target object 12 has dimensions greater than those of target object 16.

Laser transmitter assembly 2 emits a beam 11 of laser light in response to actuation of firearm 6. The laser transmitter assembly emits a red, visible beam that is preferably modulated (e.g., at a frequency of approximately forty-five kilohertz) and eye-safe. By way of example only, the laser transmitter assembly may be classified as an ANSI class 3A laser with the following characteristics: optical power of approximately 2.2 milliwatts; wavelength of approximately 650 nanometers for the beam; a pulse duration of approximately one to eight milliseconds (e.g., with a one-hundred millisecond delay when off); a modulation of approximately 45 KHz with a fifty percent duty cycle; a beam with a size or diameter of approximately 2.8 millimeters at the emission point of the assembly; and a divergence of 0.0012 radians. However, any suitable laser may be utilized. The laser is generally zeroed to approximately twenty-five meters and enabled in response to each firearm actuation for a predetermined time interval (e.g., the system may detect laser pulses with a minimum duration of approximately 1.5 milliseconds) sufficient for target objects 12, 16 to detect the pulse. The laser beam may alternatively be of any color or spectrum (e.g., visible, invisible, etc.) and include any suitable modulation (e.g., 100 kilohertz) or pulse duration. The target assemblies raise and lower targets 12, 16 in accordance with control signals from the control station as described below. The targets are individually raised by corresponding target assemblies 10 at prescribed times for a specified time interval to indicate intended targets for the user, and are lowered in response to the beam impacting the raised targets within that interval (e.g., indicating a hit) or upon expiration of the interval without a beam impact in response to receiving a signal from the computer system to lower the target (e.g., indicating a miss).

A user aims firearm 6 at the target objects and actuates the firearm to project laser beam 11 from laser assembly 2 toward the target object. The target objects detect beam impacts and transfer information to control station 30. Thus, various training scenarios may be conducted, where the participants can engage the target objects to simulate combat, law enforcement or other scenarios. It is to be understood that the terms “top”, “bottom”, “side”, “front”, “rear”, “back”, “lower”, “upper”, “up”, “down”, “height”, “width”, “thickness”, “length”, “vertical”, “horizontal”, “right”, “left” and the like are used herein merely to describe points of reference and do not limit the present invention to any specific orientation or configuration.

The system may be utilized to simulate live ammunition training systems employed by the military or law enforcement, such as the Remote Electronic Target System (RETS). This type of system is typically employed on a firing range and provides various targets that become raised (e.g., pop-up) for the trainee. The laser training system may simulate the view or conditions the trainee encounters in the RETS system, thereby providing angular perception training and angular queuing training (e.g., training to shoot the highest priority threat or closest target). The laser system typically employs seven targets to simulate the RETS system, but may include any quantity of targets. The targets become raised and/or lowered during the training exercise as described below. In addition, the system may be utilized to simulate firearm competitions, such as the International Practical Shooting Competition (IPSC). The object of this competition is to hit each target in the shortest time interval. The laser system may simulate this competition and measure the time interval for impacting a series of assembly targets.

Control station 30 includes a computer system 40. Interface unit 14 communicates with target assemblies 10 to receive target impact information and to forward that information to computer system 40. The computer system processes the information and displays simulated projectile impact locations on a target image via graphical user screens as described below. The computer system may be housed within a case 80 including upper and lower members 82, 84 pivotally connected to each other by hinges or other pivoting mechanisms. The lower member includes an open top portion and generally rectangular front, rear and side walls that collectively define the lower member interior or storage area. Similarly, upper member 84 includes an open bottom portion and generally rectangular front, rear and side walls that collectively define the upper member interior or storage area. The hinges or pivoting mechanisms are typically attached to the upper and lower member rear walls, while the lower member front wall or surface includes fasteners 89 that selectively engage corresponding fastening members 91 disposed on the upper member front wall or surface to secure the case in a closed state. Further, a handle 92 is disposed on the lower member front wall or surface between the fasteners to enable transport of the case, thereby providing a portable system that may be utilized at virtually any suitable location.

Lower member 84 includes insulation material, such as foam, configured to form several compartments each for receiving a corresponding system component. The compartments typically contain computer system 40 and may further house system software and/or documentation or any other additional system components or accessories (e.g., power source or battery, etc.). The case may include any system components or accessories and be arranged in any desired fashion.

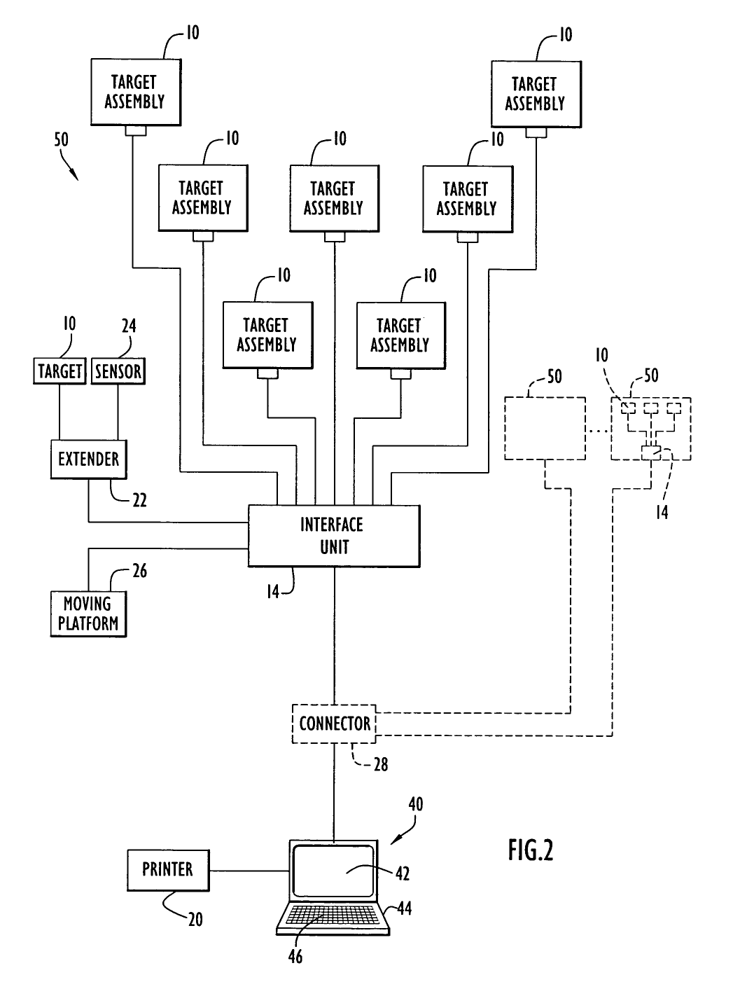

Referring to FIG. 2, computer system 40 controls system operation and may provide various feedback to a user. The computer system is typically implemented by a conventional IBM-compatible laptop or other type of personal computer (e.g., notebook, desk top, mini-tower, Apple Macintosh, palm pilot, etc.) preferably equipped with display or monitor 42, a base 44 (e.g., including the processor, memories, and internal or external communication devices or modems) and a keyboard 46 (e.g., including a mouse or other input device). Computer system 40 includes software to enable the computer system to communicate with and control target assemblies 10 and provide feedback to the user. The computer system may utilize any of the major platforms (e.g., Linux, Macintosh, Unix, OS2, etc.), but preferably includes a Windows environment (e.g., Windows 95, 98, NT, 2000, XP, etc.). Further, the computer system includes components (e.g., processor, disk storage or hard drive, etc.) having sufficient processing and storage capabilities to effectively execute the system software. By way of example only, computer system 40 includes a Pentium type or compatible processor.

Computer system 40 and target assemblies 10 are connected to interface unit 14. The interface unit is typically connected to a power source and the computer system parallel port and transmits control signals received from the computer system and power signals to target assemblies 10 as described below. The connections between the interface unit, computer system and target assemblies are preferably implemented by suitable cables. However, the connections may be facilitated in any desired fashion (e.g., wireless, etc.). A printer 20 may further be connected to the computer system to print reports containing user feedback information (e.g., score, hit/miss information, etc.). The interface unit and printer may alternatively be connected to various other ports of the computer system (e.g., serial, USB, etc.).

The interface unit includes a programmable device or other control circuitry (e.g., microprocessor, logic or other circuitry, etc.) and relays power signals and control signals from the computer system to respectively provide power to and control the target assemblies. Specifically, the computer system generates controls for the target assemblies in accordance with an entered target sequence. The control information typically includes a command to raise or lower a specific target. The computer system may control each target assembly individually. The control signals are encoded by the computer system and transmitted to the interface unit through the computer system parallel port. The interface unit receives the encoded signals and decodes them to determine the controls for the individual target assemblies. The interface unit checks the current status of the target assemblies (e.g., may request information from an assembly), and in response to proper status, transmits the control signals to the control units of the appropriate target assemblies. Thus, the interface unit basically decodes control signals and disseminates them through bits of a transmitted signal and receives signals from the target assemblies for transfer to the computer system.

The interface unit may be further connected to one or more extender units 22 or a connection interface unit 28. The extender unit enables the interface unit to communicate with an additional series of target assemblies 10 or other targets or sensors 24, thereby extending the capability of the system. The sensors may trigger system operation to simulate scenarios (e.g., motion sensors, etc.), while the system may utilize any types of targets, such as those disclosed in the aforementioned patents and patent application. The connection interface unit is coupled to computer system 40 and to interface unit 14 and the interface units and/or target assemblies of other systems 50 to enable communication with the computer system, thereby enabling the computer system to control plural systems. The extender and connection interface units may be implemented by any conventional or other circuitry, components or devices to enable distribution of signals (e.g., multiplexers, gate arrays, switches, etc.). In addition, one or more target assemblies may be disposed on a moving platform 26 to enable target lateral motion relative to a user. This platform basically includes a base to support the target assemblies and a series of wheels or rollers, preferably actuable by a motor or other mechanism, to enable the lateral motion. The moving platform is connected to the interface unit to enable control of the platform by computer system 40.

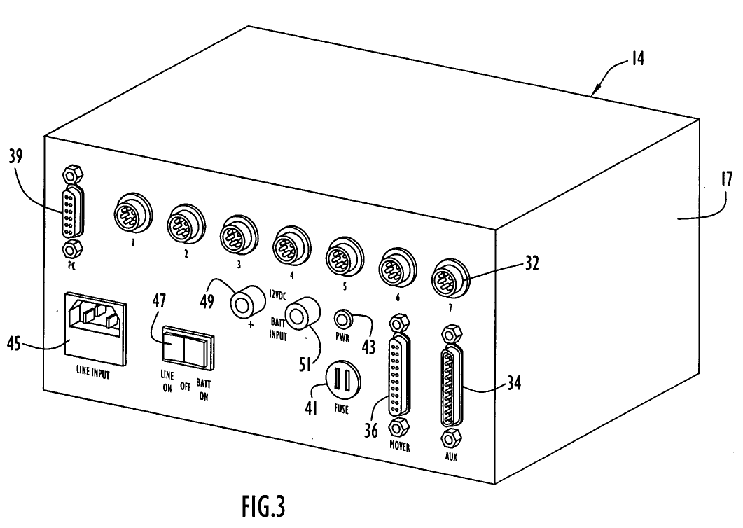

Referring to FIG. 3, interface unit 14 includes a housing 17 including the programmable device or control circuitry disposed therein and a front panel. The front panel includes a series of motor receptacles or sockets 32, an extender unit connector 34, a moving platform connector 36, a computer interface connector 39, a fuse 41, a light emitting diode (LED) 43, a power socket 45, a switch 47 and positive and negative power terminals 49, 51. Connector 39 facilitates connection of the interface unit to a parallel or other port of computer system 40 (FIG. 2), while fuse 41, typically a conventional ten amp fuse, protects the internally housed programmable device and/or circuitry. LED 43 is typically illuminated to indicate reception of power signals by the interface unit. Extender unit connector 34 enables communication between the interface unit and extender unit, while moving platform connector 36 facilitates connection to moving platform 26. Motor receptacles 32 receive cables that are connected to the target assemblies and facilitate transmission of power signals and transference of information over the cables between the target assemblies and interface unit. Each motor receptacle corresponds to or is associated with a target assembly and, via the cable, provides power signals for target assembly electronics to that target assembly. Further, each motor receptacle facilitates transmission and reception of information over the cable between that target assembly and the interface unit. By way of example only, the interface unit includes seven motor receptacles. The cables utilized for connecting the interface unit to the target assemblies, computer system, extender units and moving platform may include a combination of the individual cables compatible with the associated receptacles.

Terminals 49, 51 are connected to the associated terminals of a power supply in order to receive power. The terminals typically receive power signals in the form of 12V DC. These signals may be supplied from a battery, motorized vehicle electrical systems or any other source providing the appropriate power signals. The interface unit may further include receptacles or other interfaces for receiving power signals in the form of 13.8V DC or any other desired voltage. Alternatively, the interface unit may receive power signals from a common wall outlet jack (e.g., AC) via power socket 45. The power socket is coupled to a power cord (not shown) that interfaces the wall outlet jack to provide power signals to the interface unit. Switch 47 is manipulable by a user and serves as the main power switch for the interface unit (e.g., on/off). Switch 47 further designates the source of the power signals for the interface unit (e.g., 12V DC on terminals 49, 51 or AC via power socket 45). In addition, the rear panel of the interface unit includes a user manipulable switch (not shown) to configure the interface unit for the appropriate power setting for a particular region (e.g., 110V AC for the U.S., 220V AC for Europe, etc.).

When a target is raised in response to a control signal, target information associated with that target is transmitted from the corresponding target assembly to the interface unit. This information, by way of example, may be in the form of the target status (e.g., raised or lowered). The interface unit encodes the information and transmits it to the computer system for processing. A target lowered within the prescribed interval indicates a hit, and the computer system processes the information for display and reports as described below. A miss is identified when no hit information is received by the computer system from the specified target assembly prior to expiration of the time interval. In this case, the computer system transmits a control signal to that target assembly to lower the target (unless that assembly is active within the next interval of the sequence) and scores a miss. A hit target is lowered by the target assembly control unit as described below. The hit information may include any type of information to indicate beam impact on a target. The target may be lowered and hit information provided to the computer system in response to detection of a single hit or two hits (“double tap”) as described below.

The interface unit typically accommodates a maximum of seven target assemblies. However, the interface unit may be connected to additional target assemblies or sensors via extender unit 22, and/or be connected to connection interface unit 28 along with additional interface units or systems as described above to accommodate an increased quantity of target assemblies. The extender unit basically facilitates communication between the interface unit (and, hence, the computer system) and the target assemblies, targets and/or sensors coupled to the extender unit. The extender unit may selectively and individually address the target assemblies, targets and/or sensors to transfer information between those items and the computer system.

The connection interface unit basically receives control signals from the computer system and transmits the signals to the appropriate interface units or systems accommodating the target assemblies specified in the control signals. The connection interface unit may selectively and individually address the interface units or systems to receive information from and transmit controls for the target assemblies. The interface units of other systems are substantially similar to the interface unit of the current system. In addition, the interface unit may further include appropriate components or be configured to provide sound effect generation, to accommodate additional target assemblies and/or to operate in an event driven manner.

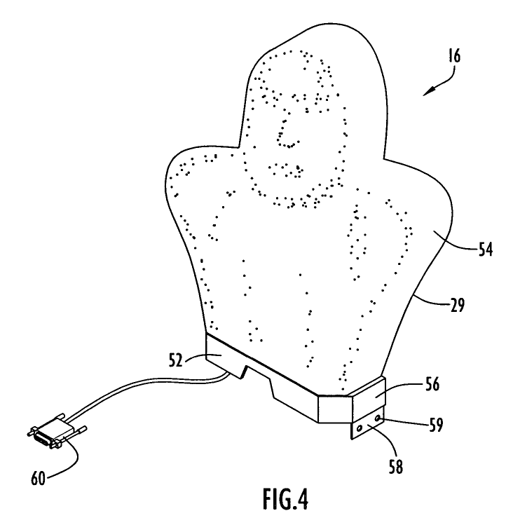

The system may be utilized with various types of targets to facilitate firearm training and/or qualifications (e.g., certification to a particular level or to use a particular firearm). The system may additionally be utilized for entertainment purposes (e.g., in target shooting games or sporting competitions). An exemplary target object 16 is illustrated in FIG. 4. Initially, target object 16 is preferably three dimensional and includes one or more detector assemblies to detect the laser beam impact on the target as described below. The detector assemblies are positioned at desired locations within the target to detect beam impacts within specific target areas or zones. By way of example only, target object 16 is implemented by an IVAN type target and includes a shell or silhouette 54 of a human upper body portion with an open back and interior. The target is typically constructed of plastic and includes a degree of transparency (e.g., translucent) sufficient to enable the laser beam to pass therethrough to the detector assemblies. In effect, shell 54 serves as a diffuser for the detector assemblies.

Shell 54 may be painted in a manner that does not block the laser beam from impacting the detector assemblies. This may be accomplished by utilizing paints designed for glass and applying the paint to the shell with a sponge to provide openings (e.g., generally not visible) to permit the laser beam to pass therethrough. Further, the shell may be constructed from glass, or fine glass or metallic fragments may be mixed into the paint to provide bright targets for nigh time activities and/or thermal night sight users. The shell may be implemented by any other molded shapes (e.g., plastic mannequins, etc.). The shell may be covered by sheer fabric or material (e.g., pantyhose, cloth, mesh, etc.) that enables the laser beam to contact the detector assemblies. This enables clothes or garments (e.g., colors, etc.) to be placed on the target to provide friend/foe or other indications. The material may be changed for any desired scenarios or applications (e.g., different type of materials, colors, etc.). Moreover, masks may be utilized to cover any desired areas (e.g., face or other body portions, etc.) of the target. The masks may be constructed of a thin plastic material to enable the laser beam to pass therethrough. The masks may be painted and are interchangeable to change the color, identification and/or friend/foe designation of the target. These masks may further be utilized on the laser detecting targets disclosed in the aforementioned patents.

In addition, the shell may be configured to be inflatable for easy storage. The shell may be constructed of a heavy duty material, such as the materials used for meteorology balloons and boats. The target object may be painted with conventional commercial paint, where stretching of the material during inflation enables the laser beam to pass therethrough. Further, target object 16 may be configured or sealed to retain heated or warmed gas (e.g., air, oxygen, etc.) at a temperature approximating the body temperature of a person (e.g., approximately 37° C.). This enables users to conduct training under conditions utilizing thermal detectors (e.g., night time training or other conditions with low visibility, etc.).

Target object 16 further includes a platform 29 and a base 52. The platform is preferably contoured to the perimeter of shell 54 to house the detecting components and add rigidity to the target. The base is attached to and extends transversely from the platform bottom portion to receive and contour the perimeter of the bottom edges of shell 54. Side walls 56 of the base each include a flange 58 disposed proximate a corresponding side wall bottom edge with a pair of fastening members 59 secured thereto. The fastening members are typically in the form of a bolt and a wing or butterfly nut to engage a corresponding actuating unit 18 (FIG. 1) as described below. A connector cable 60 extends from the target object detection circuitry to interface with system components. The connector cable receives power signals from and provides detection signals to system components as described below.

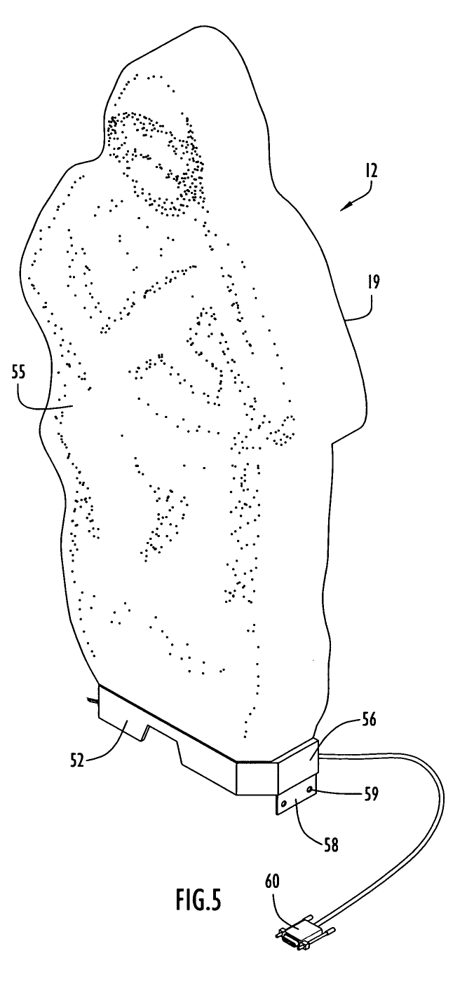

An alternative target object 12 is illustrated in FIG. 5. This target object is substantially similar to target object 16 described above, except that the dimensions of target object 12 are greater than those of target object 16. Initially, target object 12 is preferably three dimensional and includes one or more detector assemblies to detect the laser beam impact on the target as described above. The detector assemblies are positioned at desired locations within the target to detect beam impacts within specific target areas or zones. By way of example only, target object 12 is implemented by an IVAN type target and includes a shell or silhouette 55 of a human upper body portion with an open back and interior. Shell 55 is substantially similar to, but includes dimensions greater than those of, shell 54 described above. The target is typically constructed of plastic and includes a degree of transparency (e.g., translucent) sufficient to enable the laser beam to pass therethrough to the detector assemblies. In effect, shell 55 serves as a diffuser for the detector assemblies.

Shell 55 may be covered with various materials to simulate camouflage and/or indicate friend or foe conditions as described above. Further, target object 12 further includes a platform 19 and base 52. The platform is substantially similar to, but includes dimensions greater than those of, platform 29 described above and is preferably contoured to the perimeter of shell 55 to house the detecting components and add rigidity to the target. The base is substantially similar to the base described above and is attached to and extends transversely from the platform bottom portion to receive and contour the perimeter of the bottom edges of shell 55. Side walls 56 of the base each include flange 58 disposed proximate a corresponding side wall bottom edge with a pair of fastening members 59 as described above to engage a corresponding actuating unit 18 (FIG. 1). Connector cable 60 extends from the target object detection circuitry as described above to interface with system components. The connector cable receives power signals from and provides detection signals to system components as described below.

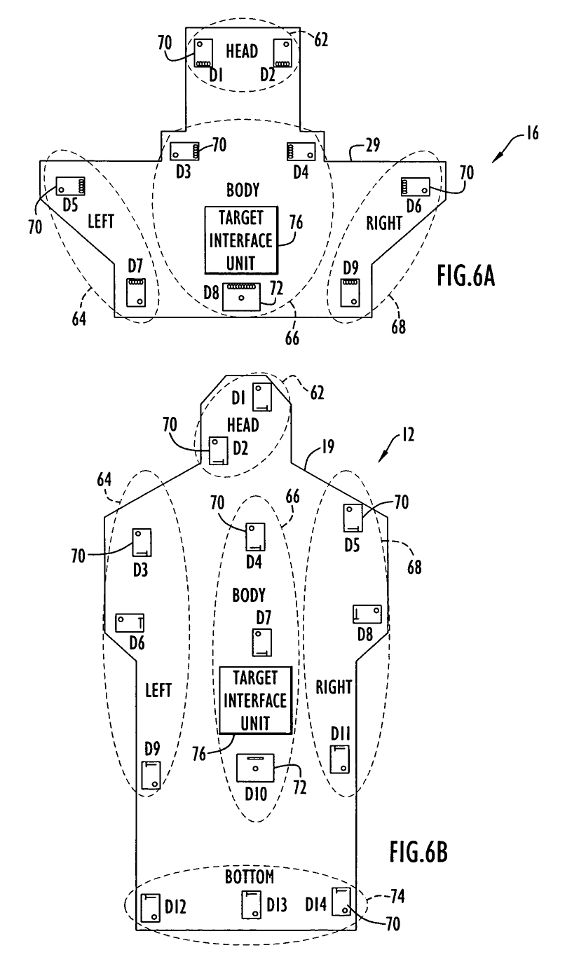

The detection circuitry within target object 16 is illustrated in FIG. 6A. In particular, platform 29 includes a plurality of detection units 70, a detection control unit 72 and a target interface unit 76. The detection units 70, 72 are arranged to detect beam impact locations on specific areas of target object 16. The target object is partitioned into a plurality of zones 62, 64, 66 and 68, each including a series of detection units coupled together. By way of example only, zone 62 includes a pair of detection units and is disposed toward a target area representing a head, zone 64 includes a pair of detection units and is disposed toward a target area representing the left portion of a chest (e.g., as viewed in FIG. 6A), zone 66 includes a pair of detection units 70 and detection control unit 72 and is disposed toward a target area representing a central portion of the chest, and zone 68 includes a pair of detection units and is disposed toward a target area representing the right portion of the chest (e.g., as viewed in FIG. 6A). Zones 62 and 66 basically represent kill type shots (e.g., shots to the head and chest), while zones 64 and 68 generally represent shots that may wound an intended target. However, the target may include any quantity of zones and/or detection units disposed at any suitable locations. Target interface unit 76 receives signals from detection control unit 72 for transfer to system components via connector cable 60. The target interface unit further receives power signals from system components via the connector cable and distributes the power signals to the detection circuitry. Moreover, the target interface unit controls gain of detection units 70 as described below.

The detection circuitry within target object 12 is illustrated in FIG. 6B. Initially, the detection circuitry is substantially similar to the detection circuitry described above and includes an additional zone to cover the increased target object dimensions. In particular, platform 19 includes a plurality of detection units 70, detection control unit 72 and target interface unit 76, each as described above. Detection units 70, 72 are arranged to detect beam impact locations on specific areas of target object 12. The target object is partitioned into a plurality of zones 62, 64, 66 and 68 to respectively cover the top portion, left target portion, central target portion and right target portion as described above. An additional zone 74 covers the bottom portion of target object 12 below zones 64, 66 and 68. By way of example, zones 62 and 66 include two detection units 70, while zones 64, 68 and 74 include three detection units 70. Zone 66 further includes detection control unit 72 as described above. Zones 62 and 66 basically represent kill type shots (e.g., shots to the head and chest), while zones 64, 68 and 74 generally represent shots that may wound an intended target. However, the target may include any quantity of zones and/or detection units disposed at any suitable locations. Target interface unit 76 receives signals from detection control unit 72 for transfer to system components via connector cable 60 as described above. The target interface unit further receives power signals from system components via the connector cable and distributes the power signals to the detection circuitry as described above. Moreover, the target interface unit controls gain of detection units 70 as described below.

The detection circuitry described above detect a beam impact for virtually any horizontal and vertical angular position of the beam impact on the front surface of shells 54, 55 (e.g., zero to one-hundred eighty degrees). The detection units are positioned to enable each detection unit to detect beam impacts in a specific corresponding area, thereby enabling this type of detection without use of separators or dividers in the target. For example, a beam impact to a head region is not detected by a detection unit positioned in the chest region. This enables beam impacts on the target to be segregated into zones and assigned different scores or kill potential as described below. Further, use of plural detection units enables isolated detection of beam impacts on the shells at any desired and precise locations (corresponding to any desired or specific body portions). Moreover, the enhanced detection with respect to specific beam impact locations enables enhanced training exercises (e.g., friend or foe, etc.). By way of example, a scenario including a hostage may be conducted since the detection units may detect hits on each of the hostage and enemy.

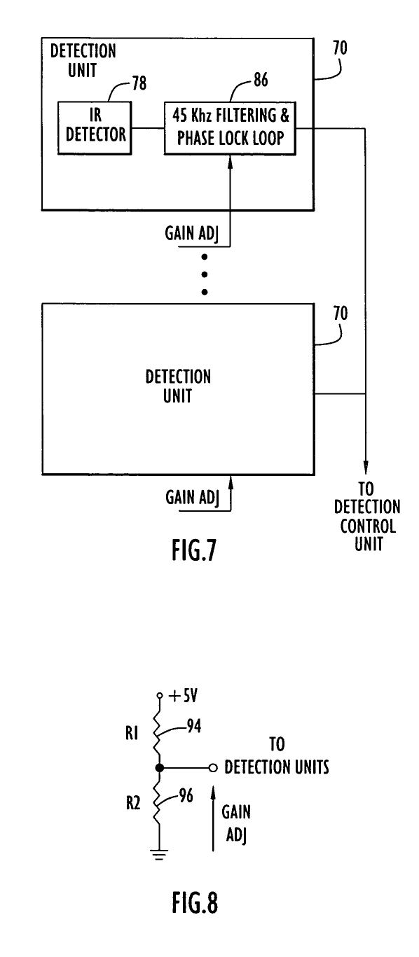

An exemplary detection unit arrangement for a target object zone is illustrated in FIG. 7. Specifically, each target object zone includes a plurality of detection units 70. The output of the detection units are coupled together to from a wired-AND type arrangement. Basically, a low signal from a detection unit indicates a beam impact, where a low output from any of the detection units within a zone pulls the coupled line low and results in a low signal for the zone. In this fashion, the detection units of the zone produce a hit signal when any of the zone detection units detect the beam impact, thereby indicating a hit in that zone.

Each detection unit includes an infrared (IR) detector 78 and a phase lock loop 86. The IR detector is preferably implemented by a diode and detects the laser beam passing through the target object shell (e.g., FIGS. 4-5, shells 54, 55). An aperture or mask is typically disposed over detector 78 to enable the detectors to detect a central portion of a laser beam. The mask may include an adhesive for application to the detector (e.g., be in the form of a sticker). Since the laser beam dimension expands as the distance between the user and target increases, the central portion of the beam represents an accurate indication of the user point of aim. Thus, the mask prevents the detector from indicating an impact based on the periphery of the laser beam (e.g., which may not accurately reflect the user point of aim due to the beam expansion), thereby enhancing system accuracy. Further, a filter may be placed over the detector in addition to, or in place of, the mask to filter extraneous light and enable the laser signal to pass through and contact the detector. This enhances detector sensitivity to the laser beam even in an environment with a large quantity of ambient light. Moreover, since detector 78 has a certain field of view, plural detectors may be employed in parallel to provide a wide sensing area. For example, three detectors may be employed in parallel each positioned at an angle relative to the other detectors to increase the field of view and sensing area of the detection unit. This may be accomplished by soldering techniques. In this fashion, the sensing area of each detection unit or assembly may be adjusted for a particular application. In addition, a central detector may be employed surrounded by four angled detectors to detect hits on far sights (e.g., when the user is at a far range from the target).

The output of the IR detector is provided to phase lock loop 86. Phase lock loop 86 basically processes and filters the information from IR detector 78 to determine the presence of the modulated laser beam (e.g., modulated at 45 KHz as described above). This enables the detection units to minimize false alarms due to ambient light. The phase lock loop produces signals indicating the presence of a beam impact, where the signals from each detection unit within the zone are coupled to produce a hit signal in response to any one of the detection units detecting a beam impact. The resulting hit signal produced by the target object zone is provided to detection control unit 72 (FIGS. 6A-6B) to determine the presence of a beam impact within any of the target object zones as described below.

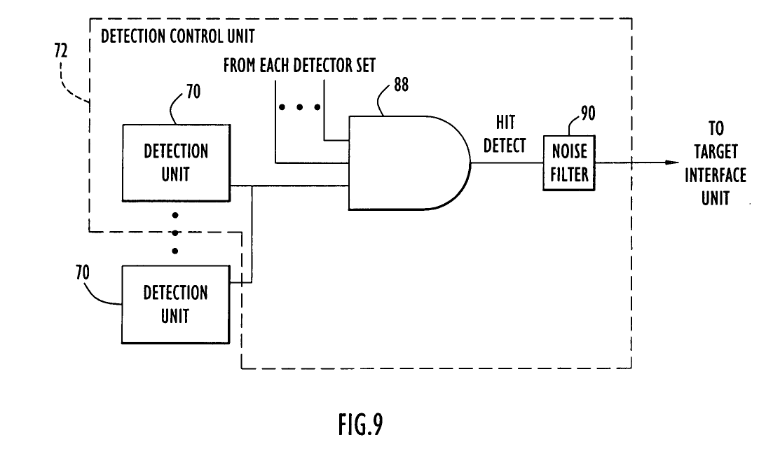

The phase lock loop receives a gain adjustment parameter from target interface unit 76 to control the threshold for indicating a beam impact. An exemplary gain control circuit within target interface unit 76 is illustrated in FIG. 8. Specifically, the circuit includes resistors 94 and 96 arranged in series with respect to each other and a power source (e.g., 5V). The output or gain adjustment parameter is ascertained from the potential between the resistors. Thus, the circuit basically forms a voltage divider, where the gain adjustment is controlled by the resistances of the resistors. The gain adjustment parameter basically reduces false alarms and enables the detection units to detect central portions of laser beams impacting the target object, thereby providing enhanced accuracy for low power lasers used over long distances.

Referring to FIG. 9, detection control unit 72 includes a detection unit 70 to detect beam impacts within an associated target object area of zone 66. The detection unit output is coupled to outputs from the other detection units within zone 66 (FIGS. 6A-6B) to provide a hit signal in response to any of those detection units detecting a beam impact. The detection control unit further receives information from the combined outputs of detection units 70 within the other target object zones and includes AND type logic 88 (e.g., logic gate, circuitry, etc.) to receive the outputs from each target object zone and provide a hit signal to target interface unit 76 when any of the zones detect a beam impact. Since a low signal from a zone indicates a beam impact as described above, AND type logic 88 produces a low signal in response to any zone detecting a beam impact. The zone information is typically produced from phase lock loops 86 as described above. The output of logic 88 is provided to a noise filter 90 that filters extraneous noise signals to produce a hit detect signal indicating a beam impact. The hit detect signal is transferred to target interface unit 76 for conveyance to system components via connector cable 60 (FIGS. 4-5). The system design enables detection of laser pulses at a sufficient rate to enable use with automatic type weapons (e.g., machine gun, M249, M240, etc.) having firing rates on the order of 1,500 rounds per minute.

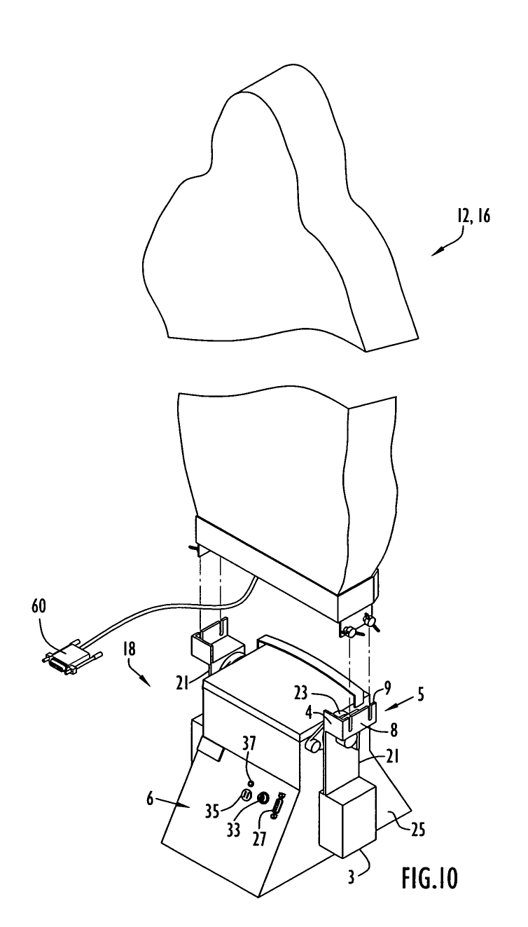

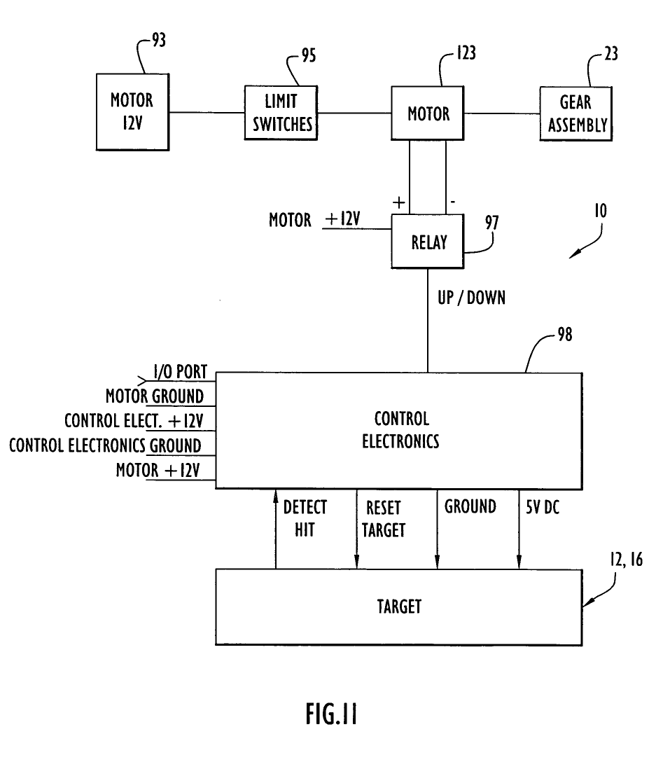

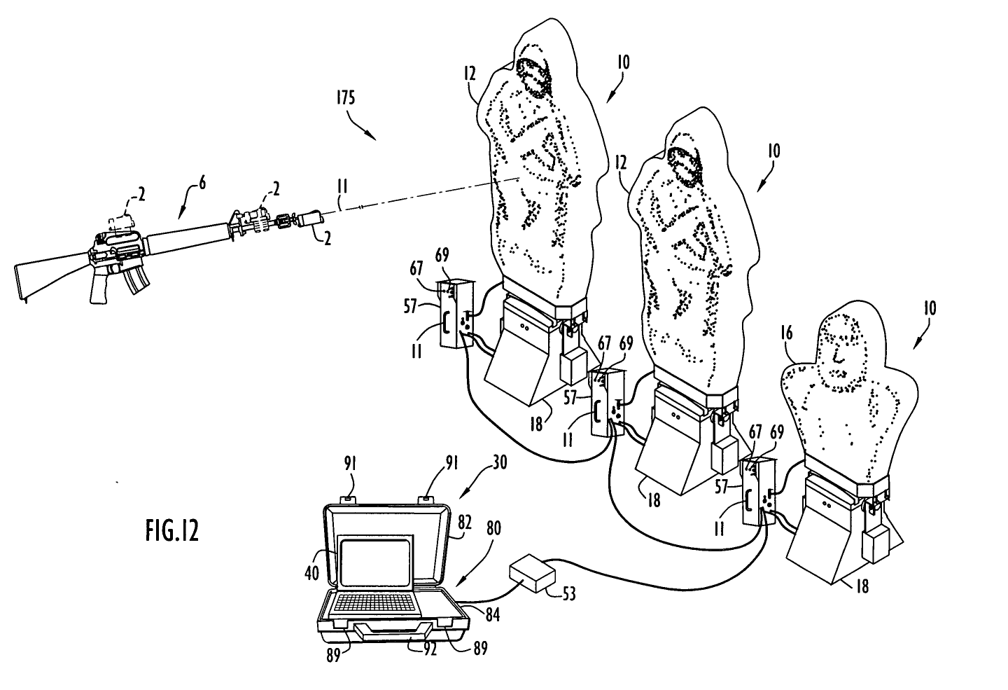

A target assembly 10 according to the present invention is illustrated in FIG. 10. Specifically, the target assembly includes a target object 12, 16 and an actuation unit 18 as described above. Actuation unit 18 includes a housing 25 including a rear panel 6 and movable arms 21 with target object 12, 16 attached thereto. The housing includes an assembly motor 123 (FIG. 11) and a control unit or control electronics or circuitry 98 as described below. A housing bottom wall includes a threaded hole (not shown) disposed toward each corresponding bottom wall corner. The holes may receive corresponding feet or may be utilized to mount the target assembly on various support structures (e.g., wall, table, door, etc.) or to affix any attachments as desired. Arms 21 are each disposed adjacent an upper portion of a corresponding housing side wall exterior surface and are attached to a corresponding gear assembly 23 that extends through the side wall and is coupled to the assembly motor within the housing.

Each arm includes a weighted proximal end portion 3 in the form of a block and an engagement member 5 disposed at the arm distal end. The weighted portion is suitable for manipulating target object 16. However, additional weight blocks (not shown) are typically placed on the arm weighted portion to accommodate the increased mass and dimensions of target object 12. The engagement member includes a rear panel 7 extending transversely relative to the arm, a bottom panel 4 and a side panel 8 with the side and bottom panels respectively attached to the side and bottom edges of the rear panel. The side wall includes a plurality of slots 9 to receive the bolts of fastening members 59 for securing target object 12, 16 to actuation unit 18. The motor actuates the gear assemblies 23, thereby actuating arms 21 to raise or lower target object 12, 16 in response to control signals from assembly control electronics 98 as described below. Travel of arms 21 is controlled by actuation of microswitches (not shown) as the arms move to the end of the desired travel distance. The movement of the arms is considered complete with the arm either in the up or down position depending upon the direction of actuation. This limiting of arm travel may alternatively be accomplished by any conventional or other techniques, and may further include electronic components, such as diodes, to provide fixed or variable speed control of arm movement.

The front panel of housing 25 (FIG. 1) includes a series of light emitting diodes (LEDs) 159, 162. LED 159 is typically yellow and flashes in response to raising of target object 12, 16, while LED 162 is typically green and is illuminated in response to lowering of target 12, 16 upon detection of a hit (e.g., the appropriate quantity of hits or beam impacts). Thus, LED 162 is generally illuminated in response to detection of a hit. Housing rear panel 6 includes light emitting diode (LED) 37, a fuse 35, a motor receptacle 33 and a target receptacle 27. LED 37 may be illuminated to indicate reception of power signals for the assembly motor. Fuse 35 protects the internally housed control electronics, while motor receptacle 33 is connected to a corresponding interface unit motor receptacle via an appropriate cable to transfer information and receive power signals for the assembly motor. Target receptacle 27 facilitates connection, via connector cable 60, to a corresponding target object in order to supply power signals to the target object and facilitate transmission and reception of information between the target object and control electronics as described below. The actuation unit may be positioned in various orientations, or the arms may be configured for various motions of travel. For example, the actuation unit may be configured or oriented to provide lateral motion (e.g., in addition to or in place of the up and down motion) for a target object. This enables the target object to be placed behind or around obstacles within a user view to simulate various scenarios (e.g., the target object may be positioned adjacent a doorway outside a user view and be moved toward a user approaching or passing through the doorway, the target object may be positioned to move toward an approaching user from behind a rock or tree, etc.).

The target assembly components controlling assembly operation in response to control signals are illustrated in FIG. 11. Specifically, the actuation unit includes a motor voltage 93, limit switches 95, motor 123, gear assembly 23, relay 97 and control electronics or circuitry 98. The motor actuates arms 21 to raise and lower target object 12,16 and receives power from motor voltage 93, typically in the form of 12V DC. The control electronics generally receives the motor voltage from the interface unit via the assembly motor receptacle. Limit switches 95 provide indications of arm position and are utilized to limit movement of the arm within a prescribed angular space. Control electronics 98 may be implemented by logic or other circuitry and activates relay 97 (e.g., transmits command signals, such as up/down, left/right, etc.) to control motor 123. The relay may be implemented by any conventional relays, and typically receives motor voltage of 12V DC. The control electronics transfers power and information signals through receptacle 27 and connector 60 to target 12. By way of example only, the control electronics provides reset, ground and power signals (e.g., 5V DC) to the target, and receives from the target a detection signal in response to detection of a hit.

The control electronics receives power (e.g., motor voltage 12V DC, control electronics voltage 12V DC) and ground signals (e.g., motor ground and control electronics ground) and information from the interface unit via motor receptacle 33. The control electronics basically includes an input/output (I/O) port and transfers various signals between the assembly and interface unit. By way of example only, the control electronics may receive control signals conveying instructions in the form of up/down actuation, assembly reset, double/single hit detection (e.g., quantity of hits to lower a raised target and provide information as described above) and utility functions (e.g., sound effects, etc.). The control electronics generally transmits hit detection information to the interface unit via the I/O port. An additional input may be supplied from the control electronics to the interface unit in accordance with a particular application.

The control electronics is coupled to interface unit 14 (FIG. 1), motor 123 and target object 12, 16, and controls target assembly operation in accordance with control signals from computer system 40. The control electronics receives control signals from the interface unit, interprets the control signals and controls the arm to raise the target until the raised target is impacted an appropriate quantity of times by the beam or the computer system directs the control electronics to lower the target due to expiration of the time interval. Further, the control electronics controls target actuation based on the arm position indicated by the limit switch signals as described above. When a time interval for a raised target expires as determined by the computer system, the control electronics receives the appropriate control signals and controls motor 123 to lower the target. In response to the laser beam impacting target object 12, 16, the target sends a signal to the control electronics indicating beam impact. The control electronics determines whether or not the appropriate quantity of beam impacts occurred, and if so, controls motor 123 to lower the target. The control electronics unit further transmits a hit indication to interface unit 14 for forwarding to computer system 40. The time intervals and target sequence are programmable via computer system 40 to simulate various scenarios as described below. The control electronics may further respond to status inquiries of the target assembly by interface unit 14. The target assemblies may further include appropriate components or be configured to provide sound effect generation, visual light indications and/or response to or indication of other events. In addition, the target assemblies may activate any type of devices in response to beam or hit detection in accordance with particular applications (e.g., audio devices, actuators to manipulate objects, visual indicator devices, etc.), and may actuate the targets in response to input signals received from devices detecting events (e.g., audio, motion or other sensors may be utilized to actuate the targets). The additional devices may be modularly configurable or may be in a fixed configuration, or any combination thereof.

Operation of system 50 is described with reference to FIG. 1-2. Initially, the target assemblies are arranged in a desired configuration and computer system 40 is commanded to control the target assemblies in accordance with an entered sequence or scenario template as described below. As each target object 12, 16 is raised, the user aims the firearm and projects a laser beam at that target. When a raised target is impacted an appropriate quantity of times within the specified time interval, the target is lowered and hit information is transmitted to the computer system as described above. In addition, a hit is indicated by the target assembly indicators (LEDs) as described above. If the beam does not impact a raised target within the specified time interval, the target is lowered in response to control signals from the computer system as described above and the computer system scores a miss. The computer system receives the hit information and provides feedback information to the user in the form of graphical user screens and/or a printed report as described below.

System 50 controls target actuation in accordance with impacts at any locations on the target objects as described above. The transfer of information between the target assemblies and computer system is generally limited to occurrence of a beam impact within any of the zones. In addition, the distance between the target assemblies and control stations is also limited due to the signal strength decreasing for cables extending over greater distances. A system 175 that further provides beam impact location information and enables greater distances between the target assemblies and control station for long range training is illustrated in FIG. 12. Initially, system 175 is substantially similar to system 50 described above and further provides beam impact location information to a user. In particular, firearm laser training system 175 includes laser transmitter assembly 2, actuable target assemblies 10, a converter unit 53 and control station 30. The laser assembly is attached to an unloaded user firearm 6 to adapt the firearm for compatibility with the training system. By way of example only, firearm 6 may be implemented by a conventional M-16 type rifle equipped to emit laser pulses in response to user actuation as described above. However, the firearm may be implemented by any conventional firearms (e.g., hand-gun, rifle, shotgun, etc.), while the laser and firearm combination may be implemented by any of the simulated firearms disclosed in the above-mentioned patents and patent application. Target assemblies 10 are each substantially similar to the target assemblies described above and are coupled to an actuation interface unit 57 to facilitate communications with computer system 40. The target assemblies include target object 12 or 16 and actuation unit 18, each substantially similar to those described above to raise or lower a corresponding target object.

The targets are individually raised by corresponding target assemblies 10 at prescribed times for a specified time interval to indicate intended targets for the user, and are lowered in response to the beam impacting the raised targets within that interval (e.g., indicating a hit) or upon expiration of the interval without a beam impact in response to receiving a signal from the computer system to lower the target (e.g., indicating a miss) as described above. A user aims firearm 6 at the target objects and actuates the firearm to project laser beam 11 from laser assembly 2 toward the target object. The target objects detect beam impacts and transfer information to control station 30. Thus, various training scenarios may be conducted, where the participants can engage the target objects to simulate combat, law enforcement or other scenarios.

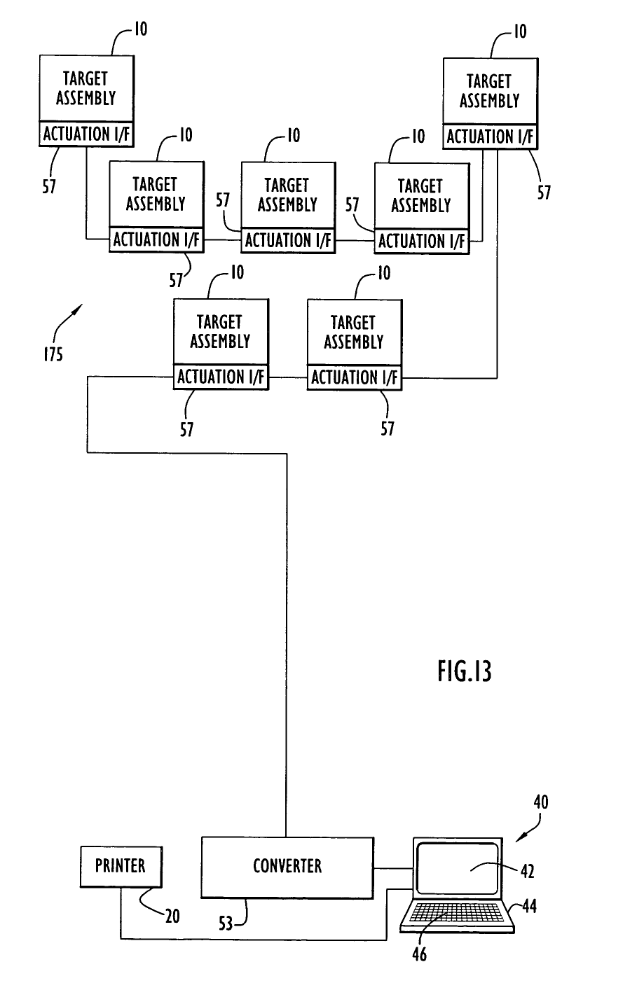

Control station 30 includes computer system 40 as described above and may be housed within case 80 as described above. Computer system 40 controls system operation and may provide various feedback to a user. Referring to FIG. 13, computer system 40 and target assemblies 10 are connected to converter unit 53. The connections between converter unit 53 and the target assemblies are preferably implemented by RS-485 type cables to enable distances between the control station and target assemblies of up to approximately 1.2 kilometers. Actuation interface units 57 convert signals between formats for the target assembly and an RS-485 type format, while converter unit 53 basically converts signals between RS-485 and RS-232 type formats to enable transfer of target assembly signals with computer system 40. However, any suitable formats may be utilized (e.g., USB, Ethernet, etc.). The actuation interface units are connected to each other in a daisy-chain type arrangement to communicate with converter unit 53. This arrangement basically serves as a bus, where each actuation interface unit may be individually addressed to receive information (e.g., each unit listens and retrieves information from the chain that is directed to that unit) and may transmit information along the chain to converter unit 53. Printer 20 may further be connected to the computer system to print reports containing user feedback information (e.g., score, hit/miss information, etc.). Converter unit 53 and printer 20 may be connected to various ports of the computer system (e.g., serial, USB, parallel, etc.).

Converter unit 53 includes a programmable device or other control circuitry (e.g., microprocessor, logic or other circuitry, etc.) and relays control signals from the computer system in the suitable format to control the target assemblies. Specifically, the computer system generates controls for the target assemblies in accordance with an entered target sequence as described above. The control information typically includes a command to raise or lower a specific target. The computer system may control each target assembly individually. The control signals are encoded by the computer system and transmitted to converter unit 53 through a computer system port (e.g., RS-232 serial, USB, Ethernet, etc.). Converter unit 53 receives the encoded signals and converts them into the proper format (e.g., RS-485) for transference to the individual target assemblies. Converter unit 53 further receives signals from the target assemblies in an RS-485 type format and converts the signals to an RS-232 type or other format (e.g., USB, Ethernet, etc.) for transference to the computer system for processing.

Converter unit 53 may be further linked to one or more extender units or a connection interface unit to respectively communicate with an additional series of target assemblies 10, sensors, targets or other systems as described above. In addition, one or more target assemblies may be disposed on a moving platform to enable target lateral motion relative to a user. The moving platform may be linked to converter unit 53 to enable control of the platform by computer system 40 as described above.

Target objects 12, 16 are substantially similar to those described above and include detection circuitry to detect a beam impact for virtually any horizontal and vertical angular position of the beam impact on the front surface of the target object shells (e.g., zero to one-hundred eighty degrees). The detection units are positioned to enable each detection unit to detect beam impacts in a specific corresponding area as described above. Further, use of plural detection units enables isolated detection of beam impacts on the shells at any desired and precise locations (corresponding to any desired or specific body portions). Moreover, the enhanced detection with respect to specific beam impact locations enables enhanced training exercises (e.g., friend or foe, etc.).

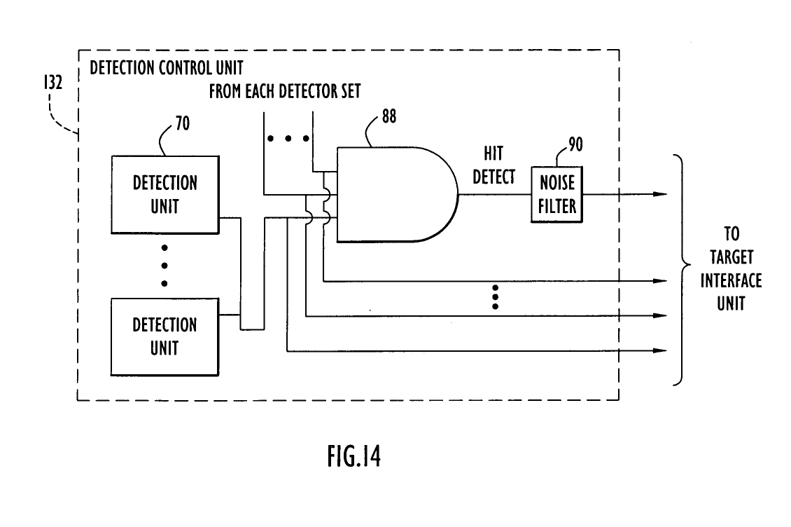

The detection circuitry within target objects 12, 16 is substantially similar to the circuitry described above for FIGS. 6A-6B and 7-9, except that the detection control unit is slightly modified to provide the detection signals from each of the zones as illustrated in FIG. 14. Initially, target object 12, 16 is partitioned into a plurality of zones (e.g., 62, 64, 66, 68 and 74 as illustrated in FIGS. 6A-6B) with each zone including a plurality of detection units as described above. The output of the detection units within each zone are coupled together to produce a detection signal in response to any detection units within that zone detecting a beam impact as described above for FIG. 7. The detection control unit disposed within zone 66 (FIGS. 6A-6B) receives the detection signals from each zone and produces a hit detect signal as described above.

In particular, detection control unit 132 is substantially similar to detection control unit 72 described above and includes a detection unit 70 to detect beam impacts within an associated target object area of zone 66. The detection unit output is coupled to outputs from the other detection units within zone 66 (FIGS. 6A-6B) to provide a hit signal in response to any of those detection units detecting a beam impact. The detection control unit further receives information from the combined outputs of detection units 70 within the other target object zones and includes AND type logic 88 (e.g., logic gate, circuitry, etc.) to receive the outputs from each target object zone and provide a hit signal to target interface unit 76 when any of the zones detect a beam impact as described above. The zone information is typically produced from phase lock loops 86 (FIG. 7) of the detection units as described above. The output of logic 88 is provided to noise filter 90 that filters extraneous noise signals to produce a hit detect signal indicating a beam impact as described above. The hit detect signal along with the detection signals from each of the zones is transferred to target interface unit 76 for conveyance to system components via connector cable 60 (FIGS. 4-5). The detection signals from the zones indicate the zone or location of the beam impact. The system design enables detection of laser pulses at a sufficient rate to enable use with automatic type weapons (e.g., machine gun, M249, M240, etc.) having firing rates on the order of 1,500 rounds per minute.

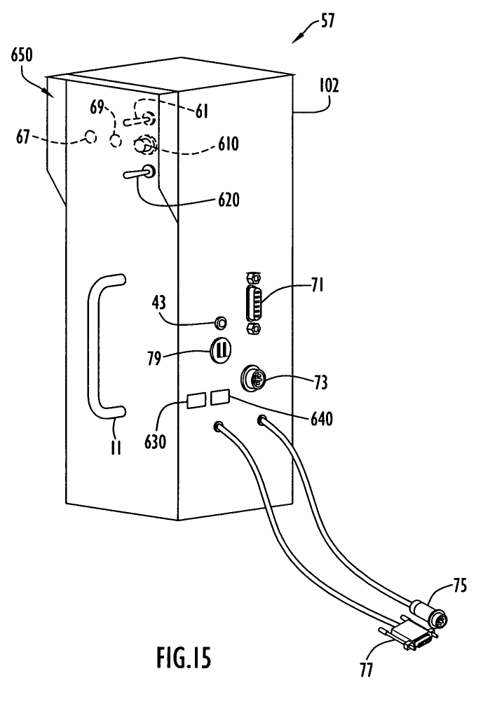

Actuation interface unit 57 enables communication between a corresponding target assembly 10 and computer system 40 and is illustrated in FIG. 15. Initially, the actuation interface unit receives power from a common wall outlet jack or a portable power source (e.g., rechargeable or other battery, vehicle electrical system etc.) and provides power signals and communications for the system components (e.g., actuation unit, target object, converter unit 53, etc.) as described below. Specifically, the actuation interface unit includes a housing 102 with front, rear, top, bottom and side walls collectively forming a unit interior. The housing further includes a projection or overhang 650 disposed at the housing upper portion and extending from the top and side wall front edges. A battery compartment (not shown) for a rechargeable or other battery is disposed in the lower rear portion of the housing. The actuation interface unit front wall includes a power switch 620 to enable unit activation and/or charging of the rechargeable battery. The front wall may further include high intensity light emitting diodes (LEDs) 67, 69, a reset switch 610 to reset the unit and an intensity switch 61 to control the intensity of the LEDs. The LEDs may be alternately illuminated in response to successive beam impacts and are generally visible for distances of approximately three-hundred meters. Projection 650 enhances visibility of the LEDs in conditions with ambient light (e.g., day time, etc.). A handle 11 is disposed on the unit front wall to enable transport of the unit, while the unit side wall includes a light emitting diode (LED) 43, a target receptacle 71, a charge receptacle 73, an actuator connector 75, a target connector 77, a fuse 79 and data receptacles 630, 640. LED 43 may be illuminated to indicate reception of power signals, while fuse 79 protects the internally housed control electronics. Signals from the target object (e.g., information related to beam impacts and locations of those impacts) are received by the actuation interface unit via target receptacle 71. This receptacle engages connector cable 60 (FIGS. 4-5) of a corresponding target object 12, 16 and further provides power signals to that target object. The actuation interface unit relays signals from the target object to the actuation unit control electronics via target connector 77 connected to target receptacle 27 of the actuation unit (FIG. 10). This connection enables transfer of information (e.g., hit detection signals) between the target object and actuation unit to actuate the target as described above.

Actuator connector 75 is connected to actuation unit motor receptacle 33 (FIG. 10) to provide power signals to the actuation unit and enable transference of information (e.g., information related to beam impacts, locations of those impacts and control of target actuation) between that unit and the computer system. Data receptacles 630, 640 may be implemented by any conventional jacks or sockets and each receive a corresponding RS-485 type cable to enable transfer of information between the actuation interface unit and converter unit 53 (and, hence, computer system 40). Data receptacles 630, 640 enable linking between the target assemblies to transmit and receive information from the chain of actuation units. Charge receptacle 73 enables charging of the unit rechargeable battery. Thus, the actuation interface unit basically provides power signals to system components and facilitates transfer of information between the computer system and target assemblies.

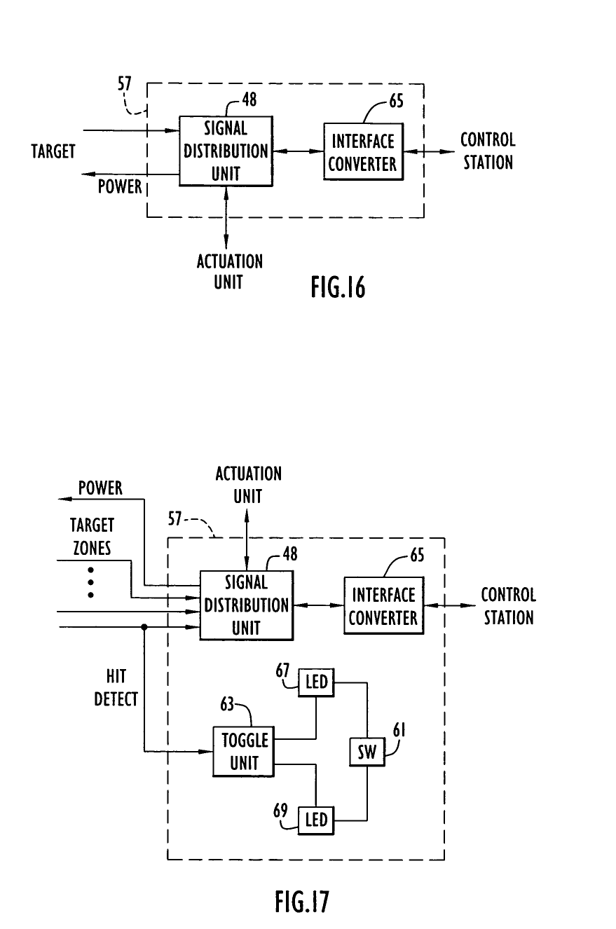

An exemplary control circuit for the actuation interface unit is illustrated in FIG. 16. Specifically, actuation interface unit 57 includes a signal distribution unit 48 and an interface converter 65. The signal distribution unit receives the hit detect signal and detection signals from each target zone within the target object. This information is received via connector cable 60 and target receptacle 71 and indicates occurrence of a beam impact and the location of the impact on the target object. The signal distribution unit further provides power signals to the target object via the connector cable and target receptacle 71. Moreover, the signal distribution unit provides power signals and the appropriate control signals to the actuation unit control electronics (FIG. 11), via actuator connector 75 and target connector 77, to enable actuation of the target object as described above. The signal distribution unit may be implemented by any conventional or other circuitry, components or devices to enable distribution of signals (e.g., multiplexers, gate arrays, switches, etc.).

Interface converter 65 is coupled to the signal distribution unit and receives signals for transference to the control station (e.g., via the chain or data receptacles 630 and/or 640). Interface converter 65 converts the detection and hit detect signals to an RS-485 type format for transmission to converter unit 53 (FIG. 12) via the chain or data receptacles 630 and/or 640 and RS-485 type cables. Converter unit 53 receives the transmitted signals and converts the received signals to an RS-232 type or other format for transmission to computer system 40 as described above. In addition, interface converter 65 receives signals in an RS-485 type format from converter unit 53 (e.g., via the chain or data receptacles 630 and/or 640) and converts the signals to a format compatible with the actuation unit and/or target object for distribution by signal distribution unit 48. Interface converter 65 includes a programmable device or other control circuitry (e.g., microprocessor, logic or other circuitry, etc.) to relay signals between the actuation interface unit and converter unit 53.

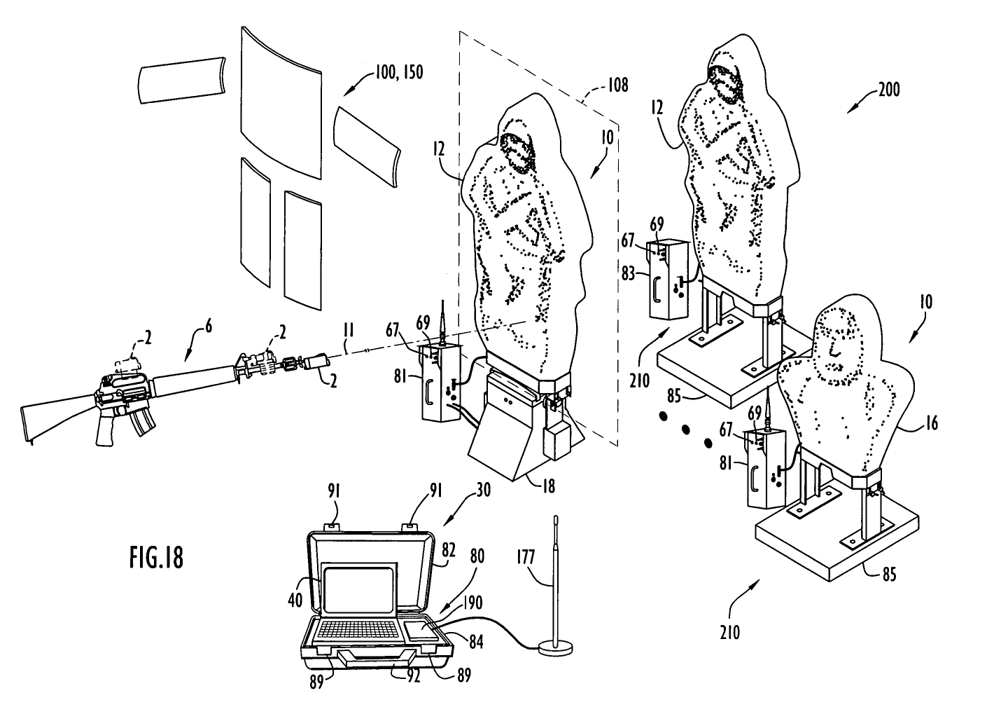

In addition, the actuation interface unit may further include a toggle unit to control illumination of indicators as illustrated in FIG. 17. In particular, actuation interface unit 57 includes signal distribution unit 48 and interface converter 65, each as described above to convey signals between the actuation unit, target object and control station. The actuation interface unit may further include toggle unit 63 to alternately illuminate LEDs 67, 69 and intensity switch 61 to control the intensity of the LEDs. Specifically, the toggle unit receives the hit detect signal indicating a beam impact in one or more of the zones. The toggle unit preferably includes a pair of ‘D’-type flip flops arranged in series with each flip flop controlling a corresponding LED 67, 69. The flip flops are each configured to toggle their output and are arranged to be clocked to provide only one flip flop with a logic one state with each beam impact, thereby enabling only one LED 67, 69 for each beam impact. The LEDs are alternately illuminated with each successive beam impact to indicate a hit to a user. The user may manipulate switch 61 to control the intensity of the LEDs and accommodate various environmental or other conditions (e.g., night time, night vision, day time, etc.). For example, low intensity may be utilized for night time exercises and to prevent night vision sights from becoming saturated upon a hit, while high intensity may be used for day time activities to enable a hit to be more visible to a user. The switch may be implemented by any conventional or other switching devices.

Operation of system 175 is described with reference to FIGS. 12-13. Initially, the target assemblies are arranged in a desired configuration and computer system 40 is commanded to control the target assemblies in accordance with an entered sequence or scenario template as described below. As each target object 12, 16 is raised, the user aims the firearm and projects a laser beam at that target. When a raised target is impacted an appropriate quantity of times within the specified time interval, the target is lowered and hit information including beam impact locations is transmitted to the computer system as described above. In addition, a hit may be indicated by the actuation interface unit indicators (LEDs) as described above. If the beam does not impact a raised target within the specified time interval, the target is lowered in response to control signals from the computer system as described above and the computer system scores a miss. The computer system receives the hit information and provides feedback information to the user including impact locations in the form of graphical user screens and/or a printed report as described below.

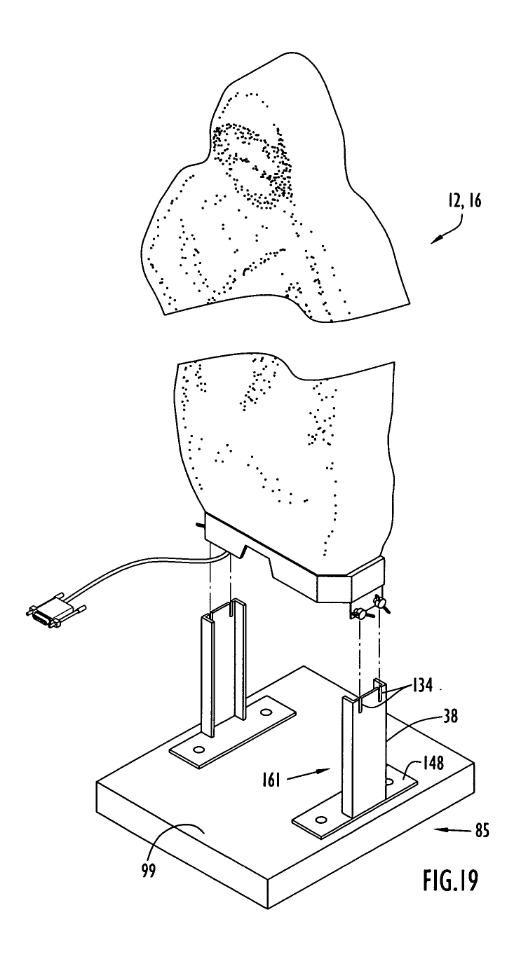

A firearm laser training system employing target assemblies and/or laser-detecting body gear in communication with a control station via a wireless communication system according to the present invention is illustrated in FIG. 18. The system provides beam impact location information and enables greater distances between the target assemblies and control station for long range training. The system may employ wireless communications and protocols enabling transference of information over a range of approximately two-hundred meters. Further, the system may employ wireless communications and protocols enabling transference of information over an extended range of approximately one mile. Specifically, firearm laser training system 200 includes laser transmitter assembly 2, control station 30 and one or more targets in the form of actuable target assembly 10 including a target object 12, 16, stationary target assembly 210 including a target object 12, 16 and/or laser-detecting body gear 100, 150. The body gear tends to be durable and provides enhanced protection for the components detecting the beam impacts as described below. The laser assembly is attached to user firearm 6 to adapt the firearm for compatibility with the training system. By way of example only, firearm 6 may be implemented by a conventional M-16 type rifle equipped to emit laser pulses in response to user actuation as described above. However, the firearm may be implemented by any conventional firearms (e.g., hand-gun, rifle, shotgun, etc.), while the laser and firearm combination may be implemented by any of the simulated firearms disclosed in the above-mentioned patents and patent application.

Target assemblies 10 are each substantially similar to the actuable target assemblies described above and are coupled to a communication interface unit 81 to facilitate communications with computer system 40 via a wireless communication system. The target assemblies include target object 12 or 16 and actuation unit 18, each substantially similar to those described above. The actuation unit raises or lowers a corresponding target object in accordance with control signals from the control station, while body gear 100, 150 is typically worn by users during training. The target objects are individually raised by corresponding target assemblies 10 at prescribed times for a specified time interval to indicate intended targets for the user, and are lowered in response to the beam impacting the raised target objects within that interval (e.g., indicating a hit) or upon expiration of the interval without a beam impact in response to receiving a signal from the computer system to lower the target (e.g., indicating a miss) as described above. Stationary target assemblies 210 may be utilized as stand-alone targets or be integrated within system 200. These target assemblies include a corresponding target object 12, 16 that remains relatively stationary as described below. The stationary target assembly may employ an impact display unit 83 to indicate beam impacts to a user in a stand-alone application, while communication interface unit 81 may be utilized with the stationary target assembly for use with system 200 to facilitate communications with computer system 40 via a wireless communication system.

A user aims firearm 6 at the target objects or body gear of another user and actuates the firearm to project laser beam 11 from laser assembly 2 toward the target object and/or body gear. The target objects and body gear detect beam impacts and transfer information to control station 30 via a wireless communication system. Thus, various training scenarios may be conducted, where the participants can engage the target objects and/or each other to simulate combat, law enforcement or other scenarios.

Target objects 12, 16 are substantially similar to those described above and include detection circuitry to detect a beam impact for virtually any horizontal and vertical angular position of the beam impact on the front surface of the target object shells (e.g., zero to one-hundred eighty degrees). The detection units are positioned to enable each detection unit to detect beam impacts in a specific corresponding area as described above. Further, use of plural detection units enables isolated detection of beam impacts on the shells at any desired and precise locations (corresponding to any desired or specific body portions). Moreover, the enhanced detection with respect to specific beam impact locations enables enhanced training exercises (e.g., friend or foe, etc.).

The detection circuitry within target objects 12, 16 is substantially similar to the circuitry described above for FIGS. 6A-6B, 7, 8 and 14 with the detection control unit providing the detection signals from each of the zones to indicate beam impact locations. Initially, target object 12, 16 is partitioned into a plurality of zones (e.g., 62, 64, 66, 68 and 74 as illustrated in FIGS. 6A-6B) with each zone including a plurality of detection units as described above. The outputs of the detection units within each zone are coupled together to produce a detection signal in response to any detection units within that zone detecting a beam impact as described above for FIG. 7. The detection control unit disposed within zone 66 (FIGS. 6A-6B and 7) receives the detection signals from each zone and produces a hit detect signal as described above. The hit detect signal along with the detection signals from each of the zones are transferred to target interface unit 76 for conveyance to system components via connector cable 60 (FIGS. 4-5) as described above.

Control station 30 includes a reader 190 and computer system 40. The computer system is substantially similar to the computer system described above. The reader includes a transportable antenna 177 and communicates with interface units 81 and/or body gear 100, 150 to transfer control and target impact information via a wireless or RF link as described below. The computer system is coupled to reader 190 and provides control information and processes impact information to display simulated projectile impact locations on a target image via graphical user screens as described below. The control station is preferably housed within case 80 that is substantially similar to the case described above with case lower member 84 supporting reader 190.

System 200 may be utilized with actuable and/or stationary target assemblies 10,210. The actuable target assemblies are substantially similar to those described above. A stationary target assembly 210 is illustrated in FIG. 19. Specifically, target assembly 210 includes target object 12, 16 as described above and a stand 85. The stand includes a base or platform 99 with a pair of legs 161 attached thereto. The legs are each disposed toward a corresponding side edge of platform 99 and include a base 148 attached to the platform and a target support 38. The target support extends upward from the side edge of base 148 and is generally ‘U’-shaped. The upper portion of target support 38 includes a pair of slots 134 to engage fastening members 59 of target object 12, 16 (FIGS. 4-5). The target object engages the stand in substantially the same manner as that described above for the actuation unit.

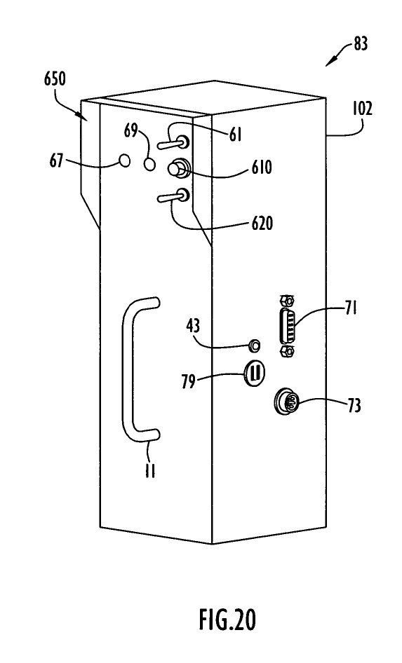

Stationary target assembly 210 may be utilized as a stand-alone target and is coupled to impact display unit 83 to indicate beam impacts to a user. An exemplary impact display unit is illustrated in FIG. 20. The impact display unit is similar to actuation interface unit 57 described above (FIG. 15) and includes housing 102 with front, rear, top, bottom and side walls collectively forming a unit interior. The impact display unit receives power from a common wall outlet jack or a portable power source (e.g., rechargeable or other battery, vehicle electrical system, etc.) and provides power signals to the system components (e.g., target object, etc.) as described below. The housing further includes a projection or overhang 650 disposed at the housing upper portion and extending from the top and side wall front edges. A battery compartment (not shown) for a rechargeable or other battery is disposed in the lower rear portion of the housing. The impact display unit front wall includes power switch 620 to enable unit activation and/or charging of the rechargeable battery, high intensity light emitting diodes (LEDs) 67, 69, a reset switch 610 to reset the unit and intensity switch 61 to control intensity of the LEDs, each as described above. The LEDs are alternately illuminated in response to successive beam impacts and are generally visible for distances of approximately three-hundred meters. Projection 650 enhances visibility of the LEDs in conditions with ambient light (e.g., day time, etc.). A handle 11 is disposed on the unit front wall to enable transport of the unit, while the unit side wall includes light emitting diode (LED) 43, target receptacle 71, charge receptacle 73 and fuse 79, each as described above. LED 43 may be illuminated to indicate reception of power signals, while fuse 79 protects the internally housed control electronics as described above. Signals from the target object (e.g., information related to beam impacts) are received by the impact display unit via target receptacle 71. This receptacle engages connector cable 60 (FIGS. 4-5) of a corresponding target object 12, 16 and provides power signals to that target object. The impact display unit receives the detection signals from the target object and alternately illuminates diodes 67, 69 to indicate beam impacts to a user. Charge receptacle 73 enables charging of the unit rechargeable battery as described above.

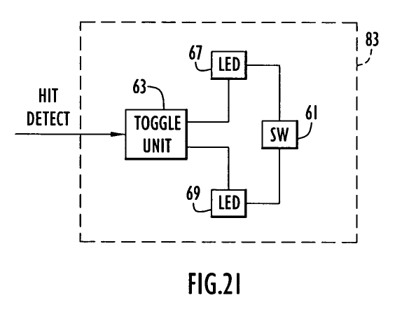

An exemplary control circuit for the impact display unit is illustrated in FIG. 21. Initially, the circuitry is similar to the corresponding circuitry described above for FIG. 17. In particular, impact display unit 83 includes toggle unit 63 to alternately illuminate LEDs 67,69 and switch 61 to control the intensity of the LEDs. Specifically, the toggle unit is substantially similar to the toggle unit described above and receives the hit detect signal indicating a beam impact in one or more of the zones. The toggle unit preferably includes a pair of ‘D’-type flip flops arranged in series with each flip flop controlling a corresponding LED 67, 69. The flip flops are each configured to toggle their output and are arranged to be clocked to provide only one flip flop with a logic one state with each beam impact, thereby enabling only one LED 67, 69 for each beam impact. The LEDs are alternately illuminated with each successive beam impact to indicate a hit to a user. The user may manipulate switch 61 to control the intensity of the LEDs and accommodate various environmental or other conditions (e.g., night time, night vision, day time, etc.). For example, low intensity may be utilized for night time exercises and to prevent night vision sights from becoming saturated upon a hit, while high intensity may be used for day time activities to enable a hit to be more visible to a user. The switch may be implemented by any conventional or other switching devices.

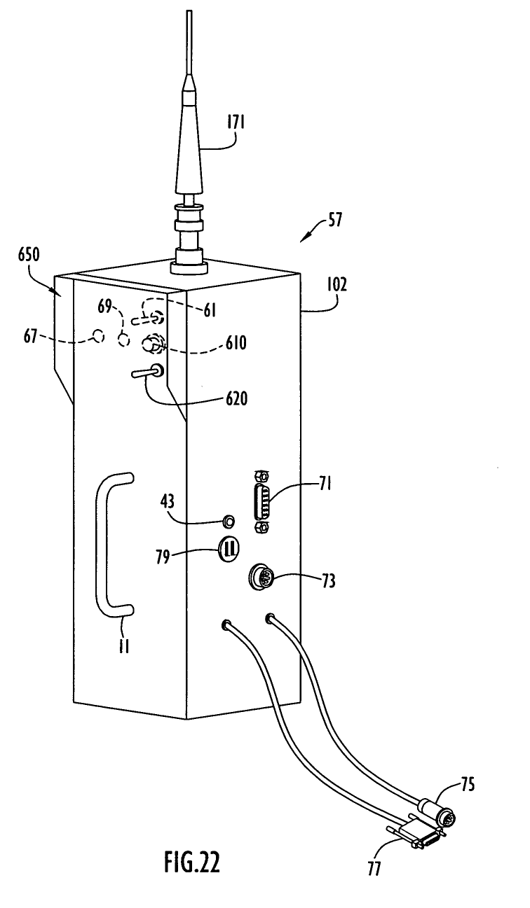

System 200 may be utilized with the actuable and/or stationary target assemblies, where these assemblies communicate with computer system 40 via a wireless communications system as described above. In order to establish communications with computer system 40 for training system operation, the actuable and stationary target assemblies employ communication interface unit 81 as illustrated in FIG. 22. Specifically, the communication interface unit is similar to actuation interface unit 57 described above (FIG. 15) and includes housing 102 with front, rear, top, bottom and side walls collectively forming a unit interior. The communication interface unit receives power from a common wall outlet jack or a portable power source (e.g., rechargeable or other battery, vehicle electrical system etc.) and provides power signals to the system components (e.g., actuation unit, target object, etc.) as described below. The housing further includes a projection or overhang 650 disposed at the housing upper portion and extending from the top and side wall front edges. A battery compartment (not shown) for a rechargeable or other battery is disposed in the lower rear portion of the housing. The communication interface unit front wall includes power switch 620 to enable unit activation and/or charging of the rechargeable battery as described above. The front wall may further include high intensity light emitting diodes (LEDs) 67, 69, reset switch 610 to reset the unit and intensity switch 61 to control the intensity of the LEDs, each as described above. The LEDs may be alternately illuminated in response to successive beam impacts and are generally visible for distances of approximately three-hundred meters. Projection 650 enhances visibility of the LEDs in conditions with ambient light (e.g., day time, etc.). A handle 11 is disposed on the unit front wall to enable transport of the unit, while the unit side wall includes light emitting diode (LED) 43, target receptacle 71, charge receptacle 73, actuator connector 75, target connector 77 and fuse 79, each as described above. Actuator connector 75 and target connector 77 are for use with actuable target assemblies and may be omitted from communication interface units employed with stationary target assemblies.

LED 43 may be illuminated to indicate reception of power signals, while fuse 79 protects the internally housed control electronics as described above. Signals from the target object (e.g., information related to beam impacts and locations of those impacts) are received by the communication interface unit via target receptacle 71. This receptacle engages connector cable 60 (FIGS. 4-5) of a corresponding target object 12, 16 and provides power signals for that target object. When the communication interface is employed with an actuable target assembly, the communication interface unit relays signals from the target object to the actuation unit control electronics via target connector 77 connected to target receptacle 27 of the actuation unit (FIG. 10). This connection enables transfer of information (e.g., hit detection signals) between the target object and actuation unit to actuate the target as described above. Further, actuator connector 75 is connected to actuation unit motor receptacle 33 (FIG. 10) to provide power signals to the actuation unit and enable transference of information (e.g., information related to controlling target actuation) between that unit and the computer system. Charge receptacle 73 enables charging of the unit rechargeable battery as described above.

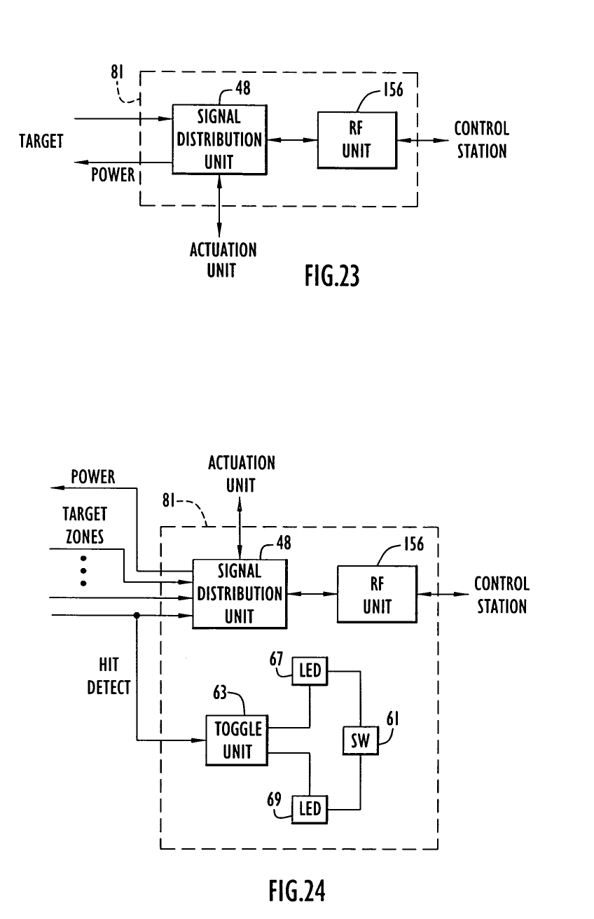

Communication interface unit 81 further includes an antenna 171 and an RF unit 156 (FIGS. 23-24) to enable transfer of information (e.g., information related to beam impacts, locations of those impacts and control of target actuation) between the communication interface unit and control station 30 via a wireless communication link as described below. Thus, the communication interface unit basically provides power signals for system components (e.g., target object, actuation unit, etc.) and facilitates transfer of information between the computer system and target assemblies.

An exemplary control circuit for the communication interface unit is illustrated in FIG. 23. Specifically, communication interface unit 81 includes signal distribution unit 48 and an RF unit 156. The signal distribution unit is substantially similar to the signal distribution unit described above and receives the hit detect signal and detection signals from each target zone within the target object. This information is received via connector cable 60 and target receptacle 71 and indicates occurrence of a beam impact and the location of the impact on the target object. The signal distribution unit further provides power signals to the target object via the connector cable and target receptacle 71. Moreover, the signal distribution unit provides power signals and the appropriate control signals to the actuation unit control electronics (FIG. 11), via actuator connector 75 and target connector 77, to enable actuation of the target object as described above. The signal distribution unit may be implemented by any conventional or other circuitry, components or devices to enable distribution of signals (e.g., multiplexers, gate arrays, switches, etc.).

RF unit 156 is coupled to the signal distribution unit and receives signals for transference to the control station via a wireless communication link. The RF unit transmits the detection and hit detect signals and other information via antenna 171 to reader 190 of control station 30 for transference to computer system 40. In addition, the RF unit receives signals from reader 190 (and, hence, computer system 40) for distribution by signal distribution unit 48 as described above.

In addition, the communication interface unit may further include a toggle unit to control illumination of indicators as illustrated in FIG. 24. In particular, communication interface unit 81 includes signal distribution unit 48 and RF unit 156, each as described above to convey signals between the actuation unit, target object and control station. The communication interface unit may further include toggle unit 63 to alternately illuminate LEDs 67, 69 and switch 61 to control the intensity of the LEDs. Specifically, the toggle unit is substantially similar to the toggle unit described above and receives the hit detect signal indicating a beam impact in one or more of the zones. The toggle unit preferably includes a pair of ‘D’-type flip flops arranged in series with each flip flop controlling a corresponding LED 67, 69. The flip flops are each configured to toggle their output and are arranged to be clocked to provide only one flip flop with a logic one state with each beam impact, thereby enabling only one LED 67, 69 for each beam impact. The LEDs are alternately illuminated with each successive beam impact to indicate a hit to a user. The user may manipulate switch 61 to control the intensity of the LEDs and accommodate various environmental or other conditions (e.g., night time, night vision, day time, etc.). For example, low intensity may be utilized for night time exercises and to prevent night vision sights from becoming saturated upon a hit, while high intensity may be used for day time activities to enable a hit to be more visible to a user. The switch may be implemented by any conventional or other switching devices.

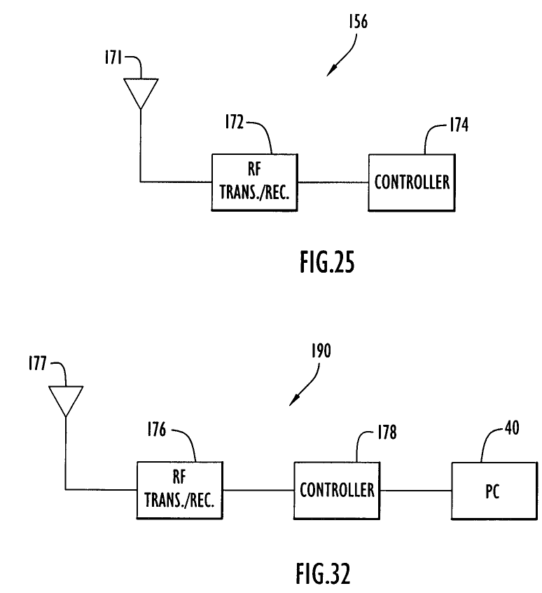

RF unit 156 (FIGS. 23-24) establishes an RF communication link with control station 30 (FIG. 18). The RF link may be in any desired form and utilize any protocol (e.g., WiFi LAN, etc.). The RF unit and/or reader is designed to be compatible with various laser targets and detectors, such as vests or other garments, traps or the types disclosed in the aforementioned patents and patent application. Referring to FIG. 25, RF unit or tag 156 includes antenna 171, RF transceiver (e.g., transmitter and receiver) 172 and a microcontroller 174. The controller receives information from signal distribution unit 48 (FIGS. 23-24) and processes that information for transfer to control station 30. The controller typically includes seven I/O channels terminated in a DB9 type connector (e.g., including nine pins, one pin for each of supply voltage (e.g., +5V), ground, reset and hit signal and remaining pins for phase lock loop or location signals from the detector assemblies). The controller includes a real time clock and may store the time of beam impacts (e.g., relative to the start time of a session), location of beam impact based on detect signals and other information. The controller further controls transceiver 172 to receive and transmit messages with control station 30 via an RF communication link, where received messages are processed to provide signals to signal distribution unit 48 for distribution of control and other signals as described above. The messages are transmitted and received over antenna 171. The RF unit may employ wireless communications and protocols enabling transference of information over a range of approximately two-hundred meters to an extended range of approximately one mile.

The controller may further store hit information (e.g., impact and time, etc.) when the target is beyond the range of a control station. When a control station becomes in range, the stored information may be sent to the control station, thereby enabling processing and feedback of the information. Controller 174 is disposed in the RF unit and serves as a central or common controller in order to reduce the quantity of controllers in the target (e.g., the target objects do not require a controller to detect the laser beam). The system design enables detection of laser pulses at a sufficient rate to enable use with automatic type weapons (e.g., machine gun, M249, M240, etc.) having firing rates on the order of 1,500 rounds per minute. The RF unit may accommodate any quantity of detection units or zones. The RF unit may be implemented by any conventional or custom components.

System 200 may further be utilized with body gear 100, 150 (FIG. 18) to enable participants to engage each other during training. Body gear 100, 150 include various body units or segments, each preferably configured to cover a particular body portion as described below. Body gear 100, 150 respectively include a detection assembly 153, 193 (FIGS. 28 and 31) to detect the laser beam impacts. The body gear detects beam impacts and provides impact information to control station 30. Detectors 112 (FIGS. 26, 27 and 30) are positioned at desired locations on the body gear to detect beam impacts within specific target areas or zones as described below.

The system may be utilized with various types of body gear to facilitate firearm training and/or qualifications (e.g., certification to a particular level or to use a particular firearm). The system may additionally be utilized for entertainment purposes (e.g., in target shooting games or sporting competitions). Body gear 100 includes various body units or segments to cover body portions (e.g., front and rear portions of the torso, arms, legs, etc.) and detect and indicate beam impacts thereon. Body gear 100 is alternately illuminated different colors to indicate successive beam impacts as described below. An exemplary body unit of body gear 100 preferably configured to cover the front or rear portion of a user torso is illustrated in FIG. 26. Specifically, body unit 110 is generally implemented as a type of body armor to detect beam impacts. Body unit 110 is in the form of a substantially rectangular plastic panel with an array of detectors 112 and a series of indicators 168, 169 embedded therein. The indicators are preferably in the form of blue light emitting diodes (LED) 168 and green light emitting diodes 169 to indicate beam impacts as described below. The detectors and indicators may be of any quantity and may be disposed in any fashion or arrangement at any panel locations suitable to detect and indicate beam impacts. The body unit includes an approximate thickness of two centimeters, while the plastic panel provides enhanced protection during training for the detectors and indicators embedded therein. Straps or other fasteners (not shown) are disposed on body unit 110 to secure the unit to the appropriate body portion (e.g., torso, etc.). The body unit may be of any size, shape or thickness and may be configured to cover any desired body portion of a user.

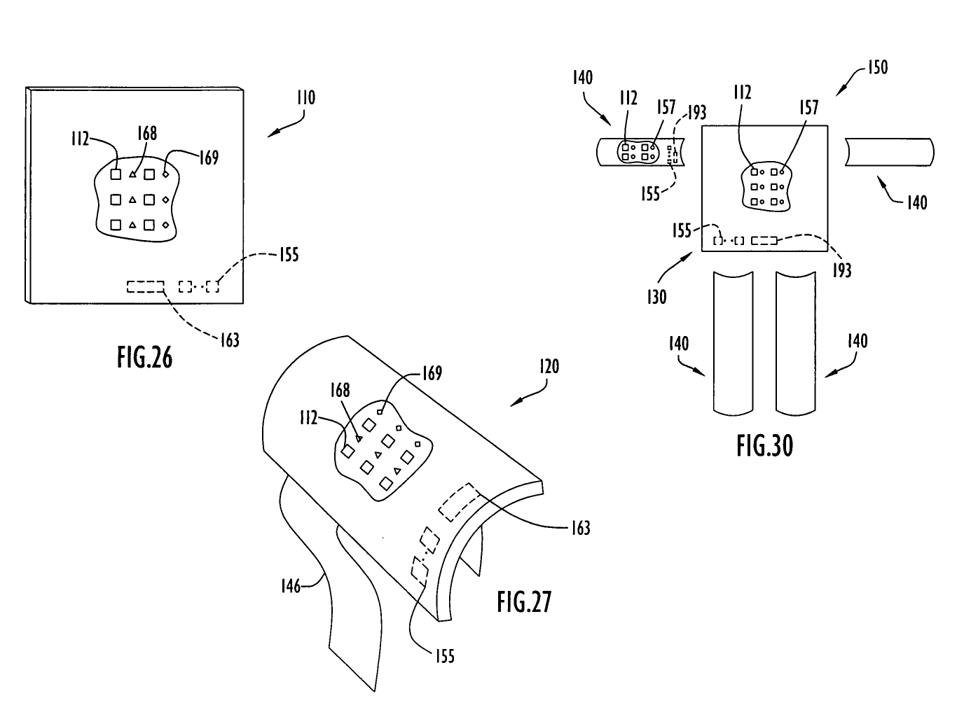

An exemplary body gear unit preferably configured to cover a user limb (e.g., arm, leg, etc.) is illustrated in FIG. 27. Specifically, body unit 120 is similar to body unit 110, except that unit 120 is configured to cover a user limb (e.g., arm, leg, etc.). Body unit 120 is in the form of a plastic panel with an array of detectors 112 and a series of indicators 168, 169 embedded therein. The indicators are preferably multi-colored in the form of blue LEDs 168 and green LEDs 169 to indicate beam impacts as described below. The detectors and indicators may be of any quantity and may be disposed in any fashion or arrangement at any panel locations suitable to detect and indicate beam impacts. Body unit 120 includes an approximate thickness of two centimeters, while the plastic panel provides enhanced protection during training for the detectors and indicators embedded therein as described above. The body unit is substantially rectangular with an arcuate or curved configuration to contour a body limb (e.g., arm, leg, etc.). Straps 146 or other fasteners are disposed on body unit 120 to secure the body unit to the appropriate body portion (e.g., arm, leg, etc.). The body unit may be of any size, shape or thickness and may be configured to cover any desired body portion of a user.

Body gear 100 may be painted in a manner that does not block the laser beam from impacting the detectors. This may be accomplished by utilizing paints designed for glass and applying the paint to the body gear units with a sponge to provide openings (e.g., generally not visible) to permit the laser beam to pass therethrough as described above for the target objects. Further, fine glass or metallic fragments may be mixed into the paint to provide bright targets for night time activities and/or thermal night sight users as described above for the target objects. The body gear units may be covered by sheer fabric or material (e.g., pantyhose, cloth, mesh, etc.) that enables the laser beam to contact the detectors. This enables clothes or garments (e.g., colors, etc.) to be placed on the body gear or user to provide friend/foe or other indications as described above for the target objects.

Body gear 100 includes detection assembly 153 (FIG. 28) to detect beam impacts thereon. The detection assembly (FIGS. 26-27) includes an impact detection unit 163 and an RF unit 256 for respectively detecting the presence of beam impacts and transmitting the information to control station 30 via an RF link as described below. A body gear unit, preferably a body unit 110, serves as a body gear control unit to combine impact information from, and provide power to, the body gear units and to transfer information to RF unit 256 for transference to computer system 40 via the RF link. In particular, body units 110, 120 each typically include connectors 155 and an impact detection unit 163. The connectors and detection unit are typically disposed on the body unit rear surface, but may be disposed at any suitable locations. The connectors are preferably implemented by conventional telephone jacks and enable body units 110, 120 to be coupled to a body gear control unit. Each body unit may be coupled directly to the control unit, or the body units may be coupled to adjacent units in a daisy-chain type fashion for connection to the control unit. The control unit provides power signals to the body units and transfers impact information to RF unit 256 as described below. The body units and RF unit are preferably coupled by conventional cables or wires extending between unit connectors. Detection assembly 153 determines the presence of beam impacts on the body gear, while RF unit 256 is coupled to the control unit and establishes the RF communication link with control station 30 to transfer impact information. The RF link may be in any desired form and utilize any protocol (e.g., WiFi LAN, etc.). Alternatively, the detection assembly may be coupled to the control station via a cable. The RF unit and/or reader is designed to be compatible with various laser targets and detectors, such as the types in the aforementioned patents and patent application.

Body gear units 110, 120 each include a series of light emitting diodes (LEDs) 168, 169 as described above to indicate a beam impact or status of the user (e.g., wounded, dead, etc.). The diode colors are selected in order to avoid noise or interference with the laser light and include a relatively high intensity. The intensity may be adjusted to accommodate various environmental or other conditions (e.g., night time, night vision, day time, etc.). For example, low intensity may be utilized for night time exercises and to prevent night vision sights from becoming saturated upon a hit, while high intensity may be used for day time activities to enable a hit to be more visible to a user. Basically, the diodes include a series of blue LEDs 168 and a series of green LEDs 169, where each series is alternately actuated to emit blue and green light in response to successive beam impacts. The body gear units may individually be alternately illuminated blue and green in response to successive beam impacts on that unit. Alternatively, the body gear units may each be alternately illuminated blue and green simultaneously in response to successive beam impacts on the body gear (e.g., successive impacts on any portion of the body gear). Thus, the body gear units are alternately illuminated blue and green to indicate to training participants successive hits upon a user or user body portion.

An exemplary detection assembly 153 for body gear 100 is illustrated in FIG. 28. Specifically, the detection assembly includes a series of impact detection units 163 each associated with a corresponding body gear unit or segment. The impact detection units each include one or more infrared (IR) detectors 112 and blue and green LEDs 168, 169 embedded within the corresponding body unit as described above and phase lock loop 86. The impact unit may further include a toggle unit 166. Each detector 112 is preferably implemented by a diode and detects the laser beam passing through the corresponding body unit. An aperture or mask may be disposed over each detector 112 to enable the detectors to detect a central portion of a laser beam. The mask may include an adhesive for application to the detector (e.g., be in the form of a sticker). Since the laser beam dimension expands as the distance between the user and target increases, the central portion of the beam represents an accurate indication of the user point of aim. Thus, the mask prevents the detector from indicating an impact based on the periphery of the laser beam (e.g., which may not accurately reflect the user point of aim due to the beam expansion), thereby enhancing system accuracy. Further, a filter (e.g., 650 nanometers) may be disposed over each detector 112, in addition to or in place of the mask, to filter extraneous light and enable the laser signal to pass through and contact the detector. This enhances detector sensitivity to the laser beam even in an environment with a large quantity of ambient light. The plastic panel of each body unit may serve as the filter and/or a diffuser for incoming light. Further, each detector 112 has a certain field of view, where plural detectors may be employed in parallel to provide a wide sensing area. For example, three detectors may be employed in parallel each positioned at an angle relative to the other detectors to increase the field of view and sensing area of the body unit. This may be accomplished by soldering techniques. In this fashion, the sensing area or zone of each body unit may be adjusted for a particular application. Moreover, a central detector may be employed surrounded by four angled detectors to detect hits on far sights (e.g., when a user projecting a laser beam is at a far range from the intended body gear target).

Detectors 112 are arranged in parallel, where the detector outputs are provided to phase lock loop 86. Phase lock loop 86 basically processes and filters the information from detectors 112 as described above to determine the presence of the modulated laser beam (e.g., modulated at 45 KHz as described above). This enables the impact detection units to minimize false alarms due to ambient light. Further, the phase lock loop may utilize a gain adjustment parameter to control the threshold for indicating a beam impact as described above for the target objects. The phase lock loop produces pulses, where a low signal indicates the presence of a beam impact. The pulse is provided to logic 165 disposed on a body gear control unit. Logic 165 basically receives information from the impact units associated with each body unit and includes AND type logic (e.g., logic gate, circuitry, etc.) to provide a hit signal (e.g., HIT DETECT as viewed in FIG. 28) to RF unit 256 when any of the impact units detect a beam impact. Since a low signal from an impact unit indicates a beam impact as described above, AND type logic 165 produces a low signal in response to any impact detection unit detecting a beam impact. The impact unit information is typically received from phase lock loop 86 of each impact unit. The phase lock loop signals are further provided to RF unit 256 to enable determination of the particular impact unit or body unit detecting the beam impact. This enables the system to determine the location of the beam impact for scoring or other information (e.g., kill shot, wounded shot, etc.). A power source 158 is further disposed on the body gear control unit and provides power to the body gear units. The power source is preferably in the form of batteries (e.g., a pair of double ‘A’ or ‘AA’ type batteries) to enable the system to be transported and used at various locations.

Toggle unit 166 may be coupled to phase lock loop 86 and LEDs 168, 169. The toggle unit receives beam impact information from the phase lock loop and alternately actuates diodes 168, 169 on successive beam impacts. This alternately illuminates the corresponding body unit blue and green to indicate successive beam impacts or hits to that unit as described above. The toggle unit is substantially similar to the toggle unit described above and preferably includes a pair of ‘D’-type flip flops arranged in series with each flip flop controlling a corresponding series of diodes 168, 169. The flip flops are each configured to toggle their output and are arranged to be clocked to provide only one flip flop with a logic one state with each beam impact, thereby enabling only one series of diodes 168, 169 for each beam impact. The impact units may each reside on a corresponding body unit and be coupled to the body gear control unit as described above. The phase lock loop and toggle unit of each impact unit may alternatively be disposed on the body gear control unit and coupled to the corresponding detectors and LEDs of the associated body unit.

Alternatively, the body gear units may simultaneously be alternately illuminated blue and green in response to successive beam impacts upon the body gear. In this case, a central toggle unit 166 is employed and disposed in the body gear control unit. The toggle unit is coupled to logic 165 and LEDs 168, 169 of each body gear unit. The toggle unit is substantially similar to the toggle unit described above and alternately actuates LEDs 168, 169 of each body gear unit in response to successive beam impacts on the body gear indicated by hit signals from logic 165. Thus, body gear 100 (e.g., each body unit) is alternately illuminated blue and green in response to successive beam impacts. The impact unit components may be implemented by any conventional or custom circuitry or components.

RF unit 256 establishes an RF communication link with control station 30 (FIG. 18) and is coupled to logic 165 as described above. The RF unit receives the resulting beam impact information from logic 165 and processes that information for transfer to control station 30 for processing as described below. Alternatively, the detection assembly may be coupled to the control station via a cable. The body gear may include any quantity of detection assemblies with components (e.g., impact unit, RF unit, etc.) disposed at any suitable locations.

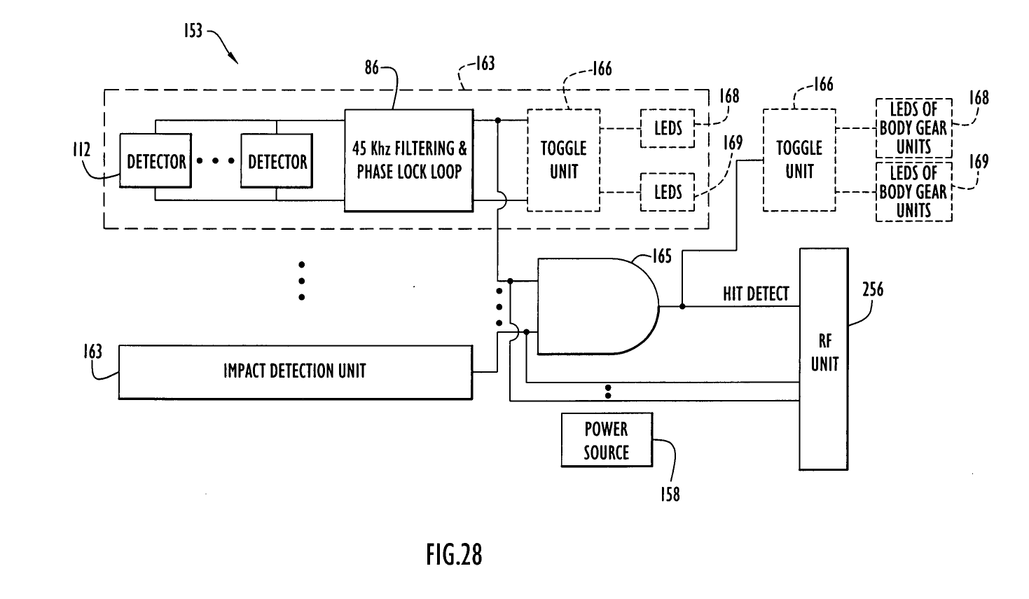

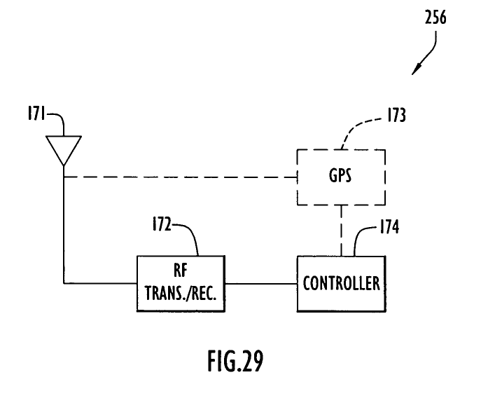

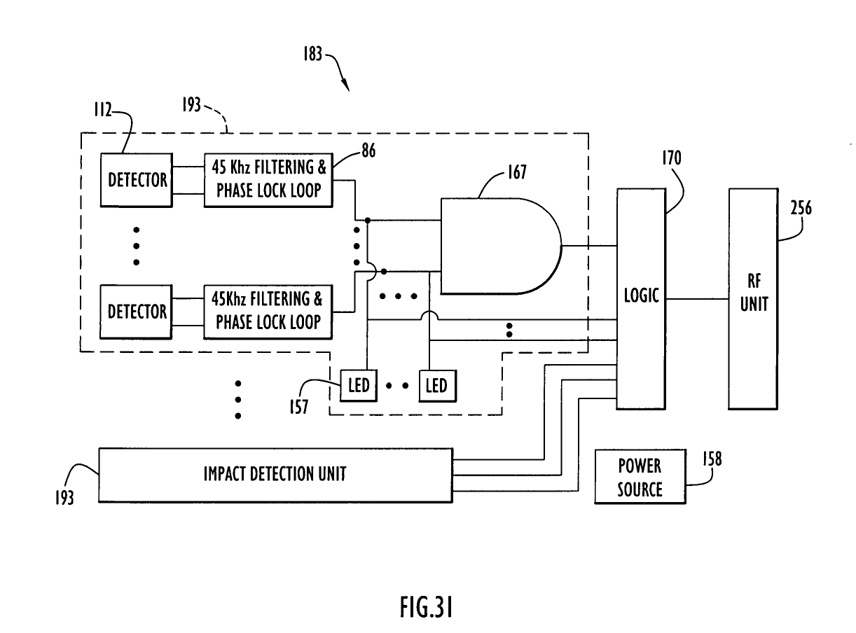

An exemplary RF unit or tag 256 is illustrated in FIG. 29. Specifically, the RF unit is substantially similar to the RF unit described above and includes antenna 171, RF transceiver (e.g., transmitter and receiver) 172 and microcontroller 174. The controller receives information from impact units 163 (FIG. 28) and processes that information for transfer to control station 30. The controller typically includes a plurality of I/O channels terminated in a DB9 type connector (e.g., including pins for supply voltage (e.g., +5V), ground, reset and hit signals and phase lock loop or location signals). The controller includes a real time clock and may store the time of beam impacts (e.g., relative to the start time of a session), location of beam impact based on the phase lock loop signals and other information. The time indication enables training with various time sensitive scenarios. The controller further controls transceiver 172 to receive and transmit messages with control station 30 via an RF communication link. The messages are transmitted and received over antenna 171. The RF unit may employ wireless communications and protocols enabling transference of information over a range of approximately two-hundred meters to an extended range of approximately one mile.

Further, the RF unit may include a Global Positioning System (GPS) unit 173 for communications with a Global Positioning System. The GPS unit basically tracks the position or location of the body gear or user during training for transfer to control station 30. The GPS unit may be implemented by any conventional or other GPS units (e.g., transmitter, receiver, etc.) and may utilize antenna 171 or a separate antenna for communication with the Global Positioning System.

In addition, the controller may store hit information (e.g., impact, time, user position, etc.) when the body gear is beyond the range of a control station. When a control station becomes in range, the stored information may be sent to the control station, thereby enabling processing and feedback of the information. Controller 174 is disposed in the RF unit and serves as a central or common controller in order to reduce the quantity of controllers in the body gear (e.g., the detectors do not require a controller to detect the laser beam). The system design enables detection of laser pulses at a sufficient rate to enable use with automatic type weapons (e.g., machine gun, M249, M240, etc.) having firing rates on the order of 1,500 rounds per minute. The RF unit and impact units may accommodate any quantity of body gear units depending upon the number of desired target zones or locations for an application. The RF unit and impact units may be implemented by any conventional or custom components.

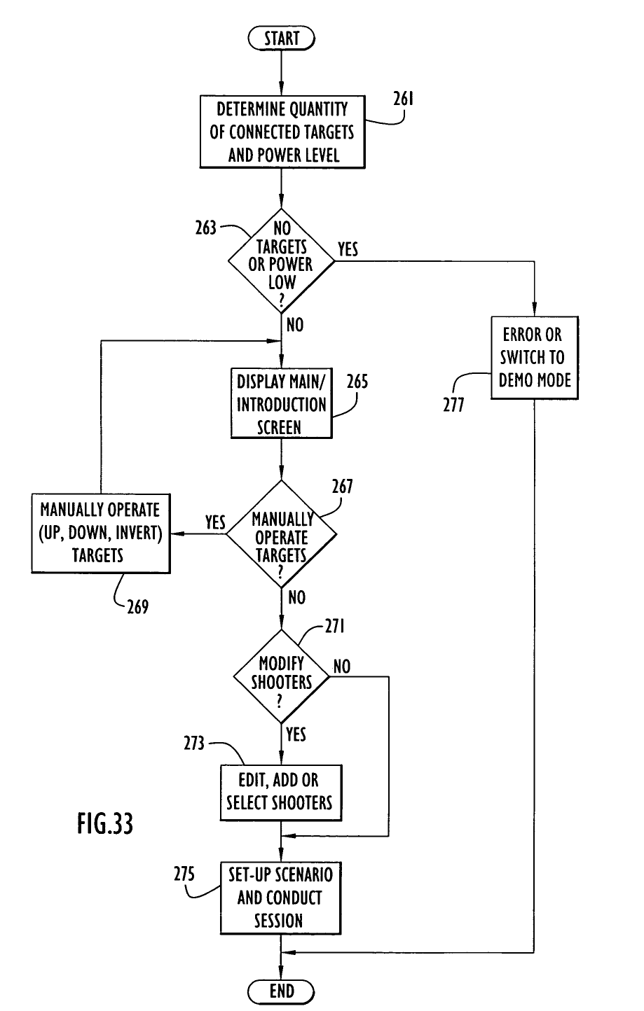

Body gear 150 is illustrated, by way of example only, in FIG. 30. Body gear 150 is similar to body gear 100 described above and includes body units or segments to cover body portions and detect and indicate beam impacts thereon, and indicators, each associated with a corresponding detector, to indicate the location of a corresponding beam impact on the body gear. Initially, body gear 150 includes body units or segments 130, 140. These units are substantially similar to respective body units 110, 120 described above, except that body units 130, 140 each include a series of indicators 157. Body unit 130 is preferably configured to cover the front or rear portion of a user torso and is in the form of a substantially rectangular plastic panel with an array of detectors 112 and corresponding indicators 157 embedded therein. The indicators are preferably implemented by LEDs and are disposed proximate a corresponding detector 112. The indicators are illuminated in response to the corresponding detector sensing a beam impact as described below. This enables the location of a beam impact to be visible to users during training. The detectors and indicators may be of any quantity and may be disposed in any fashion or arrangement at any panel locations suitable to detect and indicate beam impacts. Body unit 130 includes an approximate thickness of two centimeters, while the plastic panel provides enhanced protection during training for the detectors and indicators as described above. Straps or other fasteners (not shown) are disposed on body unit 130 to secure the unit to the appropriate body portion (e.g., torso, etc.) as described above. Body unit 130 may be of any shape, size or thickness and may be configured to cover any desired body portion of a user.

Body unit 140 is similar to body unit 130, but is configured to cover a user limb (e.g., arm, leg, etc.). Body unit 140 is in the form of a plastic panel with an array of detectors 112 and corresponding indicators 157 embedded therein. The indicators are preferably implemented by LEDs and are disposed proximate a corresponding detector 112 as described above. The indicators are illuminated in response to the corresponding detector sensing a beam impact as described below. This enables the location of the beam impact to be visible to users during training. The detectors and indicators may be of any quantity and may be disposed in any fashion or arrangement at any panel locations suitable to detect and indicate beam impacts. Body unit 140 includes an approximate thickness oftwo centimeters, while the plastic panel provides enhanced protection during training for the detectors and indicators embedded therein as described above. The body unit is substantially rectangular with an arcuate or curved configuration to contour a body limb. Straps or other fasteners (not shown) are disposed on body unit 140 to secure the body unit to the appropriate body portion (e.g., arm, leg, etc.). The body unit may be of any size, shape or thickness and may be configured to cover any desired body portion of a user.

Body gear 150 includes a detection assembly 183 (FIG. 31) to detect beam impacts thereon. Each body gear unit includes an impact detection unit 193 to detect beam impacts on that body unit. A body gear unit, preferably a body unit 130, serves as a body gear control unit to combine impact information from, and provide power to, the body gear units and to transfer information to RF unit 256 for transference to computer system 40 via an RF link. The RF unit is substantially similar to the RF unit described above. Each body unit includes one or more connectors 155 and an impact detection unit 193. The connectors and detection unit are preferably disposed on the body unit rear surface, but may be disposed at any suitable locations. The connectors are preferably implemented by conventional telephone jacks and enable links between the body units, between the body units and the body gear control unit and between the body gear control unit and RF unit as described above. Detection assembly 183 determines the presence of beam impacts on body gear 150, while RF unit 256 is coupled to the control unit and establishes the RF communication link with control station 30 to transfer impact information. The RF link may be in any desired form and utilize any protocol as described above.

An exemplary detection assembly 183 for body gear 150 is illustrated in FIG. 31. Specifically, the detection assembly includes a series of impact detection units 193 each associated with a corresponding body unit or segment. The impact detection units each include one or more infrared (IR) detectors 112 and indicators 157 embedded within the corresponding body unit as described above, a series of phase lock loops 86 and logic 167. Each detector 112 is preferably implemented by a diode and detects the laser beam passing through the corresponding body unit as described above. An aperture or mask may be disposed over each detector 112 to enable the detectors to detect a central portion of a laser beam. The mask may include an adhesive for application to the detector (e.g., be in the form of a sticker). Since the laser beam dimension expands as the distance between the user and target increases, the central portion of the beam represents an accurate indication of the user point of aim. Thus, the mask prevents the detector from indicating an impact based on the periphery of the laser beam (e.g., which may not accurately reflect the user point of aim due to the beam expansion), thereby enhancing system accuracy. Further, a filter (e.g., 650 nanometers) may be disposed over each detector 112, in addition to or in place of the mask, to filter extraneous light and enable the laser signal to pass through and contact the detector. This enhances detector sensitivity to the laser beam even in an environment with a large quantity of ambient light. The plastic panel of each body unit may serve as the filter and/or a diffuser for incoming light. Further, each detector 112 has a certain field of view, where plural detectors may be employed to adjust the sensing area for particular applications or detect hits on far sights as described above.

Each detector 112 is coupled to a corresponding phase lock loop 86. Each phase lock loop 86 is substantially similar to the phase lock loop described above and basically processes and filters the information from an associated detector 112 to determine the presence of the modulated laser beam (e.g., modulated at 45 KHz as described above) on that detector as described above. This enables the impact units to minimize false alarms due to ambient light. Further, the phase lock loops may utilize a gain adjustment parameter to control the threshold for indicating a beam impact as described above for the target objects. The phase lock loops produce pulses, where a low signal generally indicates the presence of a beam impact as described above.

Logic 167 is preferably in the form of AND type logic (e.g., logic gate, circuitry, etc.) and receives information from each phase lock loop 86. Logic 167 processes the received information and provides a hit signal in response to at least one detector detecting a beam impact. Since a low signal from a phase lock loop indicates a beam impact as described above, AND type logic 167 produces a low signal in response to any phase lock loop detecting a beam impact. The phase lock loop signals are further utilized to illuminate an indicator 157 corresponding to the detector sensing a beam impact. The hit signal and phase lock loop signals of each impact unit are further provided to logic 170.

Logic 170 is disposed on the body gear control unit and basically receives information from the impact units. Logic 170 includes AND type and selection logic (e.g., logic gate, circuitry, multiplexer, etc.) to provide a hit signal to RF unit 256 when any of the impact units detect a beam impact. Since a low signal from an impact unit indicates a beam impact as described above, logic 170 produces a low signal in response to any impact unit detecting a beam impact. The impact unit information is typically received from each logic unit 167. The phase lock loop signals corresponding to the body unit producing the hit signal are further provided to RF unit 256 by logic 170 to enable determination of the particular body unit or detector detecting the beam impact. This enables the system to determine the location of the beam impact for scoring or other information (e.g., kill shot, wounded shot, etc.). Power source 158 is further disposed on the body gear control unit and provides power to the body units. The power source is preferably in the form of batteries to enable the system to be transported as described above. The impact units may each reside on a corresponding body unit and be coupled to a body gear control unit as described above. Alternatively, the phase lock loop and logic units 167 of each impact unit may be disposed on the body gear control unit and coupled to the corresponding detectors and indicators of the associated body unit.

RF unit 256 of body gear 150 establishes an RF communication link with control station 30 (FIG. 18) and is coupled to logic 170 as described above. The RF unit receives the resulting beam impact information from logic 170 and processes that information for transfer to control station 30 for processing as described above. The RF unit includes a real time clock and may store the time of beam impacts (e.g., relative to the start time of a session), location of beam impact based on the phase lock loop signals and other information as described above. The RF unit may further include a Global Positioning System (GPS) unit to track the position or location of the body gear or user during training for transfer to control station 30 as described above.

In addition, the RF unit may store hit information (e.g., impact, time, user position, etc.) when the body gear is beyond the range of a control station as described above. When a control station becomes in range, the stored information may be sent to the control station, thereby enabling processing and feedback of the information. The RF unit controller (FIG. 29) serves as a central or common controller in order to reduce the quantity of controllers in the body gear (e.g., the detectors do not require a controller to detect the laser beam). The RF unit may accommodate any quantity of body gear units depending upon the number of desired target zones or locations for an application.

An exemplary reader 190 employed by the system is illustrated in FIG. 32. Specifically, reader 190 includes antenna 177, RF transceiver (e.g., transmitter and receiver) 176 and a microcontroller 178. The controller receives information from RF units 156, 256 and processes that information for transfer to computer system 40 via an RS-232 type or other interface (e.g., USB, Ethernet, etc.). By way of example only, the controller transfers information with the computer system at a 38,600 baud rate; however, the data transfer may be accomplished at any desired rate. The controller further receives and processes control and other information for the target assemblies and/or body gear received from the computer system and controls transceiver 176 to receive and transmit messages with RF unit 156, 256 of target assemblies 10, 210 and body gear 100, 150 via an RF communication link. The messages are transmitted and received over antenna 177. The reader communicates with the RF units of the communication interfaces and body gear preferably via a time division multiplexing (TDM) scheme, where each target is assigned specific time slots for communication with the reader. The reader preferably accommodates up to fifty RF units, but may accommodate any quantity of RF units, targets or sensors in accordance with an application or exercise. Any quantity of readers may be utilized with a computer system in order to cover a larger area for the targets or body gear. Further, any quantity of repeaters disposed at any suitable locations may be utilized with one or more readers to transmit signals and extend the range between the targets and readers or control stations. The reader may be implemented by any conventional or custom components. Alternatively, the system may employ a hand-held reader that receives information from the RF units. The hand-held reader may be transported to an area to transfer data to a computer or other system, or may be utilized to view the hit information from the targets and/or body gear.

Referring back to FIG. 18, computer system 40 is coupled to and receives and processes information from reader 190 to provide various feedback to a user. The computer system is substantially similar to the computer systems described above and includes software to enable the computer system to communicate with the reader and provide feedback to the user. Computer system 40 is connected to reader 190 via a cable and preferably utilizes an RS-232 type interface. The computer system initially performs a calibration to identify desired body gear assemblies 100, 150 and target assemblies 10, 210 to the system. Basically, each RF unit of a communication interface unit and body gear assembly includes a unique identifier. The computer system instructs a user to fire a laser pulse at a desired body gear or target object and subsequently receives impact information from that body gear or target object via reader 190. The user may enter information (e.g., name, etc.) for that body gear or target for subsequent use. Additional body gear or target objects are incorporated into the session in substantially the same manner. The user commences a session, while beam impact information is collected and transmitted to the computer system via the communication link (e.g., the RF units and reader). The computer system may provide various information on graphical user screens as described below.

Operation of system 200 is described with reference to FIG. 18. Initially, a user basically places body gear 100, 150 on the body and/or arranges the target assemblies. Once the software is executed, the computer system performs the initial calibration to identify the desired body gear and target assemblies to the system as described above. The user subsequently commences firing at body gear of other users and/or the target objects and the computer system receives and processes information from the body gear and target assemblies to provide feedback via graphical user screens as described above.

System 200 may be utilized for various training exercises. For example, the body gear may be placed on targets, where the targets may include various features to provide various training scenarios. By way of example, a target may include a laser transmitter to simulate return fire on a user and may be used with different target systems. The transmitter may be actuated by detection of the laser beam from a user or traps and/or motion type sensors to sense a user near the target.

Further, system 200 may maintain scores for users, where points for the user may be reduced in response to the user hitting a target or another user with incorrect timing, missing the target or user and/or being hit by the return fire. Moreover, traps may reduce user points (e.g., mines or grenades generating a laser beam that is detected by the body gear). If the user gets hit, the user may be notified by audio, visual, vibration or other signals (e.g., in order to reduce user points or remove the user from the training exercise). This enables various interactive training scenarios. In addition, target objects or body gear may be equipped with sound effects (e.g., talking, sounds related to shooting, sounds related to being wounded or shot, etc.) that may be actuated in response to the detectors or other sensors.

Moreover, detection panels may be employed by a target object for additional detection of laser beam impacts. For example, a target object may be placed proximate and in front of a detection panel 108 (FIG. 18). In this case, the detection panel detects near misses that can be used to provide various scenarios and information to computer system 40. By way of example, the target object may return fire as described above in response to a near miss, or the information may be reported to a user to indicate user performance during training. The panel may include solar panels or the detection units and arrangement substantially similar to that described above for the target objects to detect beam impacts.

The system may be employed with various weapons or projectiles. For example, a grenade type simulator may be employed that produces a wide beam to effectively produce beam impacts on several users close to the grenade. Further, the laser transmitter may employ a beam spreader to simulate a spray of projectiles. This may be accomplished by the laser beam being reflected by a mirror that is rotated by a motor. The mirror may be included within or disposed proximate the laser transmitter.

The target object or users may be positioned in various locations and provide diverse training scenarios. For example, the target object or user may be positioned on vehicles to enable training when the targets (or vehicles) are moving. Hit information is buffered and transferred to a computer or other system when the vehicle reaches a data transfer point. Alternatively, a wireless link may be employed to transfer the data during the exercise. This type of training is typically performed with machine gun type firearms when the vehicle is moving and targets are on the ground and is generally useful for guarding type activities. Further, the body gear may be employed for hostage type scenarios, where the body gear indicates hits upon the hostage and foe.

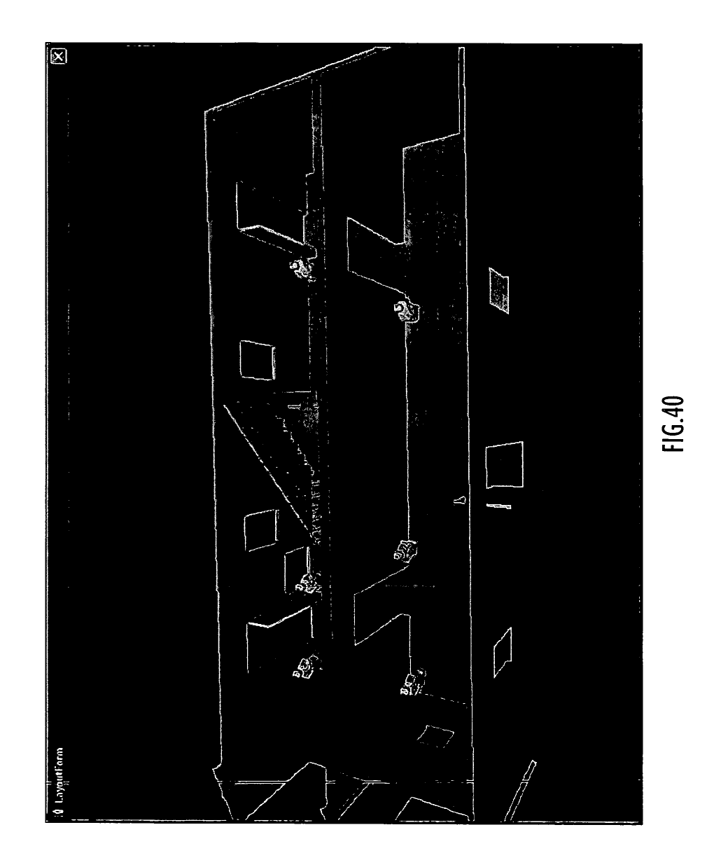

System 200 provides comprehensive training in a realistic and safe manner. For example, use of the system with a blocked barrel type (U.S. Pat. No. 6,322,365) or other firearm provides realistic and safe training for clearing rooms in a building, where the target objects may be placed in specific locations or users may roam the building. This is illustrated, by way of example only, in the graphical user screen of FIG. 40 that may show a target object or user distribution in an area corresponding to a building structure.

Computer system 40 of the above systems includes software to process hit information received from target and/or body gear assemblies and provide feedback to a user, preferably via a plurality of graphical user screens and/or reports. The actuable target assemblies of systems 50, 175 and 200 may be controlled to perform a particular training exercise. Referring to FIG. 33, the computer system determines the quantity of connected target assemblies 10 and the power level (e.g., provided to the target assemblies) at step 261. In the case of wireless system 200, the calibration is performed to identify actuable targets or communication interfaces to the system as described above. If no targets are connected or a low power level is detected as determined at step 263, an error is indicated or the system switches to a demonstration mode at step 277. In this mode, system functions are enabled; however, actual transmission and receipt of control signals and associated connections are simulated via software for various purposes (e.g., product demonstration).

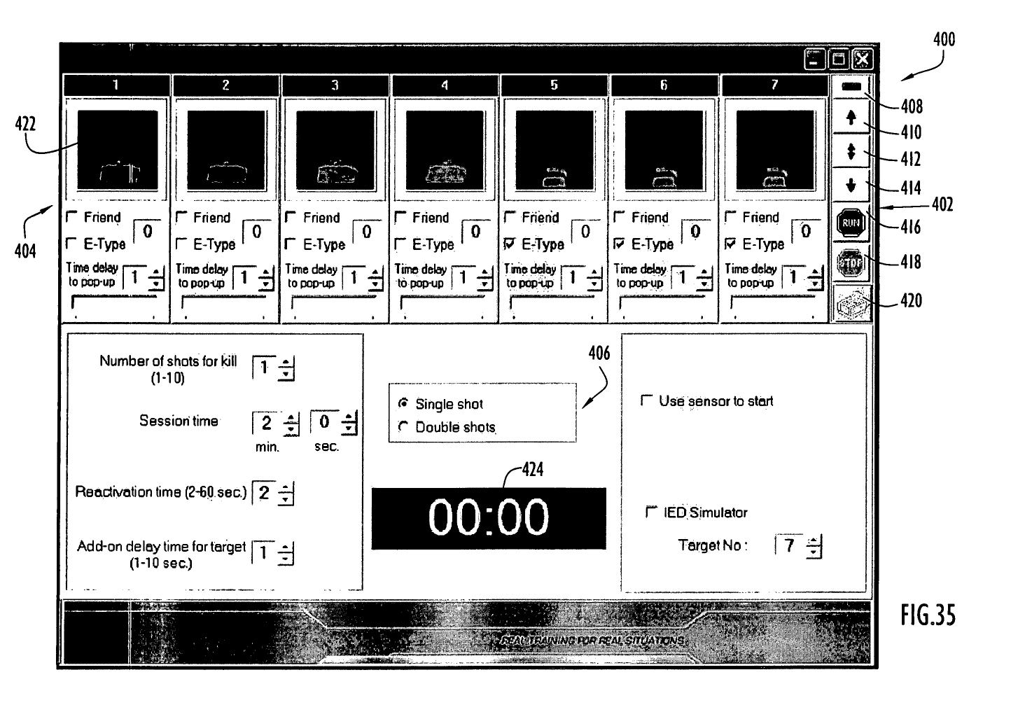

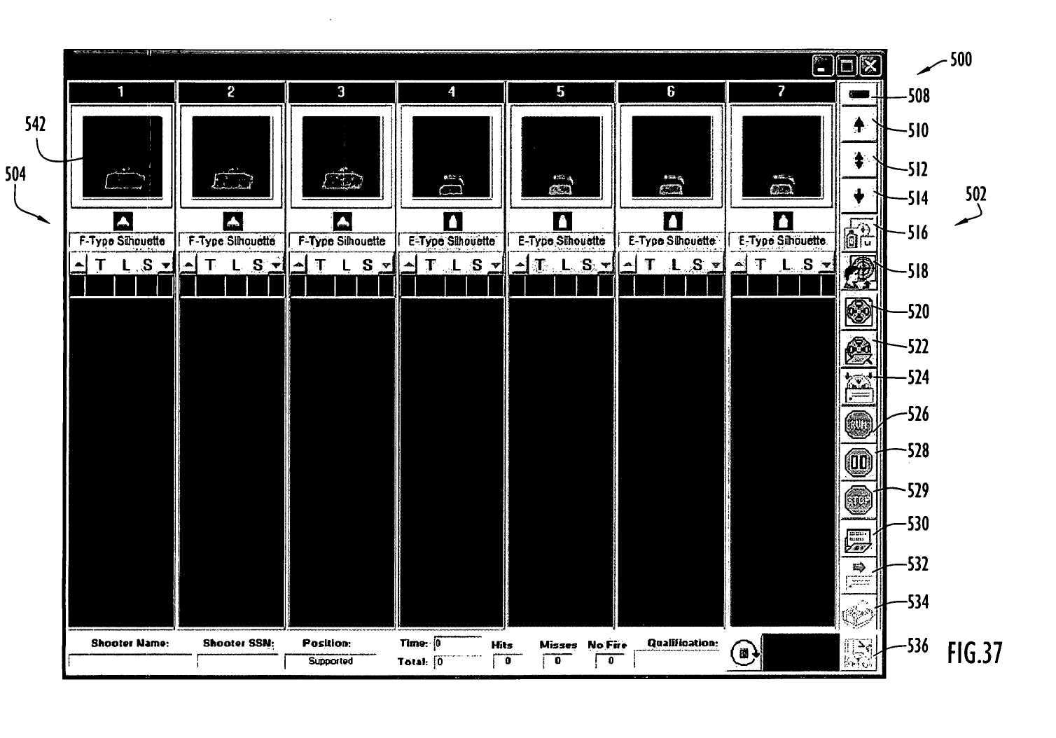

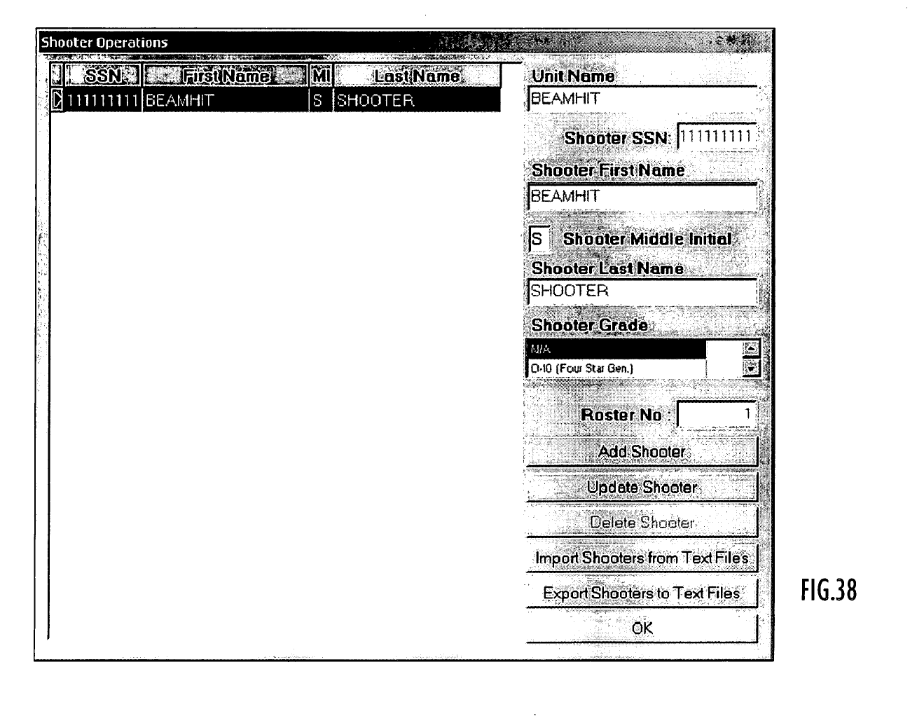

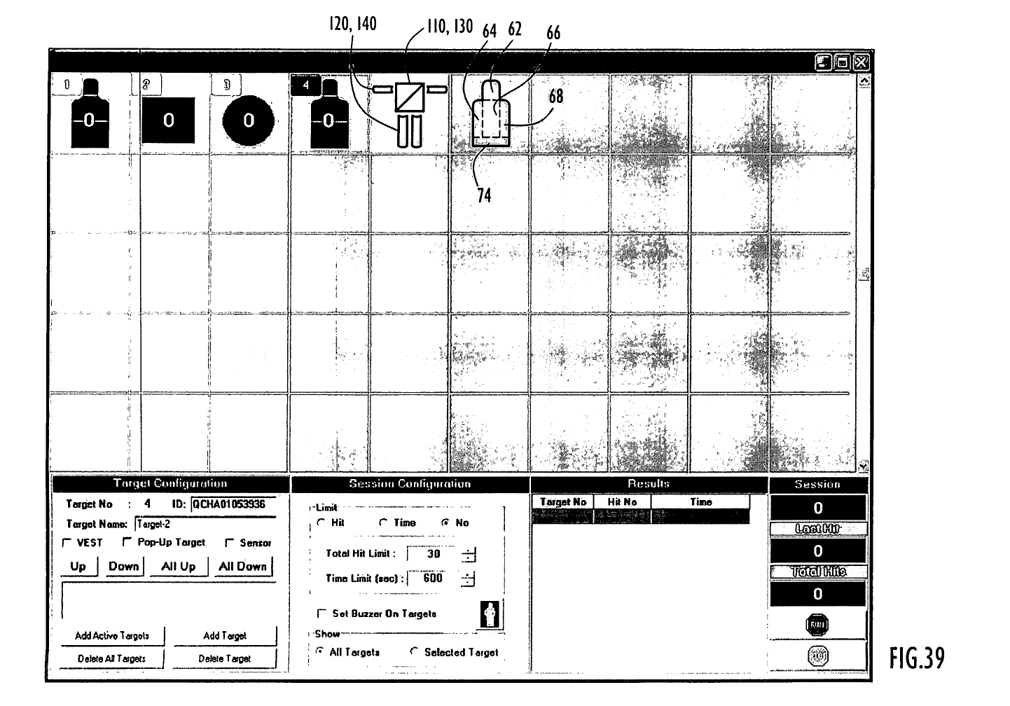

When the power level is sufficient and at least one actuable target assembly is present, the computer system displays a main or introduction screen (e.g., FIGS. 35, 37) at step 265 providing various user options. When a user indicates to the computer system the desire to manually operate the targets as determined at step 267, the user may raise and lower, or invert targets via the computer system at step 269. If the user desires to modify the participants of an activity as determined at step 271, the user may edit existing shooters or participants, enter additional participants or select a participant at step 273 (e.g., FIG. 38). Once the user has performed the desired preliminary tasks, the particular training scenario is initialized and a session is conducted at step 275.

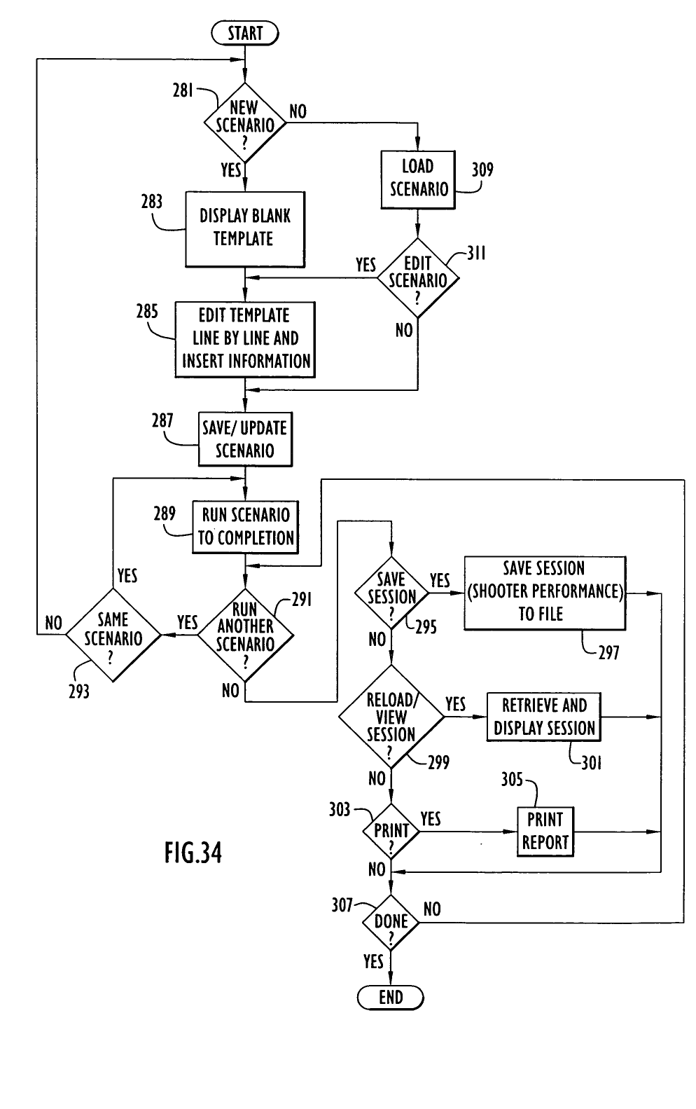

The procedure to initialize and conduct a session is illustrated in FIG. 34. In particular, when a new actuable target scenario is desired by the user as determined at step 281, the computer system displays a blank scenario template at step 283 (e.g., similar to FIG. 37) generally including a start identifier, a blank line and an end identifier. Each template line may be edited by the user at step 285 to include desired information. Specifically, a particular target sequence is entered into the computer system to control the target assemblies. The sequence typically includes the order in which target objects 12, 16 are to be raised and the duration for maintaining the targets in a raised state to permit beam impact. Each target may be individually controlled and selectively specified in the sequence. In other words, the template may include information relating to the target position (up) and corresponding time interval, shooter position (e.g., stand (“off-hand”), lying down (“prone”) or kneeling), the target mask or overlay and range and qualification levels and corresponding scores (e.g., score levels to determine classifications, such as expert, sharp shooter, marksman, not qualified, etc). The time interval for each line or target is accumulated to provide a cumulative time for the scenario. The computer system basically executes instructions on each template line in sequence to provide the scenario.

If a new scenario is not desired as determined at step 281, a scenario or template is retrieved or loaded by the computer system in accordance with a user selection at step 309. When the user desires to edit the loaded scenario as determined at step 311, the scenario may be modified at step 285 in substantially the same manner described above.

Once a scenario is entered or loaded, the scenario is saved and/or updated at step 287 and subsequently executed at step 289. The computer system executes the template by transmitting control signals to the corresponding target assemblies at appropriate times. The control signals typically include information directing the assemblies to raise associated targets for the time interval specified in the template as described above. An exemplary session for creating, editing and managing scenarios is described below with reference to FIG. 37.

When a specified target is placed in the raised position, this indicates to the user an intended target. The user subsequently aims firearm 6 at the raised target to project laser beam 11 at that target. In response to a beam impact, target 12, 16 provides signals to corresponding control electronics 98 of the actuation unit to indicate a hit as described above. The control electronics lowers the target in response to a hit, while impact signals (e.g., hit information) are provided to the computer system as described above. When computer system 40 determines expiration of the time interval and has not received a signal indicating a hit, a control signal is transmitted to the corresponding target assembly control electronics to lower the target and a miss is recorded. Computer system 40 receives the impact information from the target assemblies and calculates a corresponding score. The score may be based on the time required to hit a target and/or distances between the user and the target or other user defined criteria. Alternatively, the target information may include location information of beam impact (e.g., target object zones) to determine scores based on proximity of the beam impact to an intended target site. Once scores have been determined, computer system 40 may provide the scores on graphical user screens as described below.

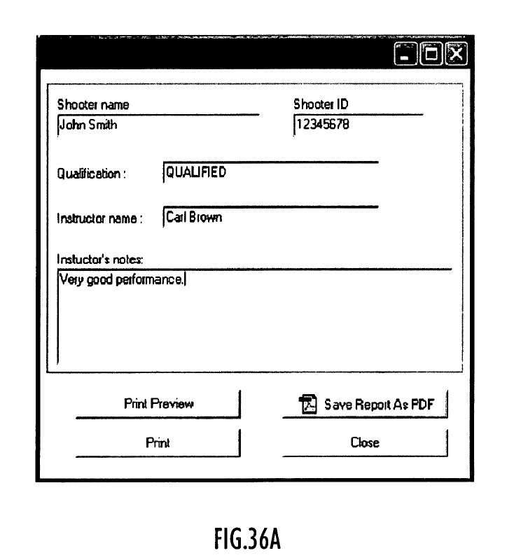

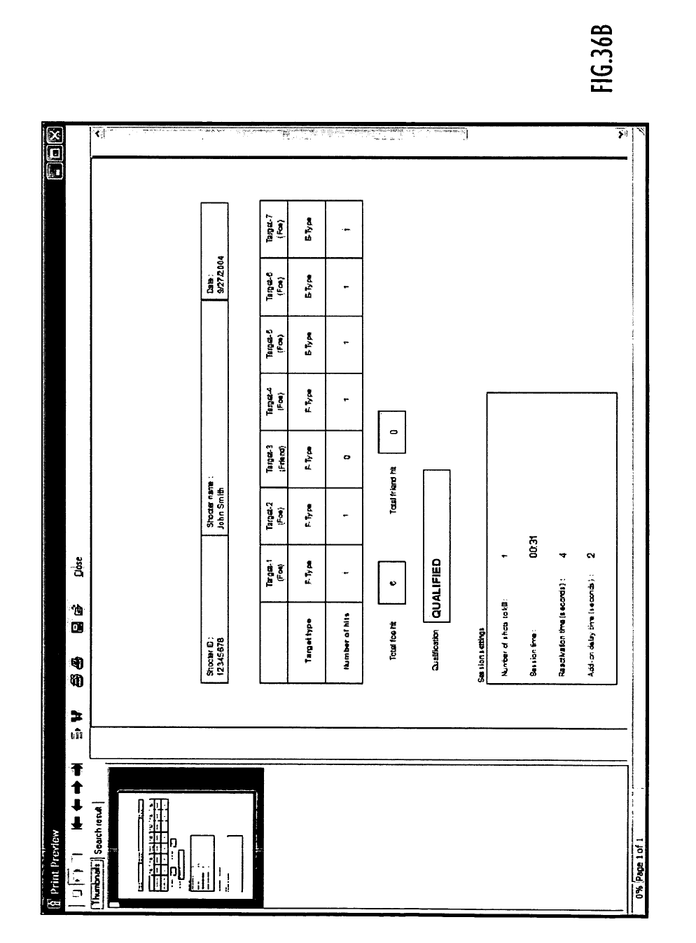

Once a scenario is complete, several options are available to the user. If the user desires to conduct the same scenario as determined at steps 291 and 293, the scenario is repeated at step 289. When a different scenario is desired, a new scenario may be created or loaded in substantially the same manner described above. When a user desires to save a session as determined at step 295, the computer system saves the session or shooter performance in a user specified or predetermined file. If the user desires to reload or view a saved session as determined at step 299, the computer system retrieves a user specified session at step 301 for display on a graphical user screen as described above. When a report is desired by the user as determined at step 303, the computer system prints the report at step 305 (e.g., FIGS. 36A, 36B). The above process continues until the user indicates completion as determined at step 307.

The systems may be utilized to simulate a RETS range utilized in military or law enforcement training as described above or to simulate a competition event, such as IPSC. Accordingly, the target may be configured to present any type of graphic to simulate conventional targets for these or other types of activities (e.g., E-type Silhouette, military pop-up targets, plates, etc.). An IPSC event typically utilizes five targets (e.g., plates) that are simultaneously raised. The object is to hit each target in the shortest cumulative time interval. In order to simulate this event, the system may utilize five target assemblies, while computer system 40 may include a sequence or scenario template to control the target assemblies in a manner similar to the competition. The computer system functions as described above to control the target assemblies, and measures the time interval for a user to hit each target or all targets. The results may be displayed or printed by computer system 40 as described above. An exemplary display that includes information for an IPSC competition is illustrated in FIG. 35; however, the display may be arranged in any fashion and include any types of information.

Exemplary screens providing scoring and other information are illustrated in FIGS. 35-39. Referring to FIG. 35, screen 400 provides various information for a training session and may be utilized by each of the systems described above. Screen 400 includes an action bar 402, a target status section 404 and a settings section 406. Action bar 402 includes a series of buttons and/or indicators to indicate or perform various actions. By way of example, action bar 402 includes a status indicator 408, a target raise button 410, a toggle button 412, a target lower button 414, a run button 416, a stop button 418 and a print button 420. Status indicator 408 is color coded to indicate system status. By way of example only, the indicator utilizes a green color to indicate a ready condition and a red color to indicate a non-ready condition. The target raise and lower buttons respectively raises and lowers all targets, while the toggle button changes the position of all targets (e.g., from a raised state to a lowered state or from a lowered state to a raised state). The run and stop buttons respectively start and stop a session, while the print button prints a report of the session as described below.

Target status section 404 includes a series of windows 422 each corresponding to a target assembly and indicating the status of that target assembly. Windows 422 each include images and/or fields to indicate the position of the target object (e.g., raised or lowered), number of hits, target type (e.g., target object 12 or 16), friend or enemy, time delay to raise the target and a health of the target (e.g., based on the quantity or location of beam impacts). Parameters for the session may be set by a user as described below.

Settings section 406 includes fields indicating and enabling setting of various session parameters. For example, the section includes fields or parameters for a number of hits to a kill, a session time, a reactivation time, a delay, number of shots, external sensors and a simulator. The number of hits parameter indicates the number of hits needed for a raised target to be placed and remain in a lowered state. If the quantity of beam impacts is less than the number of hits parameter, the target is raised after the reactivation time parameter. The number of hits parameter further affects the health indication of the target (e.g., the quantity of hits indicates a wounded or killed target, etc.) in target window 422. The session time parameter indicates the amount of time to run the session (e.g., the amount of time to hit or kill the targets). The time during a session is displayed by a timer window 424 within settings section 406. This window may be utilized to simulate an IPSC event as described above. The reactivation time parameter indicates the amount of time to maintain the target in a lowered state after a hit (e.g., when the quantity of hits is less than the number of hits parameter), thereby simulating a wounded target. The delay parameter indicates the amount of delay to add to the reactivation time, while the shot parameter indicates that either one or two hits are considered as a single hit occurrence. The sensor parameter indicates that an external sensor is utilized to start the session (e.g., motion sensor, etc.), while the simulator parameter enables activation of a simulator.

During use, the computer system checks and selects targets, where particular targets may be omitted from a session by user input (e.g., clicking on a target number, etc.). The parameters are set and the session is started by run button 416. The timer window displays the session time, where the session terminates in response to all targets being killed or the session time expiring. Upon completion of a session, a report may be generated including information relating to the targets, quantity of hits, qualification, session parameters, or any other desired information. An exemplary graphical user screen enabling entry of user information for the report (e.g., shooter name, shooter identification, qualification, instructor name, instructor notes or remarks, etc.) is illustrated in FIG. 36A. An exemplary report within a print preview window is illustrated in FIG. 36B. These screens may be displayed in response to actuation of print button 420 (FIG. 35).

An alternative screen that may be utilized by the systems is illustrated in FIG. 37. Specifically, screen 500 provides various information for a training session and may be utilized by each of the systems described above. Screen 500 includes an action bar 502 and a target status section 504. Action bar 502 includes a series of buttons and/or indicators to indicate or perform various actions. By way of example, action bar 502 includes a status indicator 508, a target select button 510, a toggle button 512, a target delete button 514, a change target button 516, a shooter data button 518, a new scenario button 520, a load scenario button 522, a save scenario button 524, a run button 526, a continue button 528, a stop button 529, a load session button 530, a save session button 532, a print button 534 and an edit scenario button 536. Status indicator 508 is color coded to indicate system status. For example, the indicator utilizes a green color to indicate a ready condition and a red color to indicate a non-ready condition. Run and stop buttons 526, 529 respectively start and stop a session, while print button 534 prints a report of the session in substantially the same manner described above.

Shooter data button 518 enables entry of shooter information. An exemplary screen to enter shooter information is illustrated in FIG. 38. In particular, the user may enter various information including unit name, shooter first name, shooter middle initial, shooter last name and shooter grade. The screen further includes a list of entered shooters and a series of buttons to perform various actions including adding a shooter to the list, updating shooter information, removing or deleting a shooter and importing and/or exporting shooters to and from text files.

Target status section 504 includes a series of windows 542 each corresponding to a target assembly and indicating the status of that target assembly. Windows 542 each include an image of the target and a table of the target sequence including the time interval of raised status (T), the lane of the target (L), and target status (S). In addition, the screen generally provides a hit or miss indication along with other information (e.g., shooter name, shooter identification, hits score, misses, qualification, etc.).

The screen includes various buttons to create, manage and execute firing scenarios. For example, load scenario button 522 enables a saved firing scenario or target sequence to be loaded and executed by the computer system. Further, new scenario button 520 enables a new scenario or target sequence to be created as described above, while edit scenario button 536 enables editing or modification of a scenario or target sequence. The systems generally enable a maximum of seven target assemblies to be programmed for presentation in a scenario. A desired target is selected by user entry (e.g., mouse click) and target parameters may be adjusted and/or entered via the scenario buttons.

When creating or editing a scenario, change target button 516 enables a target to be changed (e.g., between target objects 12, 16). The target sequence is illustrated in a table (e.g., similar to the table in target windows 542) with columns indicating the time interval of raised status (T), the lane of the target (L), and target status (S) as described above. Each row provides instructions for a corresponding target assembly. A target is added or deleted by clicking in a window with a lowered or raised target, respectively. Target select and delete buttons 510, 514 respectively select and delete all targets within a table, while the toggle button changes the position of all targets in the table (e.g., from a raised state to a lowered state or from a lowered state to a raised state). The various parameters in the table (e.g., order, exposure time, etc.) may be modified to attain the desired scenario or sequence. The computer system further enables tables to be added, deleted and inserted to attain desired scenarios. In addition, pauses may be placed in the scenario tables to enable shooters to alter their firing position. Continue button 528 resumes a session after a pause is encountered and a shooter has altered their position. Moreover, criteria for qualifications may be adjusted by a user, where the quantity of hits required for a given category or qualification may be entered. Save scenario and session buttons 524, 532 enables the scenario and session to be saved, while load scenario and session buttons 522, 529 enable retrieval of saved scenarios and sessions, respectively.

During use, a scenario or session is created or loaded and the session is started by run button 524. The computer system displays various information in the screen fields (e.g., shooter name, shooter identification, sequence table, time remaining in table and training session, hits, misses, shots not fired, pauses, end of session, qualification, etc.). The targets are color coded on the screen within windows 542 to indicate target status (e.g., yellow indicates an active target that has not been engaged, green indicates an accurately engaged target and red indicates a target that was missed or not engaged). Upon completion of a session, the session may be edited via edit scenario button 536. This enables a user to designate shots that were not fired (e.g., a user was not able to engage a target) from those identified by the computer system as missed. In addition, a report may be generated as described above (e.g., FIGS. 36A-36B).

With respect to the systems providing location information and utilizing the body gear, computer system 40 may provide other graphical user screens with further information relating to the impact locations and/or participants wearing the body gear as illustrated, by way of example only, in FIG. 39. The information for the target assemblies (e.g., actuable or stationary) providing location information may include illustrations of each target object with corresponding zones and hit indications within those zones, user number or name, hit limits and/or time limits, session time, hit time, total hits, etc. The information for the body gear may include illustrations of each body gear and/or body gear units (e.g., torso, limbs, head, etc.) with hit indications, user number or name, hit limits and/or time limits, session time, hit time, total hits, etc. Further, a body gear unit may be partitioned into zones on the display to indicate impacts. For example, a body gear unit for a torso may be partitioned on the display (e.g., as viewed in FIG. 39) to indicate impacts on the front and/or rear of a person equipped with body gear units covering the person front and back. Alternatively, the computer system may provide feedback in the form of a three dimensional layout of an area showing actual target assembly and user positions (via GPS received from the body gear) and whether that target assembly and/or user has been hit. This is illustrated, by way of example only, in FIG. 40 that may be used with training exercises for clearing rooms in a building as described above. In this case, the target assemblies may be placed in specific locations or users may roam the building and the screen may show a target assembly or user distribution in an area corresponding to a building structure.

It will be appreciated that the embodiments described above and illustrated in the drawings represent only a few of the many ways of implementing a firearm laser training system and method employing various targets to simulate training scenarios.

The systems may include any quantity of target assemblies (e.g., actuable or stationary) and/or body gear arranged in any desired fashion. The computer system may be implemented by any conventional or other computer or processing system, and may control the target assemblies to operate in any desired scenario or target sequence. The computer system may be directly or indirectly connected to the target assemblies or body gear via any communications mechanisms. Further, the components of the systems may be connected by any communications or other devices (e.g., cables, wireless, network, etc.) in any desired fashion. The computer system may be in communication with any quantity of other training systems via any type of communications medium (e.g., direct line, telephone line/modem, network, LAN, WAN, Internet, etc.) and may transfer any desired information to facilitate group training or competitions, such as in the manner disclosed in the aforementioned patents. The computer system may include any type of printing device, display and/or user interface to provide any desired information relating to a user session. The systems may be configured for any types of training, qualification, competition, gaming and/or entertainment applications.

The printer may be implemented by any conventional or other type of printer. The systems may raise any quantity of targets simultaneously to provide multiple targets for a user. The functions of the various components of the systems may be distributed among any quantity of existing or additional components in any desired fashion.

The laser training systems may be utilized with any type of weapon (e.g., hand-gun, rifle, shotgun, machine gun, powered by air/carbon dioxide, archery bow, cross bow or other weapon propelling a projectile, etc.), while the laser transmitter may be fastened to the weapon at any suitable locations via any conventional or other fastening techniques (e.g., frictional engagement with a barrel, brackets attaching the device to the weapon, etc.). Further, the systems may include a dummy firearm projecting a laser beam, or replaceable firearm components (e.g., a barrel) having a laser device disposed therein for firearm training. The replaceable components (e.g., barrel) may further enable the laser assembly to be operative with a firearm utilizing any type of blank cartridges. The laser assembly may include any suitable fastening device. The laser assembly may emit any type of laser beam. The laser beam may be enabled for any desired duration sufficient to enable the targets or body gear to detect the beam. The laser assembly may be fastened to a firearm or other similar structure (e.g., a dummy, toy or simulated firearm) at any suitable locations (e.g., external or internal of a barrel) and be actuated by a trigger or any other device (e.g., power switch, firing pin, relay, etc.).

Moreover, the laser assembly may be configured in the form of ammunition for insertion into a firearm firing or similar chamber and project a laser beam in response to trigger actuation. The laser assembly may include any type of sensor or detector (e.g., acoustic sensor, piezoelectric element, accelerometer, solid state sensors, strain gauge, etc.) to detect mechanical or acoustical waves or other conditions signifying trigger actuation. The laser beam may be visible or invisible (e.g., infrared), may be of any color and may be modulated in any fashion (e.g., at any desired frequency or unmodulated) or encoded to provide any desired information. The laser assembly may be zeroed to any desired distance. The system may be utilized with transmitters and detectors emitting and detecting any type of energy (e.g., light, infrared, etc.).

The systems may utilize any quantity of any of the electronic targets described in the aforementioned patents and patent application including actuable or stationary target assemblies, laser-detecting target devices, vests or other garments, body gear, etc. The systems may be utilized with targets scaled in any fashion to simulate conditions at any desired ranges, and may utilize lasers having sufficient power to be detected at any desired scaled range. The target objects may be of any quantity shape or size and may be constructed of any suitable materials. The shell and base of the target objects may be of any quantity, shape or size, may be constructed of any suitable materials (e.g., plastic, glass, etc.) and may include any indicia or designs (e.g., camouflage, etc.). The target objects may be covered by any suitable material (e.g., paint, garments, etc.) or other indicia. The target objects may be covered in any desired fashion to enable any desired portion to detect a beam impact (e.g., enabling only specific target areas on the target object to detect the laser beam). The target objects may include any type of connector and/or cable to provide and receive signals from system components (e.g., actuation interface unit, interface unit, communications interface unit, impact display unit, etc.) in any desired formats. The base may include any desired configuration to enable the target object to be secured to the actuation unit or stand via any conventional or other securing mechanisms (e.g., bolts and nuts, brackets, clamps, etc.).

The target objects may include any quantity of conventional or other detection assemblies or units and circuitry and may detect any type of energy beam. The detection units or assemblies of the target objects may be of any quantity, may be disposed at any locations and may detect a laser beam encoded or modulated in any fashion. The detection assemblies may include any quantity of detectors arranged in any fashion and at any orientation for any desired field of view for an application. The detection assembly components (e.g., detectors, phase lock loop, toggle unit, etc.) may be implemented by any conventional or other circuitry, where any type of signal may indicate a beam impact (e.g., high level, low level, etc.). The target objects may be partitioned into any quantity of zones with each zone including any quantity of detection units arranged in any fashion. The zones may cover any desired portion of the target objects and represent any type of shot for scoring or other purposes (e.g., kill shot, wounded shot, etc.). The detectors (e.g., solar panels, IR detectors, etc.) may include any quantity of masks or apertures of any shape or size secured thereto via any conventional or other techniques (e.g., adhesives, etc.). The detectors may include filters in addition to or in place of the masks to reduce sensitivity to ambient light. The filter may be configured for any wavelength or band and may be disposed proximate the detector in any fashion via any suitable fastening techniques (e.g., holder, adhesive, hook and loop fastener, etc.). A diffuser may further be disposed proximate the detector to diffuse the incoming beam. The mask, diffuser and filter may be employed either individually or in any combination.

The detection control unit may be of any quantity, may be disposed at any locations (e.g., within any zones) and may be coupled to the detection assemblies and target interface unit via any suitable medium (e.g., wireless, cables, etc.). The detection control unit may be implemented as a separate unit without any detection units, or may include any quantity of detection units within a zone. The logic and noise filter of the detection control unit may be implemented by any conventional or other circuitry (e.g., gates, transistors, any type of logic operation (e.g., OR, AND, NAND, NOR, etc.), filters for any desired bands or of any types, etc.). The target interface unit may be of any quantity, may be disposed at any locations and may be coupled to the detection assemblies via any suitable medium (e.g., wireless, cables, etc.). The logic of the target interface unit may be implemented by any conventional or other circuitry (e.g., gates, transistors, any type of logic operation (e.g., OR, AND, NAND, NOR, etc.), etc.). The gain adjustment circuit may include any conventional or other electrical components arranged in any fashion. The resistors of the gain adjustment circuit may include any desired values to control detection of beam impacts by the phase lock loops.

The actuation unit housing and structural components may be of any shape or size, and may be constructed of any suitable materials. The motor and gear assembly may be implemented by any suitable motor or driver and motion assembly, while the motor voltage may be supplied by any conventional or other power supply and include any appropriate power level signals for the motor. The relay may be implemented by any type of conventional or other relay and utilize any input voltage. The limit switches may be implemented by any conventional switches or circuitry, while the fuse may be implemented by any conventional or other fuse or protective device. The actuation unit receptacles (e.g., target receptacle, motor receptacle, etc.) may include any suitable configurations to transmit and/or receive signals. The actuation unit may include any quantity of the motor and target receptacles disposed at any suitable locations. The target objects may be attached to the arms via any conventional fastening techniques. The threaded holes may be defined in the housing at any suitable locations.

The actuation unit components may be implemented by any conventional or other components performing the described functions and may be arranged within the housing in any desired fashion. The arms may be of any quantity, shape or size, may be constructed of any suitable materials and may be attached to the gear assembly in any desired fashion. The arms may be disposed on the target assembly at any desired location and be actuated in any desired direction. The target object and actuation unit may be connected via any quantity of any type of cable, and may include any quantity of any types of connectors disposed at any suitable locations. The actuation unit may transmit and receive any desired information to and from the target and computer system.

The actuation unit may include any quantity of any type of indicators (e.g., LED) of any shape, size or color to indicate target status (e.g., raised, lowered, hit or miss, etc.). The indicators may be illuminated in any fashion (e.g., flash at any desired rate) and be disposed at any suitable locations on the actuation unit. The target assembly may be configured to accommodate and actuate any quantity of target objects either individually or in any combination. The assembly control electronics may include any conventional or other processor or circuitry to control assembly operation.

The interface unit may accommodate any quantity of target assemblies and may include any type of conventional or other processor or circuitry to provide the above-described functions. The housing may be of any shape or size and be constructed of any suitable materials. The interface unit may be connected to any port of the computer system (e.g., parallel, USB, serial, etc.), and may include any quantity of any type of connectors disposed at any suitable locations to connect to the computer system. The interface unit may communicate with the computer system via any suitable medium (e.g., cables, wires, network, wireless, etc.) and transfer any desired information. The control signals and other information may be encoded by or for compatibility with the computer system in any desired fashion. The computer system and other control signals may include any types of information or commands to control the target assemblies in any fashion. The control signals and other information may be formatted in any desired fashion for transmission between the computer system and target assemblies. The fuse may be implemented by any conventional or other fuse or protective device.

The receptacles, connectors and/or sockets (e.g., motor receptacles or sockets, extender unit connector, moving platform connector, computer interface connector, power socket, etc.) of the interface unit may include any suitable configurations to transmit and/or receive signals. The interface unit may include any quantity of the receptacles, connectors and/or sockets disposed at any suitable locations. The interface unit may include any quantity of any types of terminals or other interfaces to receive power signals from any power source (e.g., power supply, battery, vehicle electrical system, generator, etc.). The cables utilized for communication between the interface unit and target assemblies may be of any quantity, may include any quantity of individual cables in any combination and may be compatible with any suitable receptacles, connectors or sockets. The interface unit components may be arranged within the housing in any suitable fashion. The systems may be utilized without a printer.

The interface unit power switches (e.g., main, power selector, etc.) may be implemented by any conventional switches or circuitry, while the fuse may be implemented by any conventional or other fuse or protective device. The interface unit may include any quantity of any types of terminals or other interfaces (e.g., sockets, receptacles, connectors, etc.) to receive power signals of any desired voltage. The interface unit components (e.g., switches, receptacles, terminals, fuse, etc.) may be disposed at any desired locations.

The extender unit may interface any quantity of targets, sensors or target assemblies. The system may employ any quantity of extender units, where the extender units include any conventional or other circuitry to transfer signals. The connection interface unit may interface any quantity of interface units or training systems. The system may employ any quantity of connection interface units, where these units include any conventional or other circuitry to transfer signals. The moving platform may be implemented by any conventional or other motion device (e.g., cart, moving platform, vehicle, etc.) to provide motion for the target assemblies.

The actuation interface unit may be of any quantity, shape or size and may accommodate any desired quantity of target assemblies. The receptacles, connectors and/or sockets (e.g., target receptacle, charge receptacle, data receptacles, actuator connector, target connector, etc.) of the actuation interface unit may include any suitable configurations to transmit and/or receive signals. The actuation interface unit may include any quantity of components (e.g., receptacles, connectors, sockets, fuses, LEDs, etc.) disposed at any suitable locations. The handle may be of any quantity or type and may be disposed at any suitable locations. The actuation interface unit may include any quantity of any types of indicators (e.g., audio, visual, buzzer, light, speech synthesis, etc.) disposed at any locations to indicate a hit and/or miss. The visual and/or audio indicators may be actuated individually or in any combination to indicate a hit and/or miss. The actuation interface unit may include any quantity of LEDs or other visual indicators of any color arranged in any fashion. Any quantity of indicators of any colors may be illuminated in any fashion (e.g., continuous, flashing, etc.) in response to a beam impact or other condition. The actuation interface units may be arranged in any fashion and/or employ any communication schemes to transfer signals with the converter unit or computer system (e.g., daisy-chain, direct connections to the converter unit, etc.). The switches (e.g., power, reset, intensity, etc.) may be implemented by any quantity of any conventional or other switching devices.

The signal distribution unit may be of any quantity and may be implemented by any conventional or other circuitry (e.g., gates, multiplexers, etc.) to distribute signals within the actuation interface unit. The interface converter and converter unit may be of any quantity and may be implemented by any conventional or other circuitry (e.g., processor, etc.) to convert signals between formats for transfer. The signals may be formatted in any desired fashion for transference between the target assemblies and computer system (e.g., RS-232, RS-485, USB, Ethernet, etc.). The cables between the target assemblies and converter unit may be of any suitable length and carry signals in any desired format. The converter unit may receive power from any source (e.g., interface actuation unit, computer, etc.) and may be linked to any quantity of target assemblies. The toggle unit may be implemented by any conventional or other circuitry or devices toggling or inverting states (e.g., flip-flops, gates, etc.). The indicators may be of any desired intensity, while the switch may be implemented by any type of conventional or other switch to control the intensity (e.g., any quantity of intensity settings).

The stand of the stationary target assembly may be of any quantity, shape or size and may be constructed of any suitable materials. The stand components (e.g., legs, base, etc.) may be of any quantity, shape or size. The legs may be configured to engage the target object base via any conventional or other securing techniques (e.g., nuts and bolts, brackets, clamps, etc.).

The impact display unit may be of any quantity, shape or size and may accommodate any desired quantity of target assemblies in a stand-alone application. The receptacles, connectors and/or sockets (e.g., target receptacle, charge receptacle, etc.) of the impact display unit may include any suitable configurations to transmit and/or receive signals. The impact display unit may include any quantity of components (e.g., receptacles, connectors, sockets, fuses, LEDs, etc.) disposed at any suitable locations. The handle may be of any quantity or type and may be disposed at any suitable locations. The impact display unit may include any quantity of any types of indicators (e.g., audio, visual, buzzer, light, speech synthesis, etc.) disposed at any locations to indicate a hit and/or miss. The visual and/or audio indicators may be actuated individually or in any combination to indicate a hit and/or miss. The impact display unit may include any quantity of LEDs or other visual indicators of any color arranged in any fashion. Any quantity of indicators of any colors may be illuminated in any fashion (e.g., continuous, flashing, etc.) in response to a beam impact or other condition. The toggle unit may be implemented by any conventional or other circuitry or devices toggling or inverting states (e.g., flip-flops, gates, etc.). The LEDs or other visual indicators may be of any desired intensity, while the switch may be implemented by any type of conventional or other switch to control the intensity (e.g., have any desired quantity of intensity settings). The switches (e.g., power, reset, intensity, etc.) may be implemented by any quantity of any conventional or other switching devices.

The communication interface unit may be of any quantity, shape or size and may accommodate any desired quantity of target assemblies. The receptacles, connectors and/or sockets (e.g., target receptacle, charge receptacle, actuator connector, target connector, etc.) of the communication interface unit may include any suitable configurations to transmit and/or receive signals. The communication interface unit may include any quantity of components (e.g., receptacles, connectors, sockets, fuses, LEDs, etc.) disposed at any suitable locations. The handle may be of any quantity or type and may be disposed at any suitable locations. The communication interface unit may include any quantity of any types of indicators (e.g., audio, visual, buzzer, light, speech synthesis, etc.) disposed at any locations to indicate a hit and/or miss. The visual and/or audio indicators may be actuated individually or in any combination to indicate a hit and/or miss. The communication interface unit may include any quantity of LEDs or other visual indicators of any color arranged in any fashion. Any quantity of indicators of any colors may be illuminated in any fashion (e.g., continuous, flashing, etc.) in response to a beam impact or other condition. The switches (e.g., power, reset, intensity, etc.) may be implemented by any quantity of any conventional or other switching devices.

The signal distribution unit may be of any quantity and may be implemented by any conventional or other circuitry (e.g., gates, multiplexers, etc.) to distribute signals within the communication interface unit. The toggle unit may be implemented by any conventional or other circuitry or devices toggling or inverting states (e.g., flip-flops, gates, etc.). The LEDs or other visual indicators may be of any desired intensity, while the switch may be implemented by any type of conventional or other switch to control the intensity (e.g., have any desired quantity of intensity settings).

The RF unit of the communication interface unit may be of any quantity, and may be disposed at any locations. The RF unit may communicate with any quantity of control stations via signals at any desired frequency. The RF unit components (e.g., antenna, transceiver, controller, etc.) may be implemented by any conventional or other circuitry or components. The controller may be implemented by any conventional or other processor (e.g., microcontroller, microprocessor, etc.). The controller may include any quantity of I/O channels for any desired input/output and may utilize any type of connector. The controller may process and store any desired information from the detector assemblies.

The body gear may be of any quantity, shape or size, may be constructed of any suitable materials (e.g., plastic, etc.) and may include any indicia or designs. The body gear may be covered by any suitable material (e.g., paint, garments, etc.) or other indicia. The body gear units may be of any quantity, shape, size or thickness, may be constructed of any suitable materials (e.g., plastic, etc.) and may include any indicia or designs. The body gear units may be configured for any body portions (e.g., torso, legs, arms, etc.), where any combinations of body gear units may be used during training. The body gear units may include any quantity of conventional or other detectors and circuitry and may detect any type of energy beam. The detectors may be implemented by any quantity of any conventional or other detectors (e.g., solar panels, IR detectors, etc.), where the detectors may be disposed at any locations on or within the body gear unit via any securing techniques (e.g., embedded within, adhesives, brackets, etc.). The body gear units may include any securing mechanisms (e.g., hook and loop fasteners, straps, sleeves, etc.) to secure the body gear units to a user body. The detectors may include any quantity of masks or apertures of any shape or size secured thereto via any conventional or other techniques (e.g., adhesives, etc.). The detectors may include filters in addition to or in place of the masks to reduce sensitivity to ambient light. The filter may be configured for any wavelength or band and may be disposed proximate the detector in any fashion via any suitable fastening techniques (e.g., holder, adhesive, hook and loop fastener, etc.). A diffuser may further be disposed proximate the detector to diffuse the incoming beam. The mask, diffuser and filter may be employed either individually or in any combination.

The body gear units may include any quantity of any types of indicators (e.g., audio, visual, buzzer, light, speech synthesis, etc.) disposed at any locations to indicate a hit and/or miss. The visual and/or audio indicators may be actuated individually or in any combination to indicate a hit and/or miss. The visual indicators may be of any color and may be illuminated in any fashion (e.g., alternately illuminated, illuminated for each hit and/or miss, etc.) to indicate a hit and/or miss. Any quantity of indicators may be associated with a detector to indicate an impact location in response to a beam impact. Further, any quantity of detectors may be associated with an indicator to indicate a location or area of the beam impact. Moreover, the body gear units may include any quantity of visual indicators of any quantity of colors, where changes of one or more colors of body gear units or the entire body gear may indicate successive beam impacts. The system components (e.g., detection assembly, circuitry, RF unit, etc.) may be secured to the body gear in any fashion and at any locations on any combinations or individual body gear units.

Any body gear unit may serve as the body gear control unit. The body gear units may include any quantity of any conventional or other connectors to facilitate coupling of the body gear units to the control unit. The body gear units may be coupled to the control unit in any fashion (e.g., each body gear unit may be connected to the control unit, the body gear units may be connected to adjacent body gear units to form a daisy-chain type connection to the control unit, etc.). The connectors may be disposed at any locations on the body gear units and may facilitate any type of communication (e.g., hardwire, cable, wireless, etc.). Alternatively, each individual body gear unit may communicate with the RF unit or computer system to transfer information.

The body gear may communicate with the computer system or reader via any conventional or other protocol, interface or medium. Alternatively, the body gear may be coupled to a network or other communications medium to directly send information to other systems or a central host processor or server (e.g., accessible directly or via a web site). The processing of hit information may be distributed between the body gear units, control unit and computer system in any fashion.

The detection assembly for the alternately illuminated body gear may be of any quantity, may be disposed at any locations on the body gear and/or body gear units and may detect a laser beam encoded or modulated in any fashion. The detection assembly may include any quantity of impact detection units, each associated with any quantity of detectors. The detection assembly may include any quantity of detectors arranged in any fashion and at any orientation for any desired field of view for an application. The detection assembly components (e.g., detectors, phase lock loop, logic, toggle unit, power source, LEDs, etc.) may be implemented by any conventional or other circuitry, where any type of signal may indicate a beam impact (e.g., high level, low level, etc.). The detection assembly may include any quantity of LEDs or other visual indicators of any color arranged in any fashion. Any quantity of LEDs of any colors may be illuminated in response to a beam impact. The body gear units may be alternately illuminated any colors in any fashion in response to a beam impact (e.g., any quantity of individual units may be illuminated, the entire body gear may be illuminated, units may be individually illuminated in response to that unit being hit, all units may be illuminated simultaneously in response to any unit being hit, etc.). The toggle unit may be arranged or configured in any fashion to illuminate individual units or the entire body gear. The LEDs may be illuminated when the body gear is used as a stand alone system or in combination with the control station. The logic unit may be of any quantity, may be disposed at any locations and may be coupled to the detectors or loops and RF and toggle units via any suitable medium (e.g., wireless, cables, etc.). The logic may be of any type of logic (e.g., OR, AND, NOR, NAND, etc.) and may be implemented by any conventional or other circuitry (e.g., gates, transistors, etc.). The power source may be implemented by any quantity of any type of power source (e.g., any quantity of any type of batteries, rechargeable batteries, etc.).

The detection assembly for the body gear indicating impact locations may be of any quantity, may be disposed at any locations on the body gear and/or body gear units and may detect a laser beam encoded or modulated in any fashion. The detection assembly may include any quantity of impact detection units, each associated with any quantity of detectors. The detection assembly may include any quantity of detectors arranged in any fashion and at any orientation for any desired field of view for an application. The detection assembly components (e.g., detectors, phase lock loop, logic, toggle unit, power source, LEDs, etc.) may be implemented by any conventional or other circuitry, where any type of signal may indicate a beam impact (e.g., high level, low level, etc.). The detection assembly may include any quantity of LEDs or other visual indicators of any color arranged in any fashion. Any quantity of indicators may be associated with a detector to indicate an impact location in response to a beam impact. Further, any quantity of detectors may be associated with an indicator to indicate a location or area of the beam impact. The indicators may be illuminated when the body gear is used as a stand alone system or in combination with the control station. The logic unit may be of any quantity, may be disposed at any locations and may be coupled to the detectors or loops via any suitable medium (e.g., wireless, cables, etc.). The logic may be of any type of logic (e.g., OR, AND, NOR, NAND, etc.) and may be implemented by any conventional or other circuitry (e.g., gates, transistors, etc.). The logic and selection unit may be of any quantity, may be disposed at any locations and may be coupled to the logic units and RF unit via any suitable medium (e.g., wireless, cables, etc.). The logic and selection unit may include any type of logic and selection (e.g., OR, AND, NOR, NAND, multiplexer, etc.) and may be implemented by any conventional or other circuitry (e.g., gates, transistors, multiplexers, etc.). The power source may be implemented by any quantity of any type of power source (e.g., any quantity of any type of batteries, rechargeable batteries, etc.).

The RF unit of the body gear may be of any quantity, and may be disposed at any locations. The RF unit may communicate with any quantity of control stations via signals at any desired frequency. The RF unit components (e.g., antenna, transceiver, controller, etc.) may be implemented by any conventional or other circuitry or components. The RF unit may accommodate any quantity of impact detection units. The controller may be implemented by any conventional or other processor (e.g., microcontroller, microprocessor, etc.). The controller may include any quantity of I/O channels for any desired input/output and may utilize any type of connector. The controller may process and store any desired information from the impact detection units.

The target assemblies and/or body gear may communicate with the computer or reader via any conventional or other protocol, interface or medium. Alternatively, the target assemblies and/or body gear may be coupled to a network or other communications medium to directly send information to other systems or a central host processor or server (e.g., accessible directly or via a web site). The processing of hit information may be distributed between the target assemblies, body gear and computer in any fashion. The target assembly may be disposed at any suitable location relative to a user.

The reader may be of any quantity, and may be disposed at any locations on, within or external of the case. The reader may communicate with any quantity of targets via signals at any desired frequency. The reader may communicate with any quantity of computer systems via any medium or protocols (e.g., wireless, cables, etc.) at any desired rate. The computer system may be local to or remote from the reader. The reader components (e.g., antenna, transceiver, controller, etc.) may be implemented by any conventional or other circuitry or components. The antenna may be placed at suitable location relative to the reader. The controller may be implemented by any conventional or other processor (e.g., microcontroller, microprocessor, etc.). The controller may process and store any desired information from the detector assemblies.

The case may be of any size or shape and may be constructed of any suitable materials. The case may be placed at any desired location and include any quantity of any system components and/or accessories. The upper and lower members may be of any shape or size and may be constructed of any suitable materials. These members may include any quantity of any types of conventional or other fastening, pivoting and support devices disposed at any suitable locations. Further, the case may include any quantity of any types of handles and/or other transporting devices (e.g., wheels, casters, etc.) disposed at any suitable locations to facilitate transport of the case. The upper and lower members may store any quantity of any system components or accessories, and may include any type of insulation material (e.g., foam). The upper and lower members may include any quantity of compartments of any shape or size and arranged in any fashion to store the system components and/or accessories. The system components and/or accessories may be disposed in any quantity and/or combination in the case in any desired arrangement. The components of the system may be utilized as described above within or external of a case.

The control station may be placed at any suitable location relative to the target assemblies, preferably within communication range of the target assemblies and body gear. However, the target assemblies and body gear may store impact data when out of range and provide the data to the control station when the target assemblies and/or body gear become in communication range with that station. The target assemblies and body gear may further communicate with a hand-held device to transfer impact information to that device. The control station is preferably powered by a battery (e.g., disposed within or external of the case) to be transportable, but may be powered by any suitable power source (e.g., conventional wall outlet jack, vehicle, rechargeable battery, etc.). The target assemblies may similarly be powered by any suitable power source (e.g., conventional wall outlet jack, vehicle, rechargeable or other battery, actuation unit, etc.).

It is to be understood that the software for the various processors and/or computer systems may be implemented in any desired computer language and could be developed by one of ordinary skill in the computer arts based on the functional descriptions contained herein and flow charts illustrated in the drawings. The various functions of the computer system may be distributed in any manner among any quantity of software modules, processing systems and/or circuitry. The processors and/or computer systems may alternatively be implemented by hardware or other processing circuitry.

The display screens and reports may be arranged in any fashion and contain any type of information. The systems may produce any desired type of display or report having any desired information. The computer system may determine scores based on any desired criteria. The various functions of the processors and computer system may be distributed in any manner among any quantity of processing systems or circuitry. The flow charts and/or algorithms described above may be modified in any manner capable of performing the functions described herein. The system may be employed without a computer system where the target assemblies raise and lower the targets using time intervals selected by a user via a timing device (e.g., rotary switch, etc.). In addition, control software and/or processors may be integrated in to the various interface units (e.g., communication interface, actuation interface, etc.) and/or target assemblies to obviate the need for an external computer system.

Detection panels employing solar panels or other detectors (e.g., the detection units described above, etc.) may be employed by the target object for additional detection of laser beam impacts. For example, a target may be placed proximate and in front of a detection panel. In this case, the detection panel detects near misses that can be used to provide various scenarios. By way of example, the target may return fire as described above in response to a near miss. Solar panels may further function as a detector to cover various curvatures of the target object shells (e.g., shells 54, 55) that impede detection of the laser beam. The solar panel may be used to detect the beam in those locations. Moreover, the detection panel may be placed at the rear of the target to detect shots from the rear. In addition, the solar panel may be utilized to charge the power source (e.g., battery, etc.) utilized by the systems (e.g., interface unit, actuation interface unit, impact display unit, communication interface unit).

The target assemblies may be placed in various locations and provide diverse training scenarios. For example, the target assemblies or target object may placed on vehicles to enable training when the targets (or vehicles) are moving. Hit information is buffered and transferred to a computer or other system when the vehicle reaches a data transfer point. Alternatively, a wireless link may be employed to transfer the data during the exercise. This type of training is typically performed with machine gun type firearms when the vehicle is moving and targets are on the ground and is generally useful for guarding type activities. Further, the target assemblies or target objects may be placed on aquatic vehicles (e.g., remote controlled vehicles, miniature or other boats or jet skis, etc.) within a pool, where navy or other personnel are trained to shoot from a simulated deck of a ship or other location.

The systems are compatible with and may utilize various types of targets, such as those disclosed in the aforementioned patents and patent applications. These types of targets may be coupled to the system extender units or to the various interface units (e.g., target interface, communications interface, actuation interface, etc.) employed by the systems to enable training with various targets or scenarios.

The present invention is not limited to the applications disclosed herein, but may be utilized for any type of firearm training, gaming or entertainment applications and employ any types or combinations of targets (e.g., shells in the form of globes detecting laser impacts similar to the target objects described above, laser-detecting targets, three dimensional targets, actuable targets as described above, stationary targets as described above, etc.).

From the foregoing description, it will be appreciated that the invention makes available a novel firearm laser training system and method employing various targets to simulate training scenarios, wherein a firearm laser training system employs target assemblies and/or laser-detecting body gear to simulate various training scenarios.

Having described preferred embodiments of a new and improved firearm laser training system and method employing various targets to simulate training scenarios, it is believed that other modifications, variations and changes will be suggested to those skilled in the art in view of the teachings set forth herein. It is therefore to be understood that all such variations, modifications and changes are believed to fall within the scope of the present invention as defined by the appended claims.

1. A firearm laser training system enabling a user to project a laser beam toward one or more targets presented in accordance with control signals received from a processing system, said training system comprising:
at least one target assembly with each target assembly including a target device including a three dimensional impact surface to receive laser beam impacts and at least one detection unit to detect said impacts on said impact surface, wherein each said target assembly is responsive to control signals from said processing system to manipulate said target device into a position indicating presentation to said user; and
a transference unit in communication with each said target assembly and said processing system to transfer control and operational signals between said processing system and each said target assembly.

2. The training system of claim 1, wherein said target device includes:
a platform including said at least one detection unit; and
a shell covering said platform and including said three dimensional impact surface to receive said laser beam impacts thereon.

3. The training system of claim 1, wherein said target device is partitioned into a plurality of zones each representing a simulated location and type of shot for a beam impact, wherein each zone includes at least one detection unit to detect a beam impact within that zone.

4. The training system of claim 3, wherein each said zone includes:
a plurality of said detection units to detect said beam impact within that zone, wherein output of each said detection unit is coupled together to produce a hit signal indicating a beam impact within that zone, and wherein each said detection unit includes:
a detector to detect said laser beam on said impact surface; and
a phase lock loop to process signals from said detector and determine the presence of said laser beam impact.

5. The training system of claim 4, wherein at least one of a mask and a filter is disposed proximate said detector to control extraneous signals received by said detector.

6. The training system of claim 4, wherein said target device further includes a gain adjustment circuit to determine a gain adjustment parameter and said phase lock loop receives said gain parameter and determines the presence of said beam impact in accordance with said gain parameter.

7. The training system of claim 4, wherein said target device further includes a detection control unit disposed within one of said zones to combine said hit signals received from other zones and produce an impact signal indicating the presence of a beam impact on said impact surface, and wherein at least one of said impact signal and said hit signals are communicated to said processing system.

8. The training system of claim 1, wherein each said detection unit is configured to detect laser signals emitted from an eye-safe ANSI class 3A laser.

9. The training system of claim 1, wherein each said detection unit is configured to detect laser signals modulated at approximately 45 KHz.

10. The training system of claim 1, wherein said target device includes at least one of indicia and garments disposed thereon to indicate the target type to said user.

11. The training system of claim 1 further including a printing device coupled to said processing system to generate printed reports including information relating to performance of said user during said target presentation.

12. The training system of claim 1, wherein said transference unit supplies power signals to each said target assembly and transfers information between each said target assembly and said processing system to facilitate target presentation and display of user performance during said target presentation.

13. The training system of claim 1 further including a control module for installation on said processing system to control each said target assembly in accordance with a target presentation sequence and to process information received by said processing system from each said target assembly for selective display of user performance during said target presentation in the form of at least one of one or more graphical user screens and a printed report.

14. The training system of claim 13, wherein said control module facilitates entry of a target presentation sequence by said user into said processing system and controls said processing system to actuate each said target assembly in accordance with said entered target presentation sequence.

15. The training system of claim 1, wherein each said target assembly further includes:
a plurality of arms with said target device attached thereto;
a motor and gear assembly to actuate said arms to present said target device to said user; and
a control unit in communication with said target device and said processing system to control actuation of said arms in response to detection information received from said target device and control signals received from said processing system.

16. The training system of claim 15, wherein said control unit controls said motor assembly to actuate said arms and raise said target device in response to control signals received from said processing system, and controls said motor to actuate said arms to lower said target in response to detection information received from said target device or in response to control signals received from said processing system upon expiration of a particular time interval for presentation of said target device to said user.

17. The training system of claim 1 further including:
at least one connection unit to couple said processing system to at least one of another training system, another transference unit, a target assembly, a target and a sensor to expand said training system and enable communication between said processing system and devices coupled to said connection unit.

18. The training system of claim 1, wherein at least one target assembly is responsive to an input signal from an event detecting device to trigger presentation of said target device in response to detection of a particular event.

19. The training system of claim 1 further including at least one detection panel disposed proximate a corresponding target assembly to detect laser beam impacts on said detection panel indicating a missed target.

20. The training system of claim 1 further including an impact quantity indicator manipulable by said user to selectively designate a quantity of beam impacts that are to be detected within a predetermined time interval by said target device of each said target assembly to comprise a hit.

21. The training system of claim 1 further including:
a transference unit for each corresponding target assembly with each transference unit including a target converter unit to convert signals between a first format compatible with said corresponding target assembly and a second format for communication; and
a processor converter unit in communication with said processing system and each said transference unit to convert signals between a third format compatible with said processing system and said second format for communication with each said transference unit.

22. The training system of claim 21, wherein said target converter unit and said processor converter unit are configured to communicate over a maximum distance of approximately 1.2 kilometers, and wherein said second format includes an RS-485 format and said third format includes an RS-232 format.

23. The training system of claim 21, wherein each transference unit is coupled to said corresponding target assembly and further includes at least one indicator to indicate the presence of a beam impact on said corresponding target assembly to said user.

24. The training system of claim 1 further including:
a transference unit for each corresponding target assembly with each transference unit including a wireless communication unit for communication with said processing system; and
a wireless transceiver unit in communication with said processing system and each said transference unit to enable communication between said processing system and each said transference unit.

25. The training system of claim 24 further including:
at least one stationary target assembly including said target device and a stand to support said target device; and
a transference unit for each corresponding stationary target assembly with each transference unit including a wireless communication unit for communication.

26. The training system of claim 25, wherein said stand includes:
a platform; and
a plurality of legs attached to said platform with each leg including an engagement member to receive and secure said target device to said stand.

27. The training system of claim 25, wherein each transference unit is coupled to said corresponding target assembly and further includes at least one indicator to indicate the presence of a beam impact on said corresponding target assembly to said user.

28. The training system of claim 24, wherein said wireless communication unit and said wireless transceiver unit communicate via transmission and reception of RF signals.

29. The training system of claim 24, wherein each said transference unit and said wireless transceiver unit are configured to communicate over a maximum distance of approximately one mile.

30. The training system of claim 24 further including:
at least one body gear assembly for placement on a corresponding user, wherein each said body gear assembly includes:
at least one body gear unit each for placement on a corresponding user body portion and including at least one detection assembly to detect laser beam impacts on that body gear unit; and
a body gear wireless unit to communicate with said wireless transceiver unit and enable communication of beam impact information between that body gear assembly and said processing system.

31. The training system of claim 30, wherein said at least one body gear assembly includes a gear control unit to receive impact information from other body gear units within a corresponding body gear assembly and combine said received information to produce an impact signal indicating occurrence of a laser beam impact on that body gear assembly and to transfer said impact information and said impact signal to said body gear wireless unit for transference to said processing system.

32. The training system of claim 31, wherein each said detection assembly includes:
a plurality of detectors to detect a laser beam impact on a corresponding body gear unit;
a phase lock loop to process signals from said plurality of detectors and determine the presence of said laser beam impact; and
a plurality of indicators to indicate the occurrence of said laser beam impact in response to said determination.

33. The training system of claim 32, wherein at least one of a mask and a filter is disposed proximate each said detection assembly detector to control extraneous signals received by that detector.

34. The training system of claim 32, wherein said plurality of indicators include a plurality of visual indicators providing first and second color indications, and each said detection assembly further includes:
a toggle unit to actuate said indicators of a body gear unit to alternately provide said first and second color indications in response to successive laser beam impacts on that body gear unit.

35. The training system of claim 32, wherein said plurality of indicators include a plurality of visual indicators providing first and second color indications, and said gear control unit further includes:
a toggle unit to actuate said indicators of each said body gear unit to alternately provide said first and second color indications in response to successive laser beam impacts indicated by said impact signal.

36. The training system of claim 31, wherein each said detection assembly includes:
a plurality of detectors to detect a laser beam impact on a corresponding body gear unit;
a plurality of phase lock loops each to process signals from a corresponding detector and determine detection of said laser beam impact by that corresponding detector;
a plurality of indicators each placed proximate, and actuated in response to detection of a beam impact by, a corresponding detector to indicate the location and occurrence of said laser beam impact in accordance with said determination by a phase lock loop associated with that corresponding detector; and
a logic unit to combine said phase lock loop determinations and produce a hit signal indicating occurrence of a laser beam impact on a corresponding body gear unit.

37. The training system of claim 30, wherein said body gear wireless unit includes a position unit to retrieve a position of said body gear assembly from a Global Positioning System and to communicate said body gear assembly position to said processing system.

38. The system of claim 37, further including a control module for installation on said processing system to process information received by said processing system from each said target and body gear assemblies for selective display of user performance and user position during a training session via a graphical user screen illustrating a layout of an area utilized for said training session.

39. The training system of claim 36 further including a control module for installation on said processing system to process information received by said processing system from each said body gear assembly for selective display of user performance during a training session via a graphical user screen including laser beam impact locations on each said body gear assembly.

40. The training system of claim 1, wherein said at least one detection unit identifies a location on said impact surface of said beam impact and said control and operational signals include said beam impact location.

41. The training system of claim 40 further including a control module for installation on said processing system to process information received by said processing system from each said target assembly for selective display of user performance during a training session via a graphical user screen including laser beam impact locations on each said target assembly.

42. The training system of claim 1, wherein said target device retains a heated gas to enable users to ascertain a location of said target device via a thermal detection device.

43. The training system of claim 24, wherein said wireless communication unit stores impact information in response to attaining a position outside a communication range of said wireless transceiver unit and forwards said stored information to said wireless transceiver unit in response to regaining a position within said communication range of said wireless transceiver unit.

44. The training system of claim 30, wherein said body gear wireless unit stores impact information in response to attaining a position outside a communication range of said wireless transceiver unit and forwards said stored information to said wireless transceiver unit in response to regaining a position within said communication range of said wireless transceiver unit.

45. The training system of claim 30 further including:
a hand-held wireless unit to receive and display impact information to a user from at least one of said wireless communication unit and said body gear wireless unit.

46. A firearm laser training system enabling a user to project a laser beam toward a target in the form of another user comprising:
at least one body gear assembly for placement on a corresponding user, wherein each said body gear assembly includes:
at least one body gear unit each for placement on a corresponding user body portion and including at least one detection assembly to detect laser beam impacts on that body gear unit; and
a body gear wireless unit to communicate beam impact information to a processing system.

47. The training system of claim 46, wherein said at least one body gear assembly includes a gear control unit to receive impact information from other body gear units within a corresponding body gear assembly and combine said received information to produce an impact signal indicating occurrence of a laser beam impact on that body gear assembly and to transfer said impact information and said impact signal to said body gear wireless unit for transference to said processing system.

48. The training system of claim 47, wherein each said detection assembly includes:
a plurality of detectors to detect a laser beam impact on a corresponding body gear unit;
a phase lock loop to process signals from said plurality of detectors and determine the presence of said laser beam impact; and
a plurality of indicators to indicate the occurrence of said laser beam impact in response to said determination.

49. The training system of claim 48, wherein at least one of a mask and a filter is disposed proximate each detection assembly detector to control extraneous signals received by that detector.

50. The training system of claim 48, wherein said plurality of indicators include a plurality of visual indicators providing first and second color indications, and each said detection assembly further includes:
a toggle unit to actuate said indicators of a body gear unit to alternately provide said first and second color indications in response to successive laser beam impacts on that body gear unit.

51. The training system of claim 48, wherein said plurality of indicators include a plurality of visual indicators providing first and second color indications, and said gear control unit further includes:
a toggle unit to actuate said indicators of each said body gear unit to alternately provide said first and second color indications in response to successive laser beam impacts indicated by said impact signal.

52. The training system of claim 47, wherein each said detection assembly includes:
a plurality of detectors to detect a laser beam impact on a corresponding body gear unit;
a plurality of phase lock loops each to process signals from a corresponding detector and determine detection of said laser beam impact by that corresponding detector;
a plurality of indicators each placed proximate, and actuated in response to detection of a beam impact by, a corresponding detector to indicate the location and occurrence of said laser beam impact in accordance with said determination by a phase lock loop associated with that corresponding detector; and
a logic unit to combine said phase lock loop determinations and produce a hit signal indicating occurrence of a laser beam impact on a corresponding body gear unit.

53. The training system of claim 46, wherein said body gear wireless unit includes a position unit to retrieve a position of said body gear assembly from a Global Positioning System and to communicate said body gear assembly position to said processing system.

54. The training system of claim 46 further including:
a wireless transceiver unit in communication with said processing system and each said body gear wireless unit to enable communication of said beam impact information to said processing system.

55. The training system of claim 54, wherein said body gear wireless unit stores impact information in response to attaining a position outside a communication range of said wireless transceiver unit and forwards said stored information to said wireless transceiver unit in response to regaining a position within said communication range of said wireless transceiver unit.

56. The training system of claim 46 further including:
a hand-held wireless unit to receive and display impact information to a user from said body gear wireless unit.

57. In a firearm laser training system including at least one target assembly and a processing system to control each said target assembly, a method of presenting one or more targets to a user to enable the user to project a laser beam at the presented target and thereby conduct a training exercise comprising the steps of:
(a) transferring control and operational signals between said processing system and each said target assembly, wherein each target assembly includes a target device including a three dimensional impact surface to receive laser beam impacts and at least one detection unit to detect said impacts on said impact surface;
(b) manipulating a corresponding target device into a position indicating presentation to said user, via each said target assembly, in accordance with said control signals received from said processing system; and
(c) detecting said projected laser beam, via said manipulated target device, to determine the presence of beam impact on said presented target device.

58. The method of claim 57, wherein step (c) further includes:
(c.1) partitioning said target device into a plurality of zones each representing a simulated location and type of shot for a beam impact, wherein each zone includes at least one detection unit to detect a beam impact within that zone.

59. The method of claim 58, wherein each said zone includes a plurality of said detection units to detect said beam impact within that zone, and step (c.1) further includes:
(c.1.1) detecting said laser beam on said impact surface via detectors of said detection units within each zone;
(c.1.2) processing signals from said detectors to determine the presence of said laser beam impact within each zone; and
(c.1.3) combining the output of each said detection unit within each zone to produce a hit signal indicating a beam impact within that zone.

60. The method of claim 59, wherein step (c.1.1) further includes:
(c.1.1.1) controlling extraneous signals received by each detector via at least one of a mask and a filter placed proximate each detector.

61. The method of claim 59, wherein said target device further includes a detection control unit disposed within one of said zones, and step (c.1) further includes:
(c.1.4) combining said hit signals received from other zones and producing an impact signal indicating the presence of a beam impact on said impact surface; and
(c.1.5) communicating at least one of said impact signal and said hit signals to said processing system.

62. The method of claim 57, wherein step (a) further includes:
(a.1) indicating the target type to said user via at least one of indicia and garments placed on said target device.

63. The method of claim 57 further including the step of:
(d) generating printed reports including information relating to performance of said user during said target presentation.

64. The method of claim 57, wherein step (a) further includes:
(a.1) supplying power signals to each said target assembly and transferring information between each said target assembly and said processing system to facilitate target presentation and display of user performance during said target presentation.

65. The method of claim 57, wherein step (b) further includes:
(b.1) controlling each said target assembly in accordance with a target presentation sequence; and
said method further includes the step of:
(d) processing information received by said processing system from each said target assembly for selective display of user performance during said target presentation in the form of at least one of one or more graphical user screens and a printed report.

66. The method of claim 57, wherein step (a) further includes:
(a.1) facilitating entry of a target presentation sequence by said user into said processing system; and
step (b) further includes:
(b.1) controlling each said target assembly, via said processing system, in accordance with said entered target presentation sequence.

67. The method of claim 57, wherein step (b) further includes:
(b.1) raising said corresponding target device in response to control signals received from said processing system; and
(b.2) lowering said corresponding target device in response to detection of a beam impact by that target device or in response to control signals received from said processing system upon expiration of a particular time interval for presentation of that target device to said user.

68. The method of claim 57, wherein step (a) further includes:
(a.1) expanding said training system by coupling said processing system to at least one of another training system, a target assembly, a target and a sensor via a connection unit to establish communication between said processing system and devices coupled to said connection unit.

69. The method of claim 57, wherein step (b) further includes:
(b.1) manipulating a corresponding target device into a position indicating presentation to said user, via a corresponding target assembly, in response to an input signal from an event detecting device to trigger presentation of that target device in response to detection of a particular event.

70. The method of claim 57, wherein step (c) further includes:
(c.1) detecting laser beam impacts on at least one detection panel placed proximate a corresponding target assembly to indicate a missed target.

71. The method of claim 57, wherein step (a) further includes:
(a.1) selectively designating a quantity of beam impacts that are to be detected within a predetermined time interval by said target device of each said target assembly to comprise a hit.

72. The method of claim 57, wherein step (a) further includes:
(a.1) at each target assembly, converting signals between a first format compatible with said corresponding target assembly and a second format for communication; and
(a.2) at said processing system, converting signals between a third format compatible with said processing system and said second format for communication with each said target assembly.

73. The method of claim 72, wherein each said target assembly and said processing system are configured to communicate over a maximum distance of approximately 1.2 kilometers, and wherein said second format includes an RS-485 format and said third format includes an RS-232 format.

74. The method of claim 72, wherein each said target assembly includes at least one indicator, and said method further includes:
(d) indicating the presence of a beam impact on that target assembly to said user.

75. The method of claim 57, wherein step (a) further includes:
(a.1) communicating information between each said target assembly and said processing system via a wireless communication scheme.

76. The method of claim 75, wherein said training system includes at least one stationary target assembly including said target device and a stand to support said target device.

77. The method of claim 76, wherein each said target assembly includes at least one indicator, and said method further includes:
(d) indicating the presence of a beam impact on that target assembly to said user.

78. The method of claim 75, wherein each said target assembly and said processing system are configured to communicate over a maximum distance of approximately one mile.

79. The method of claim 75, wherein said training system further includes at least one body gear assembly for placement on a corresponding user, wherein each said body gear assembly includes at least one body gear unit each for placement on a corresponding user body portion, and step (c) further includes:
(c.1) detecting laser beam impacts on each body gear assembly; and
(c.2) communicating beam impact information from each body gear assembly to said processing system via said wireless communication scheme.

80. The method of claim 79, wherein said at least one body gear assembly includes a gear control unit, and step (c.1) further includes:
(c.1.1) at each gear control unit, receiving impact information from body gear units within that body gear assembly and combining said received information to produce an impact signal indicating occurrence of a laser beam impact on that body gear assembly; and
(c.1.2) at each body gear assembly, transferring said impact information and said impact signal to said processing system.

81. The method of claim 80, wherein step (c.1.1) further includes:
(c.1.1.1) at each body gear assembly, detecting a laser beam impact on a corresponding body gear unit via a plurality of detectors;
(c.1.1.2) processing signals from said plurality of detectors and determining the presence of said laser beam impact; and
(c.1.1.3) indicating the occurrence of said laser beam impact in response to said determination via a plurality of indicators.

82. The method of claim 81, wherein step (c.1.1.1) further includes:
(c.1.1.1.1) controlling extraneous signals received by each detector via at least one of a mask and a filter disposed proximate each said detector.

83. The method of claim 81, wherein said plurality of indicators include a plurality of visual indicators providing first and second color indications, and step (c.1.1.3) further includes:
(c.1.1.3.1) actuating said indicators of a body gear unit to alternately provide said first and second color indications in response to successive laser beam impacts on that body gear unit.

84. The method of claim 81, wherein said plurality of indicators include a plurality of visual indicators providing first and second color indications, and step (c.1.1.3) further includes:
(c.1.1.3.1) actuating said indicators of each said body gear unit to alternately provide said first and second color indications in response to successive laser beam impacts indicated by said impact signal.

85. The method of claim 80, wherein step (c.1.1) further includes:
(c.1.1.1) at each body gear assembly, detecting a laser beam impact on a corresponding body gear unit via a plurality of detectors;
(c.1.1.2) processing signals from a corresponding detector and determining detection of said laser beam impact by that corresponding detector;
(c.1.1.3) indicating the location and occurrence of said laser beam impact in accordance with said determination via a plurality of indicators each placed proximate, and actuated in response to detection of a beam impact by, a corresponding detector; and
(c.1.1.4) combining said determinations and producing a hit signal indicating occurrence of a laser beam impact on a corresponding body gear unit.

86. The method of claim 79, wherein step (c.2) further includes:
(c.2.1) retrieving a position of said body gear assembly from a Global Positioning System and communicating said body gear assembly position to said processing system.

87. The method of claim 86 further including:
(d) displaying user performance and user position during a training session via a graphical user screen illustrating a layout of an area utilized for said training session.

88. The method of claim 85 further including:
(d) displaying user performance during a training session via a graphical user screen including laser beam impact locations on each said body gear assembly.

89. The method of claim 57, wherein step (c) further includes:
(c.1) identifying a location on said impact surface of said beam impact, wherein said control and operational signals include said beam impact location.

90. The method of claim 89 further including:
(d) displaying user performance during a training session via a graphical user screen including laser beam impact locations on each said target assembly.

91. The method of claim 57, wherein said target device retains a heated gas, and step (c) further includes:
(c.1) ascertaining a location of said target device via a thermal detection device.

92. The method of claim 75, wherein step (a.1) further includes:
(a.1.1) at each target assembly, storing impact information in response to that target assembly attaining a position outside a wireless communication range of said processing system and forwarding said stored information to said processing system in response to regaining a position within said wireless communication range of said processing system.

93. The method of claim 79, wherein step (c.2) further includes:
(c.2.1) at each body gear assembly, storing impact information in response to attaining a position outside a wireless communication range of said processing system and forwarding said stored information to said processing system in response to regaining a position within said wireless communication range of said processing system.

94. The method of claim 79, wherein step (c.2) further includes:
(c.2.1) receiving and displaying impact information to a user from at least one of said body gear assemblies and said target assemblies via a hand-held wireless unit.

95. A method of firearm training enabling a user to project a laser beam toward a target in the form of another user comprising the steps of:
(a) detecting laser beam impacts via a body gear assembly for placement on a corresponding user, wherein said body gear assembly includes at least one body gear unit each for placement on a corresponding user body portion;
(b) communicating beam impact information from each body gear assembly to a processing system via a wireless communication scheme.

96. The method of claim 95, wherein each body gear assembly includes a gear control unit, and step (a) further includes:
(a.1) at each gear control unit, receiving impact information from other body gear units within that body gear assembly and combining said received information to produce an impact signal indicating occurrence of a laser beam impact on that body gear assembly; and
step (b) further includes:
(b.1) at each body gear assembly, transferring said impact information and said impact signal to said processing system.

97. The method of claim 96, wherein step (a.1) further includes:
(a.1.1) at each body gear assembly, detecting a laser beam impact on a corresponding body gear unit via a plurality of detectors;
(a.1.2) processing signals from said plurality of detectors and determining the presence of said laser beam impact; and
(a.1.3) indicating the occurrence of said laser beam impact in response to said determination via a plurality of indicators.

98. The method of claim 97, wherein step (a.1.1) further includes:
(a.1.1.1) controlling extraneous signals received by each detector via at least one of a mask and a filter disposed proximate each said detector.

99. The method of claim 97, wherein said plurality of indicators include a plurality of visual indicators providing first and second color indications, and step (a.1.3) further includes:
(a.1.3.1) actuating said indicators of a body gear unit to alternately provide said first and second color indications in response to successive laser beam impacts on that body gear unit.

100. The method of claim 97, wherein said plurality of indicators include a plurality of visual indicators providing first and second color indications, and step (a.1.3) further includes:
(a.1.3.1) actuating said indicators of each said body gear unit to alternately provide said first and second color indications in response to successive laser beam impacts indicated by said impact signal.

101. The method of claim 96, wherein step (a.1) further includes:
(a.1.1) at each body gear assembly, detecting a laser beam impact on a corresponding body gear unit via a plurality of detectors;
(a.1.2) processing signals from a corresponding detector and determining detection of said laser beam impact by that corresponding detector;
(a.1.3) indicating the location and occurrence of said laser beam impact in accordance with said determination via a plurality of indicators each placed proximate, and actuated in response to detection of a beam impact by, a corresponding detector; and
(a.1.4) combining said determinations and producing a hit signal indicating occurrence of a laser beam impact on a corresponding body gear unit.

102. The method of claim 95, wherein step (b) further includes:
(b.1) retrieving a position of said body gear assembly from a Global Positioning System and communicating said body gear assembly position to said processing system.

103. The method of claim 95, wherein step (b) further includes:
(b.1) at each body gear assembly, storing impact information in response to attaining a position outside a wireless communication range of said processing system and forwarding said stored information to said processing system in response to regaining a position within said wireless communication range of said processing system.

104. The method of claim 95, wherein step (b) further includes:
(b.1) receiving and displaying impact information to a user from at least one body gear assembly via a hand-held wireless unit.

105. The training system of claim 1, wherein said target device includes an inflatable unit providing said three dimensional impact surface.

106. The training system of claim 1, wherein at least one target assembly is disposed on a vehicle.

107. The training system of claim 1, wherein said at least one detection unit detects a beam impact in response to detection of a central portion of said laser beam.

108. The training system of claim 8, wherein said at least one target assembly is at least 600 meters from said user.

109. The training system of claim 19, wherein said corresponding target assembly includes a laser transmitter to project a laser beam in response to detection of a laser beam impact by at least one detection panel.

110. The method of claim 57, wherein said target device includes an inflatable unit to provide said three dimensional impact surface.

111. The method of claim 57, wherein at least one target assembly is disposed on a vehicle.

112. The method of claim 57, wherein step (c) further includes:
(c.1) detecting a beam impact in response to detection of a central portion of said laser beam.

113. The method of claim 70, wherein said corresponding target assembly includes a laser transmitter, and step (c.1) further includes:
(c.1.1) projecting a laser beam in response to detection of a laser beam impact by at least one detection panel.

114. A firearm laser training system enabling a user to project a laser beam toward one or more targets comprising:
at least one target assembly with each target assembly including:
a target device including a three dimensional impact surface to receive laser beam impacts; and
at least one detection unit to detect said impacts on said impact surface;
a transference unit for each corresponding target assembly with each transference unit including a wireless communication unit; and
a wireless transceiver unit in communication with a processing system and each said transference unit to enable transfer of impact information between said processing system and each said target assembly.

115. The training system of claim 114, wherein each transference unit is coupled to said corresponding target assembly and further includes at least one indicator to indicate the presence of a beam impact on said corresponding target assembly to said user.

116. The training system of claim 114, wherein said wireless communication unit and said wireless transceiver unit communicate via transmission and reception of RF signals.

117. The training system of claim 114, wherein each said transference unit and said wireless transceiver unit are configured to communicate over a maximum distance of approximately one mile.

118. In a firearm laser training system including at least one target assembly and a processing system, a method of enabling a user to project a laser beam at a target to conducting a training exercise comprising:
(a) detecting said projected laser beam by at least one target assembly to determine the presence of a beam impact, wherein each target assembly includes a three dimensional impact surface to receive laser beam impacts and at least one detection unit to detect said impacts on said impact surface; and
(b) communicating information between each said target assembly and a processing system via a wireless communication scheme.

119. The method of claim 118, wherein each said target assembly includes at least one indicator, and said method further includes:
(c) indicating the presence of a beam impact on that target assembly to said user.

120. The method of claim 118, wherein step (b) further includes:
(b.1) communicating information between each said target assembly and said processing system via transmission and reception of RF signals.

121. The method of claim 118, wherein each said target assembly and said processing system are configured to communicate over a maximum distance of approximately one mile.
